(19) United States
(12) Patent Application Publication
(10) Pub. No.: US 2017/0072657 A1
(43) Pub. Date: Mar. 16, 2017

(54) OPPOSING-FOIL PANEL HAVING ZONES DEVOID OF INTERCONNECTING STRUCTURES

(71) Applicant: Bradford Company, Holland, MI (US)

(72) Inventor: Judson A. Bradford, Holland, MI (US)

(21) Appl. No.: 15/266,026

(22) Filed: Sep. 15, 2016

Related U.S. Application Data
(60) Provisional application No. 62/219,133, filed on Sep. 16, 2015.
(60) Provisional application No. 62/220,241, filed on Sep. 18, 2015.
(60) Provisional application No. 62/243,491, filed on Oct. 19, 2015.
(60) Provisional application No. 62/259,591, filed on Nov. 24, 2015.

(51) Int. Cl. B32B 3/18

(52) U.S. Cl. CPC B32B 3/18; B32B 2307/732; B32B 2439/00; B32B 2307/54

(57) ABSTRACT

An opposing-foil panel includes spaced-apart planar foils, a plurality of elongated support members affixed to the interior surfaces of the planar foils and extending along the between the foil ends and spaced apart laterally in and along a section of the spaced-apart foils and a region adjacent to the section in which no elongated support members are affixed therein between the interior surfaces of the first and second planar foils. In some embodiments, the region may be occupied by a filler material which at least partially fills the region. In some embodiments, two such sections may be spaced apart by the region.

### CROSS-REFERENCE TO RELATED APPLICATIONS

This patent application claims the benefit of, and priority to, U.S. Provisional Patent Application Ser. No. 62/219,133, filed Sep. 16, 2015, U.S. Provisional Patent Application Ser. No. 62/220,241, filed Sep. 18, 2015, U.S. Provisional Patent Application Ser. No. 62/243,491, filed Oct. 19, 2015, and U.S. Provisional Patent Application Ser. No. 62/259,591, filed Nov. 24, 2015, the disclosures of which are all incorporated herein by reference in their entireties.

### FIELD OF THE INVENTION

The present invention relates generally to rigid or semi-rigid opposing-foil panels and methods of forming such panels, and more specifically to such panels having one or more zones devoid of interconnecting structures.

### BACKGROUND

Conventional opposing-foil panels are used to construct various panel products including, for example, collapsible container sleeves for shipping and/or storage of one or more items. Such sleeves typically have formed therein a number of vertically extending and spaced apart living hinges, and some panels used to make such sleeves typically have complicated designs for supporting the structures and repeated operation of such living hinges, for ensuring adequate bonding of such panels along their edges, and/or for providing high compressive load bearing capacity. Such panels can therefore be expensive to manufacture and to purchase. It is therefore desirable to design and manufacture opposing-foil panels for use in constructing such collapsible sleeves and/or for other uses that will support the structures and repeated operation of living hinges, ensure adequate bonding of such panels along their edges and/or provide one or more zones of high compressive load bearing capacity, yet be more cost efficiently manufactured than conventional opposing-foil panels having one or more such features.

### SUMMARY

The present invention may comprise one or more of the features recited in the attached claims, and/or one or more of the following features and combinations thereof. In a first example aspect, an opposing-foil panel may comprise first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, the interior surface the first planar foil spaced apart from the interior surface of the second planar foil, a first plurality of elongated support members affixed to the interior surfaces of the first and second planar foils, the first plurality of elongated support members extending along the machine direction between the first and second foil ends and spaced apart along the cross-machine direction in a first section of the first and second planar foils, a second plurality of elongated support members affixed to the interior surfaces of the first and second planar foils, the second plurality of elongated support members extending along the machine direction between the first and second foil ends and spaced apart along the cross-machine direction in a second section of the first and second planar foils that is separate and spaced apart from the first section of the first and second planar foils, and a region of the first and second planar foils having a thickness defined between the interior surfaces of the first and second planar foils, a width defined between the first and second sections of the first and second planar foils and a length extending at least partially along the foil height from one of the first and second foil ends toward the other of the first and second foil ends, the region of the first and second planar foils having no elongated support members affixed therein between the interior surfaces of the first and second planar foils.

A second example aspect includes the subject matter of the first example aspect, and may further comprise at least one filler member disposed within the region of the first and second planar foils and extending at least partially along the length, width and thickness thereof such that the at least one filler member at least partially fills a volume of the region.

A third example aspect includes the subject matter of the second example aspect, and wherein the region of the first and second planar foils comprises a living hinge zone, and wherein the opposing-foil panel further comprises a living hinge formed at least partially along the living hinge zone with the first and second planar foils and the at least one filler member disposed therein.

A fourth example aspect includes the subject matter of the third example aspect, and wherein the living hinge further includes at least one of the first plurality of elongated support members.

A fifth example aspect includes the subject matter of the fourth example aspect, and wherein the living hinge further includes at least one of the second plurality of elongated support members.

A sixth example aspect includes the subject matter of the second example aspect, and wherein the at least one filler member is formed of at least one of a polypropylene foam, a high-density polypropylene foam, an expanding foam, a non-expanding foam, a low-density polyether, polyester, polyvinyl acetate, a flexible plastic material, a rigid plastic material, wood, a wood composite, paper, cellulose, one or a combination of metals, a metal composite, a textile, a formable medium and a curable medium.

A seventh example aspect includes the subject matter of the second example aspect, and wherein the at least one filler member defines a thickness sized to be received within the thickness of the region of the first and second planar foils, and wherein the at least one filler member comprises two or more sheets coupled together to define the thickness of the filler member.

An eighth example aspect includes the subject matter of the second example aspect, and wherein the at least one filler member defines a width sized to be received within the width of the region of the first and second planar foils, and wherein the at least one filler member comprises two or more sheets positioned side-by-side within the width of the region.

A ninth example aspect includes the subject matter of the second example aspect, and wherein the at least one filler member is a single sheet.

A tenth example aspect includes the subject matter of the second example aspect, and may further comprise a third plurality of elongated support members affixed to the interior surfaces of the first and second planar foils within the region of the first and second foils, the third plurality of elongated support members extending along the machine direction between the first and second foil ends and spaced apart along the cross-machine direction in the region of the first and second planar foils, and wherein the third plurality of elongated support members is at least partially removed from the region prior to receiving the at least one filler member therein.

An eleventh example aspect includes the subject matter of the first example aspect, and wherein the region of the first and second planar foils comprises a living hinge zone, and wherein the opposing-foil panel further comprises a living hinge formed at least partially along the living hinge zone with the first and second planar foils.

A twelfth example aspect includes the subject matter of the eleventh example aspect, and wherein the living hinge further includes at least one of the first plurality of elongated support members.

A thirteenth example aspect includes the subject matter of the twelfth example aspect, and wherein the living hinge further includes at least one of the second plurality of elongated support members.

A fourteenth example aspect includes the subject matter of the first example aspect, and wherein the opposing-foil panel is one of an extruded opposing-foil panel and laminated opposing-foil panel.

A fifteenth example aspect includes the subject matter of the first example aspect, and may further comprise a third plurality of elongated support members affixed to the interior surfaces of the first and second planar foils within the region of the first and second foils, the third plurality of elongated support members extending along the machine direction between the first and second foil ends and spaced apart along the cross-machine direction in the region of the first and second planar foils, and wherein the third plurality of elongated support members is at least partially removed from the region.

In a sixteenth example aspect, an opposing-foil panel may comprise first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, the interior surface the first planar foil spaced apart from the interior surface of the second planar foil, a first plurality of elongated support members affixed to the interior surfaces of the first and second planar foils, the first plurality of elongated support members extending along the machine direction between the first and second foil ends and spaced apart along the cross-machine in a section of the first and second planar foils, and a region of the first and second planar foils having a thickness defined between the interior surfaces of the first and second planar foils, a width defined between one of the first and second foil sides and the section of the first and second planar foils and a length extending at least partially along the foil height from one of the first and second foil ends toward the other of the first and second foil ends, the region of the first and second planar foils having no elongated support members affixed therein between the interior surfaces of the first and second planar foils.

A seventeenth example aspect includes the subject matter of the sixteenth example aspect, and may further comprise at least one filler member disposed within the region of the first and second planar foils and extending at least partially along the length, width and thickness thereof such that the at least one filler member at least partially fills a volume of the region.

In an eighteenth example aspect, a method of forming an opposing-foil panel may comprise forming the opposing foil panel to include first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, with the interior surface the first planar foil spaced apart from the interior surface of the second planar foil, to include a first plurality of elongated support members affixed to the interior surfaces of the first and second planar foils and extending along the machine direction between the first and second foil ends and spaced apart along the cross-machine direction in a first section of the first and second planar foils, and to include a second plurality of elongated support members affixed to the interior surfaces of the first and second planar foils and extending along the machine direction between the first and second foil ends and spaced apart along the cross-machine direction in a second section of the first and second planar foils that is separate and spaced apart from the first section of the first and second planar foils, and one of forming a region of the first and second planar foils between the first and second sections of the first and second planar foils and having no elongated support members affixed therein between the interior surfaces of the first and second planar foils, and forming the region to include a third plurality of elongated support members affixed to the interior surfaces of the first and second planar foils and extending along the machine direction between the first and second foil ends and spaced apart along the cross-machine direction in the region and thereafter at least partially removing the third plurality of elongated support members from the region.

A nineteenth example aspect includes the subject matter of the eighteenth example aspect, and may further comprise inserting at least one filler member into the region such that the at least one filler member at least partially fills a volume of the region.

A twentieth example aspect includes the subject matter of the eighteenth example aspect, and may further comprise at least partially filling the region with a formable filling material.

### BRIEF DESCRIPTION OF THE DRAWINGS

FIG. 1 is a simplified diagram of a side elevational view of one embodiment of a panel stock formed to include a number of zones with distributed interconnecting structures.

FIG. 2 is a top plan view of a collapsible shipping container sleeve made using two of the panels cut from the panel stock illustrated in FIG. 1.

FIG. 3 is a top plan view of the collapsible shipping container sleeve of FIG. 2 shown in a partially collapsed state.

FIG. 4 is a top plan view of the collapsible shipping container sleeve of FIGS. 2 and 3 shown in a fully collapsed state.

FIG. 5A is a side elevation, magnified and partial cutaway view of one embodiment of a portion 5A of one of the panels cut from the panel stock illustrated in FIG. 1.

FIG. 5B is a cross-sectional view of the panel of FIG. 5A along the section lines 5B-5B thereof.

FIG. 6 is a simplified diagram of a zone of the panel illustrated in FIG. 5B at which a living hinge is to be formed.

FIG. 7 is a simplified diagram of the portion of the panel illustrated in FIG. 6 showing formation of the living hinge.

FIG. 8 is a simplified diagram of the portion of the panel illustrated in FIGS. 6 and 7 showing the formed living hinge in a folded configuration.

FIG. 9 is a cross-sectional view similar to the cross-sectional view of FIG. 5B and illustrating other embodiments of the panel stock of FIG. 1 in the areas of the panel joining and living hinge zones.

FIG. 10A is a side elevation and magnified view similar to the side-elevation view of FIG. 5A but illustrating still other embodiments of the panel stock of FIG. 1 in the areas of the panel joining and living hinge zones.

FIG. 10B is a cross-sectional view of the panel stock of FIG. 10A along the section lines 10B-10B thereof.

FIG. 11A is a cross-sectional view of a portion of a panel illustrating an alternate embodiment of an interconnecting structure between the opposing panel foils within one of the panel zones.

FIG. 11B is a cross-sectional view of a portion of a panel illustrating another alternate embodiment of an interconnecting structure between the opposing panel foils within one of the panel zones.

FIG. 11C is a cross-sectional view of a portion of a panel illustrating yet another alternate embodiment of an interconnecting structure between the opposing panel foils within one of the panel zones.

FIG. 11D is a cross-sectional view of a portion of a panel illustrating still another alternate embodiment of an interconnecting structure between the opposing panel foils within one of the panel zones.

FIG. 12A is a cross-sectional view of a portion of a panel illustrating another alternate embodiment of a distributed interconnecting structure between the opposing panel foils within one of the living hinge zones.

FIG. 12B is a cross-sectional view of the embodiment illustrated in FIG. 12A, shown with the living hinge zone partially compressed during formation of the living hinge.

FIG. 12C is a cross-sectional view of the embodiments illustrated in FIGS. 12A and 12B, shown with the living hinge zone further compressed during formation of the living hinge.

FIG. 12D is a cross-sectional view of the embodiments illustrated in FIGS. 12A-12C, shown with the living hinge zone still further compressed during formation of the living hinge.

FIG. 13A is a cross-sectional view of a portion of a panel illustrating yet another alternate embodiment of a distributed interconnecting structure between the opposing panel foils within one of the living hinge zones.

FIG. 13B is a cross-sectional view of the embodiment illustrated in FIG. 13A, shown with the living hinge zone partially compressed during formation of the living hinge.

FIG. 14A is a cross-sectional view of a portion of a panel illustrating still another alternate embodiment of a distributed interconnecting structure between the opposing panel foils within one of the living hinge zones.

FIG. 14B is a cross-sectional view of the embodiment illustrated in FIG. 14A, shown with the living hinge zone partially compressed during formation of the living hinge.

FIG. 15A is a cross-sectional view of a portion of a panel illustrating a further alternate embodiment of a distributed interconnecting structure between the opposing panel foils within one of the living hinge zones.

FIG. 15B is a cross-sectional view of the embodiment illustrated in FIG. 15A, shown with the living hinge zone partially compressed during formation of the living hinge.

FIG. 16A is a cross-sectional view of a portion of a panel illustrating yet a further alternate embodiment of a distributed interconnecting structure between the opposing panel foils within one of the living hinge zones.

FIG. 16B is a cross-sectional view of the embodiment illustrated in FIG. 16A, shown with the living hinge zone partially compressed during formation of the living hinge.

FIG. 17 is a cross-sectional view of a portion of a panel illustrating an embodiment of a multi-tiered distributed interconnecting structure between the opposing panel foils within one of the living hinge zones.

FIG. 18 is a cross-sectional view of a portion of a panel illustrating an alternate embodiment of a multi-tiered distributed interconnecting structure between the opposing panel foils within one of the living hinge zones.

FIG. 19 is a cross-sectional view of a portion of a panel illustrating another alternate embodiment of a multi-tiered distributed interconnecting structure between the opposing panel foils within one of the living hinge zones.

FIG. 20 is a cross-sectional view of a portion of a panel illustrating yet another alternate embodiment of a multi-tiered distributed interconnecting structure between the opposing panel foils within one of the living hinge zones.

FIG. 21 is a cross-sectional view of a portion of a panel illustrating still another alternate embodiment of a multi-tiered distributed interconnecting structure between the opposing panel foils within one of the living hinge zones.

FIG. 22A is a simplified diagram of a side elevational view of an embodiment of a panel cut from a panel stock having end zones and living hinge zones sized and located along the panel to provide for the formation of hinged container sleeves of at least two different dimensions, and in which the illustrated panel has been sized and the living hinges have been formed in the living hinge zones to produce a hinged container sleeve having a first dimensional configuration.

FIG. 22B is a simplified diagram of a side elevational view of another panel cut from the same panel stock illustrated in FIG. 22A but in which the panel has been sized and the living hinges have been formed in the living hinge zones to produce a hinged container sleeve having a second dimensional configuration.

FIG. 23 is a simplified diagram of a side elevational view of an embodiment of a panel from which a panel product is to be cut and in which a number of zones having distributed interconnecting structures have been selectively formed to provide enhanced structural support in a corresponding number of selected areas of the panel product.

FIG. 24 is a cross-sectional view of a portion of a panel illustrating an alternate embodiment in which a secondary foil is formed on or affixed to either of the top and/or bottom foils of the panel.

FIG. 25A is a side elevation and magnified view similar to the side-elevation view of FIG. 5A but illustrating still another embodiment of a panel in the areas of the panel joining and living hinge zones.

FIG. 25B is a cross-sectional view of one of the elongated filler members of FIG. 25A along the section lines 25B-25B thereof.

FIG. 25C is a cross-sectional view of the panel of FIG. 25A along the section lines 25C-25C thereof.

FIG. 26A is a side elevation and magnified view similar to the side-elevation view of FIG. 25A but illustrating yet another embodiment of a panel in the areas of a living hinge zone.

FIG. 26B is a cross-sectional view of the filler member of FIG. 26A along the section lines 26B-26B thereof.

FIG. 26C is a cross-sectional view of the panel of FIG. 26A along the section lines 26C-26C thereof.

FIG. 26D is a cross-sectional view of an alternate embodiment of the filler member of FIG. 26A along the section lines 26D-26D thereof.

FIG. 27A is a simplified front elevational view of an embodiment of a conventional extrusion tool for use with a conventional extruder to produce hollow panels with interconnecting fins or ribs.

FIG. 27B is a cross-sectional view of an conventional hollow panel with interconnecting fins or ribs producible by an extruder and the extrusion tool illustrated in FIG. 27A.

FIG. 28A is a simplified perspective-view diagram of an embodiment of an extrusion tool mask mountable to the extrusion tool illustrated in FIG. 27A.

FIG. 28B is a simplified diagram of the extrusion tool mask of FIG. 28A mounted to the extrusion tool of FIG. 27A.

FIG. 28C is a cross-sectional view of the extrusion tool mask and extrusion tool of FIG. 28B viewed along section lines 28C-28C.

FIG. 28D is a cross-sectional view of the extrusion tool mask and extrusion tool of FIG. 28B viewed along section lines 28D-28D.

FIG. 28E is a cross-sectional view of the extrusion tool mask and extrusion tool of FIG. 28B viewed along section lines 28E-28E.

FIG. 29A is a simplified perspective-view diagram of another embodiment of an extrusion tool mask mountable to the extrusion tool illustrated in FIG. 27A.

FIG. 29B is a cross-sectional view illustrating the extrusion tool mask of FIG. 29A mounted to the extrusion tool of FIG. 27A and viewed along section lines similar to FIG. 28D.

FIG. 30A is a simplified perspective-view diagram of yet another embodiment of an extrusion tool mask mountable to the extrusion tool illustrated in FIG. 27A.

FIG. 30B is a simplified perspective-view diagram of still another embodiment of an extrusion tool mask mountable to the extrusion tool illustrated in FIG. 27A.

FIG. 31 is a view of the panel of FIG. 25A and illustrating an embodiment of an apparatus for dispensing filler material in the panel in the areas of the panel joining and living hinge zones.

FIG. 32 is a view of the panel of FIG. 26A and illustrating an embodiment of an apparatus for dispensing filler material in the panel in the area of a living hinge zone.

FIG. 33A is a view of the panel of FIG. 25A and illustrating another embodiment of an apparatus for dispensing filler material in the panel in the areas of the panel joining and living hinge zones.

FIG. 33B is a side elevational view of the embodiment illustrated in FIG. 33A.

FIG. 34 is a view of the panel of FIG. 26A and illustrating another embodiment of an apparatus for dispensing filler material in the panel in the area of a living hinge zone.

FIG. 35A is a simplified front elevational view of another embodiment of an extrusion tool for use with a conventional extruder to produce hollow panels with interconnecting fins or ribs in some panel regions and with no interconnecting fins or ribs in one or more other panel regions.

FIG. 35B is a cross-sectional view of a panel producible by an extruder and the extrusion tool illustrated in FIG. 35A.

FIG. 36A is a simplified front elevational view of yet another embodiment of an extrusion tool for use with a conventional extruder to produce panels with interconnecting fins or ribs in some panel regions and with no interconnecting fins or ribs in one or more other panel regions.

FIG. 36B is a cross-sectional view of a panel producible by an extruder and the extrusion tool illustrated in FIG. 36A.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same. For purposes of this disclosure, the term “living hinge” is defined as a thin flexible hinge or flexure bearing made by thinning an area, or adjacent areas, of a relatively rigid material so the material will bend along a line defined by the hinge.

Referring to the attached figures, an embodiment is shown in FIG. 1 of a panel stock 10 formed to include a number of zones with distributed interconnecting structures. In some embodiments, one or more such zones may be provided to accommodate formation of living hinges. Alternatively or additionally, such zones may be provided at and along one or more of the panel edges to facilitate joinder and bonding of two such panels along such edges. Alternatively or additionally still, one or more such zones may be selectively located along the panel stock 10 to provide enhanced structural integrity in and at one or more corresponding selected areas thereof.

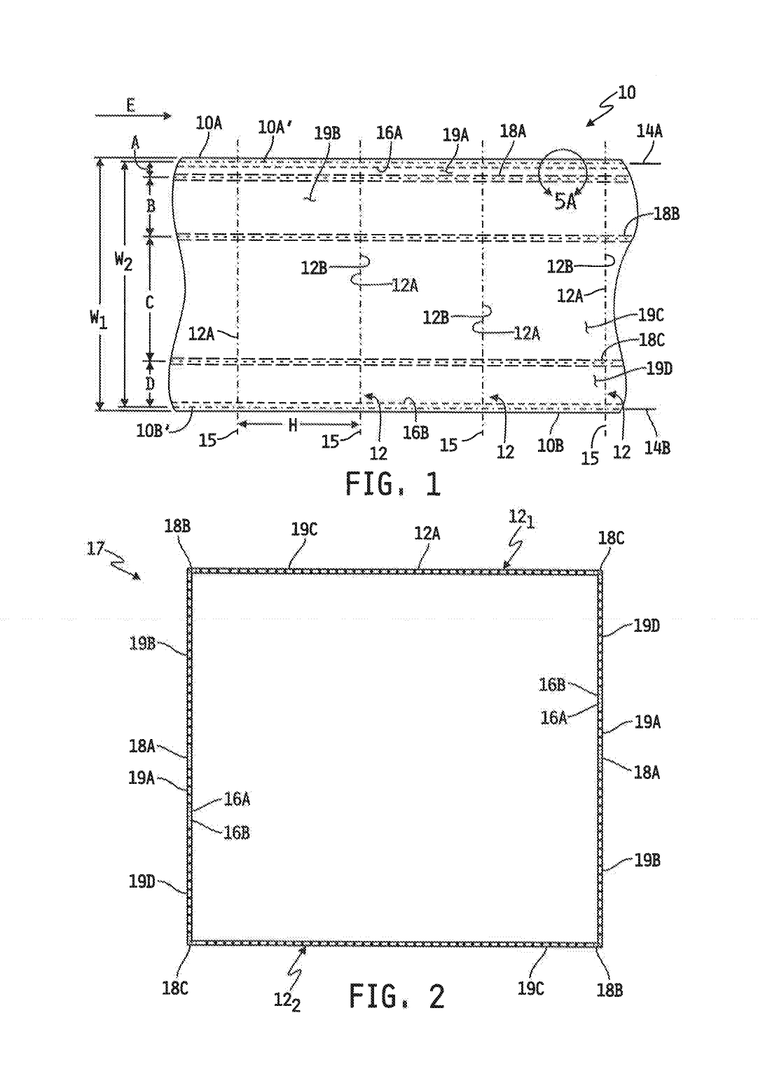

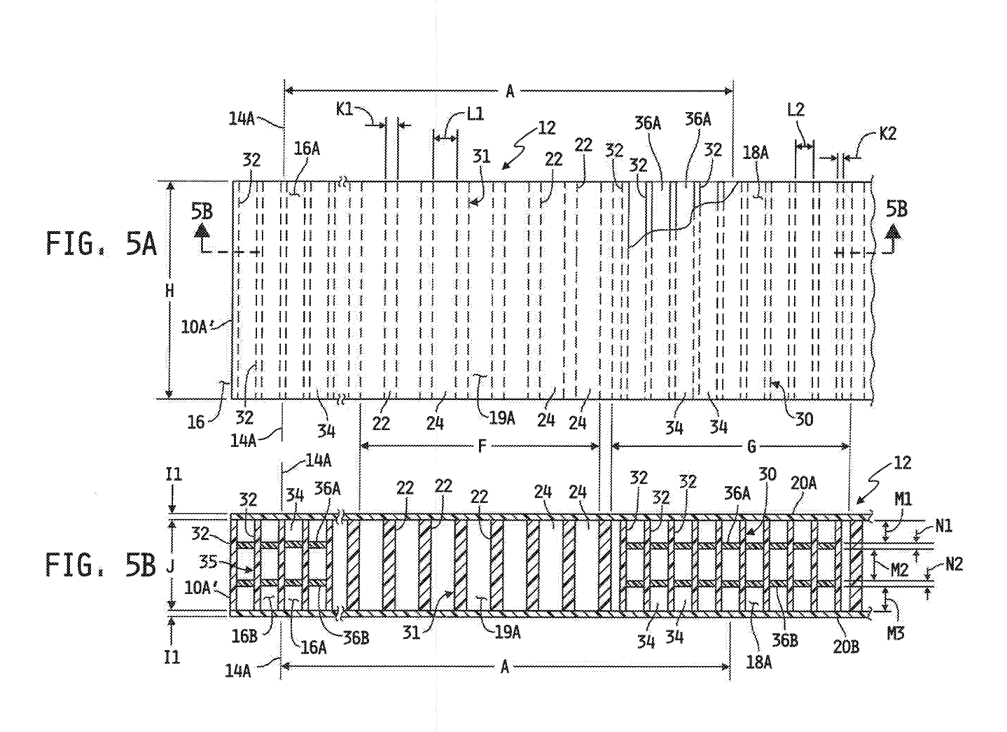

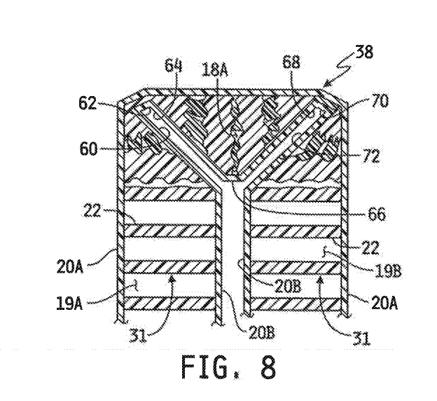

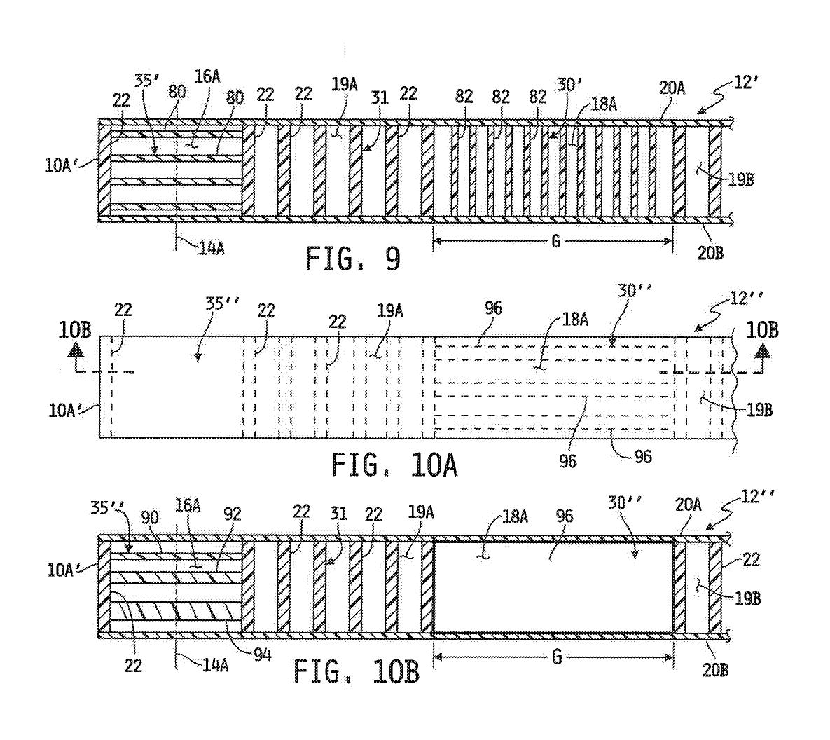

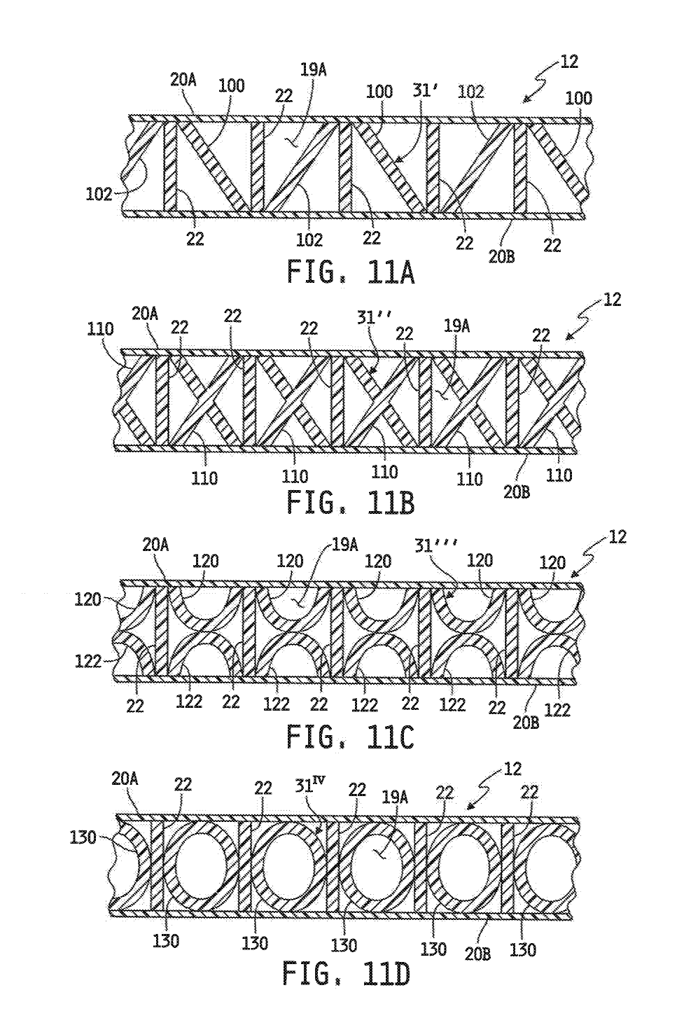

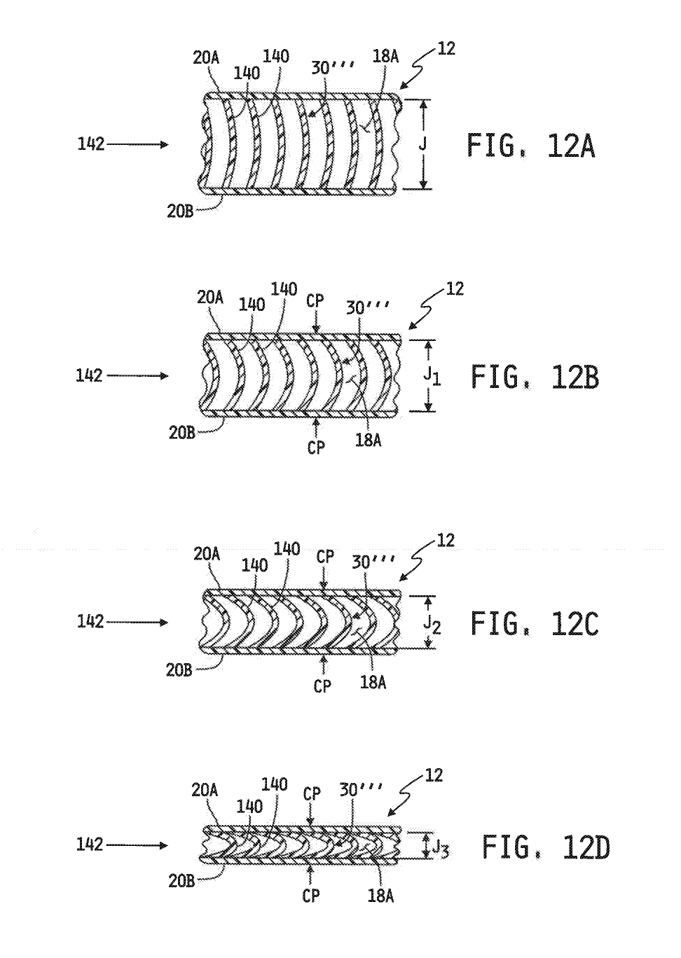

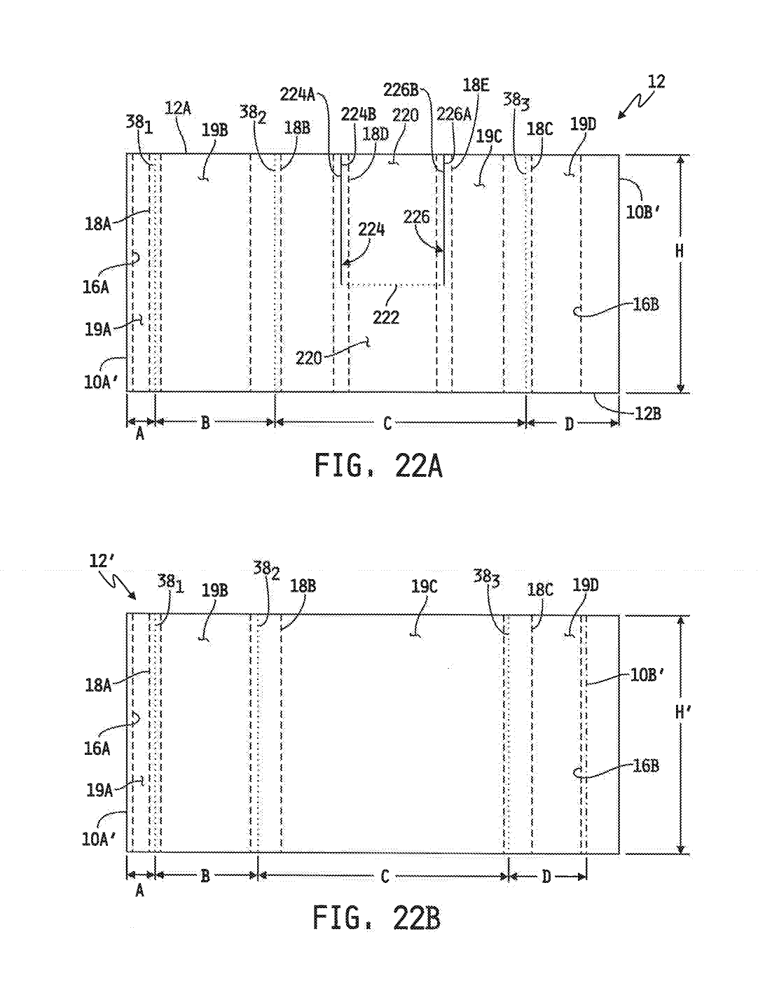

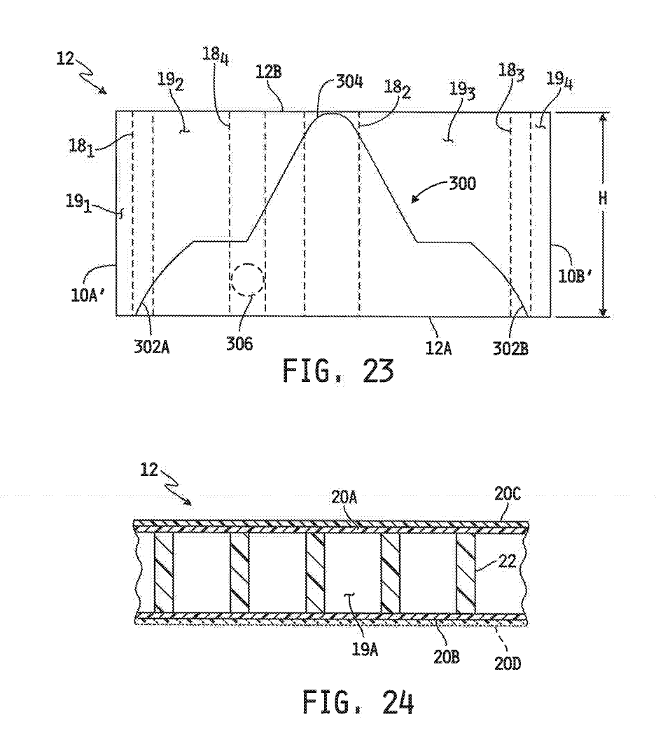

Details of the panel stock 10 and of panels 12 cut or otherwise separated from the panel stock 10 shown in FIG. 1 are illustratively shown in FIGS. 5A-5B in the context of one example configuration of such panels 12 from which collapsible container sleeves 17 with multiple living hinges may be subsequently formed. The general structure and operation of one such subsequently formed collapsible container sleeve 17 is illustrated in FIGS. 2-4. In the embodiment illustrated in FIGS. 1-5B, the panel stock 10 is illustratively formed such that each panel 12 includes end areas or zones 16A, 16B at, adjacent to and along opposing sides 10A′, 10B′ thereof which are configured to facilitate subsequent joinder of two such panels along their edges together, e.g., to form a closed-sided container 17 as illustrated in FIGS. 2-4. The panel stock 10 is further illustratively formed such that each panel 12 includes multiple, spaced apart living hinge areas or zones 18A-18C configured to be subsequently processed, e.g., in a conventional manner, to form multiple corresponding living hinges along the panel 12. The end zones 16A, 16B and the living hinge areas or zones 18A-18C are separated by one of a plurality of different panel areas or zones 19A-19D as generally illustrated in FIGS. 1-4. A simplified example of a structure and process for forming a living hinge in one such area or zone 18A is illustrated in FIGS. 6-8. In alternate embodiments, living hinges in one or more of the multiple areas or zones 18A-18C may be formed as part of the formation of the panel stock 10, e.g., either prior to or following separation thereof into individual panels 12. FIGS. 9-10B illustrate various alternate embodiments of the end areas or zones 16A, 16B and/or of one or more of the multiple living hinge areas or zones 18A-18C. FIGS. 11A-11D illustrate various alternate embodiments of one or more of the panel areas or zones 19A-19D, and FIGS. 12-21 illustrate further various alternate embodiments of the end areas or zones 16A, 16B and/or one or more of the multiple living hinge areas or zones 18A-18C (and/or in either or both of the end zones 16A, 16B). FIGS. 22A and 22B illustrate one example embodiment of the panel stock 10 having end zones and living hinge zones sized and located along the panel to provide for the formation of hinged container sleeves of at least two different dimensions. FIG. 23 illustrates an example embodiment of a panel from which a panel product is to be cut and in which a number of zones having distributed interconnecting structures have been selectively formed to provide enhanced structural support in a corresponding number of selected areas of the panel product. FIG. 24 illustrates an example embodiment of a panel in which a secondary foil is formed on or affixed to either of the top and/or bottom foils of the panel.

In one embodiment, the panel stock 10 is of unitary construction and is illustratively provided in the form of a polymer structure fabricated in accordance with a conventional extrusion process. In some such embodiments, the polymer panel stock 10 is a thermoplastic polyolefin, examples of which may be or include, but are not limited to, polypropylene, polyethylene, polymethylpentene, and/or polybutene-1. In alternate embodiments, the panel stock 10 may be formed, in whole or in part, from one or more non-polymer materials, and/or may be formed using one or more processes other than, or in addition to, a conventional extrusion process, and it will be understood that any such alternate panel stock material(s) and/or formation process(es) is/are intended to fall within the scope of this disclosure.

Referring now to FIG. 1, a simplified diagram is shown of a side elevation view of one embodiment of the panel stock 10 formed to include a number of zones with distributed interconnecting structures. In the illustrated embodiment, the panel stock 10 is fabricated in the form of a continuous stock, e.g., using a conventional extrusion process, from which individual panels 12 of any desired height, H, may be subsequently cut, or otherwise separated, in a conventional manner. In some alternate embodiments, the panels 12 may be formed separately and individually, e.g., via a conventional extrusion process or other conventional process. In embodiments in which the panels 12 are initially provided in the form of a panel stock 10, as illustrated in FIG. 1, the panel stock 10 is illustratively extruded in the direction E, e.g., the so-called “machine direction,” to produce a continuous and substantially planar stock 10 having width W₁ which extends between two opposing sides 10A and 10B thereof. In some example embodiments, the width W₁ is in the range of approximately 2.2-2.6 meters, although other stock widths are contemplated by this disclosure. In any case, portions of the panel stock 10 along each side edge are trimmed, e.g., cut, from the stock 10 along the cut lines 14A, 14B such that the resulting finished panel width W₂ extends between two opposing sides 10A′, 10B′ that are both inboard of the opposing sides 10A, 10B. In one example embodiment, the finished panel width, W₂, is approximately 93 inches, although other finished panel widths are contemplated by this disclosure. The height, H, of each of the panels 12 cut or otherwise separated from the panel stock 10 extends along the machine direction E between a top edge 12A of the panel 12 and a bottom edge 12B of the panel between panel cut lines 15. It will be understood that while the panels 12 illustrated in FIG. 1 all have the same height, H, individual panels 12 cut or otherwise separated from the panel stock 10 may have differing heights. In any case, the transverse direction to the machine direction E is the direction in which the widths W₁ and W₂ extend between the sides 10A, 10B and 10A′, 10B′ respectively of the panel stock 10, and this transverse direction will be referred to herein as the “cross-machine direction” or “CMD,” and/or as the trans-machine direction or “TMD.”

In any case, the panel stock 10 illustrated in FIG. 1, and therefore also each panel 12 cut or otherwise separated therefrom, includes panel end areas or zones 16A, 16B at and adjacent to respective ones of the two opposing ends 10A′, 10B′ thereof, wherein each panel end zone 16A, 16B extends along the panel stock 10 in the machine direction E. The two opposing panel end areas or zones 16A, 16B are separated by a number of living hinge areas or zones spaced apart along the width, W₂, of the panel 12 in the cross-machine direction, and each living hinge area or zone extends along the panel stock 10 in the machine direction E. Each adjacent pair of living hinge areas or zones, and also each adjacent set of living hinge areas or zones and end zones 16A, 16B, is separated in the cross-machine direction by a different one of a number of panel zones. Each of the living hinge areas or zones and each of the panel zones extend along the panel stock 10 in the machine direction E.

The panel stock 10, and therefore each panel 12, may include any number of living hinge areas or zones positioned at any corresponding number of locations along the panel stock 10 (and panels 12) to establish corresponding hinge locations thereat. In the example embodiment shown in FIG. 1, the illustrated panel stock 10 includes three such living hinge areas 18A-18C, each defining a longitudinal axis therethrough which extends along the machine direction E, and four panel zones 19A-19D each of which also extend along the machine direction E. The panel zone 19A is defined between the end zone 16A and the living hinge zone 18A, the panel zone 19B is defined between the living hinge zones 18A and 18B, the panel zone 19C is defined between the living hinge zones 18B and 18C, and the panel zone 19D is defined between the living hinge zone 18C and the end zone 16B. In the illustrated example, the width W₂ of the is the sum of the distances A-D, where A is the distance between the edge 10A′ of the panel stock 10 and the center of the living hinge area 18A, B is the distance between the centers of the living hinge zones 18A, 18B, C is the distance between the centers of the living hinge zones 18B, 18C and D is the distance between the center of the living hinge zone 18C and the edge 10B′ of the panel stock 10. The

In some embodiments, the panel 12 is cut or otherwise separated from the panel stock 10 illustrated in FIG. 1 and the living hinge areas or zones 18A-18C are subsequently each further processed to form and establish a corresponding living hinge along the length thereof. In some alternate embodiments, the living hinges may be formed and established along the lengths of the living hinge areas or zones 18A-18C during, i.e., as part of, formation of the panel stock 10, e.g., prior to or after separation of the panel stock 10 into individual panels 12.

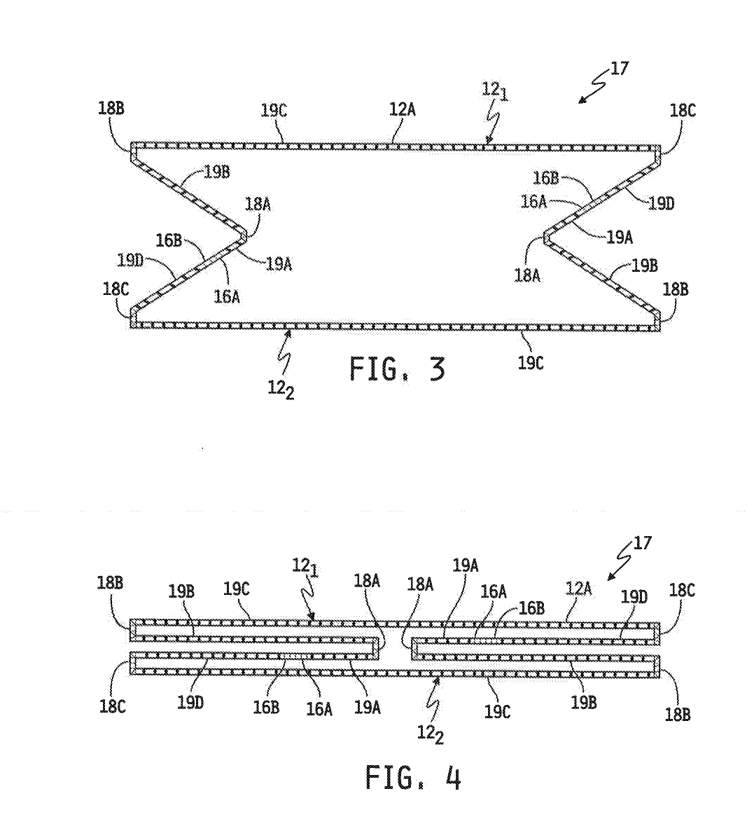

When the panel 12 is cut or otherwise separated from the panel stock 10 illustrated in FIG. 1 and the living hinges formed and established along each of the living hinge areas or zones 18A-18C, the opposing ends 10A′, 10B′ of two of the panels 12₁ and 12₂ may be joined together along their lengths in a conventional manner, e.g., via thermal bonding, adhesive bonding, one or more conventional fixation members or the like, to form a closed-sided container sleeve 17 as illustrated in the top plan view of FIG. 2. In the illustrated example, the living hinges 18B, 18C of each panel 12₁ and 12₂ form the corners of the closed-sided container sleeve 17, the living hinges 18A of the two panels 12₁, 12₂ form oppositely-oriented living hinges and the end zones 16A, 16B of the panel 12₁ are joined to and with the end zones 16B, 16A of the panel 12₂. When the closed-sided container sleeve 17 is used as, or as part of, a shipping or storage container, the living hinges 18A are generally unused, i.e., the panel zones 19B and 19D lie along a common plane as illustrated in FIG. 2. When not in use as, or as part of, a storage or shipping container, the living hinges 18A may be actuated, along with the living hinges 18B and 18C to collapse the closed-sided container sleeve 17 into a compact, generally linear form for storage thereof as illustrated by example in FIGS. 3 and 4. In some alternate embodiments, the panels 12₁, 12₂ may illustratively formed, e.g., extruded or otherwise formed, as a single panel including six living hinges, e.g., two sets of living hinges 18A-18C, and end zones 16A, 16B along opposing sides thereof. In such alternate embodiments, the closed-sided container sleeve 17 thus includes only a single joint formed by joining the end zones 16A, 16B along the opposite sides of the single panel.

A container sleeve 17 of the type and configuration illustrated in FIGS. 2-4 is sometimes referred to as a “pallet box” or “pallet box sleeve,” and may be used in conjunction with a conventional pallet or pallet assembly to store and/or transport one or more items. Alternatively, the container sleeve 17 may include an attachable or integral bottom and/or a removable or articulated top to form a complete storage and/or shipping container.

Referring now to FIGS. 5A and 5B, a side elevation, magnified and partial cutaway view and a cross-sectional view respectively are shown of one embodiment of the portion 5A of the panel 12 illustrated in FIG. 1. In the illustrated embodiment, the panel 12 includes a planar panel member 20A on one side thereof and a planar panel member 20B on an opposite side thereof. The phrases “planar panel member” and “panel member” used to describe the members 20A and 20B will be understood to be synonymous with the terms “foil,” “panel foil,” “liner” and “panel liner,” and either of the planar panel members 20A, 20B may be referred to herein as a “foil,” “panel foil,” “liner” or “panel liner,” and the planar panel members 20A, 20B may be collectively referred to herein as “foils,” “panel foils,” “liners” or “panel liners. Between the panel end area or zone 16A at/adjacent to the panel edge 10A′ and the living hinge area or zone 18A, a plurality of spaced apart support walls, ribs or flutes 22 extend and are connected between the foils 20A, 20B along the panel zone 19A in the cross-machine direction to form an interconnecting structure 31 within the panel zone 19A. In the illustrated embodiment, this same interconnecting structure 31 in the form of an arrangement of support walls 22 also extends between the panel foils 20A, 20B within each of the remaining panel zones 19B-19D. Illustratively, the panel foils 20A, 20B and the interconnecting support walls 22 are integral structures in a unitary embodiment of the panel 12, although in other embodiments the interconnecting support walls 22 may be attached at either or both ends thereof to the interior faces of the foils 20A, 20B. In any case, the exposed, exterior faces of the panel foils 20A, 20B each define the major exterior surfaces of the panel 12 between the width W₂ and the height H thereof (both defined above), and each panel foil 20A, 20B has a thickness I1 as illustrated in FIG. 5B. In the illustrated embodiment, the interconnecting support walls 22 are elongated, generally linear support walls, each extending in the panel zones 19A-19D of the panel 12 in and along the machine direction E (see FIG. 1).

The interconnecting support walls 22 each have a height J defined by the distance between the opposed, interior faces of the panel foils 20A, 20B, a length H defined by the height of the panel 12 and a thickness K1 as illustrated in FIG. 5A. Each support wall 22 is spaced apart from an adjacent support wall 22, or from a foil interconnecting structure in the panel end area or zone 16A or from a foil interconnecting structure in the living hinge area or zone 18A, by a space 24. Each space 24 has a height J, a length H, and a width L2 as illustrated in FIG. 5A.

The foregoing dimensions of the panel members 20A, 20B, the interconnecting support walls 22 and the spaces 24 between the interconnecting support walls 22 are typically selected based on a number of considerations such as the desired performance characteristics of the panel 12, the weight of the finished panel 12, the cost of producing the panel 12 (including material cost), and/or the like. In one specific example embodiment, the width W₂, of the panel 12 is approximately 93 inches, the widths of the areas A-D are approximately 5 inches, 22.5 inches, 48 inches and 17.5 inches respectively and the height H is approximately 45 inches, such that the resulting closed-sided container sleeve 17 illustrated in FIGS. 2-4 is approximately 48 inches (along the sides 19C) by approximately 45 inches (along the sides 19A, 19B, 19D) by approximately 45 inches (height H), and the thickness, K2, of each panel foil 20A, 20B is approximately 1.25 mm, the thickness, K1, of each interconnecting support member 22 is approximately 1 mm, the width, L1, of the space 24 is approximately 10 mm and the height, J, of the interconnecting support members 22 and the spaces 24 is approximately 7.5 mm. It will be understood, however, that such dimensions are provided only by way of example and should not be considered limiting in any way, and that other dimensions of the width W₂, the widths of the areas A-D, the height H, the thickness K1, the thickness K2, the width L1 and/or the height J are contemplated by this disclosure.

It is desirable to provide collapsible container sleeves 17 of the type illustrated in FIGS. 2-4 using panels 12 constructed using only the components just described, i.e., panel foils 20A, 20B interconnected via an interconnecting structure 31 in the form of a plurality of transverse support members 22 spaced apart along the total width W₂ of the panel 12. However, as described in connection with FIGS. 2-4, such collapsible containers 17 include a number of living hinges, and using panels 12 of the type just described would require orienting such living hinges parallel with the longitudinal axes of the interconnecting support members 22, i.e., in the machine direction E. In embodiments of the panel 12 in which the width, L2, of the spaces 24 between interconnecting support members 22 is relatively large as compared with the thickness, K1, of the interconnecting support members 22, such as in the specific example described above, forming such living hinges in parallel with the interconnecting support members 22 may result in weakness and/or failure in one or more such living hinges as a result of insufficient material in and along the length of the relatively large spaces 24 for supporting the structure and operation thereof. Moreover, the lack of sufficient material in and along the length of the relatively large spaces 24 may likewise result in weak or insufficient joining of the two panel ends 10A′, 10B′ when implemented as container sleeves 17 or other implementations that include joinder of two or more panels 12 along their edges 10A′ and/or 10B′. Further still, the lack of sufficient material in and along the length of the relatively large spaces 24 may result in weak or insufficient deformation resistance to compression forces applied to the outer surfaces of the foils 20A, 20B. In the embodiment of the panel 12 illustrated in FIGS. 5A-5B, the panel end zones 16A, 16B and each of the zones 18A-18C are modified for one or more such implementations thereof, e.g., during formation of the panel stock 10, to distribute the same amount of material in the interconnecting support members 22 more evenly or uniformly, i.e., with greater mass density and surface area density, across the widths of these areas or zones, i.e., in the cross-machine direction of the panel 12, than occurs in the panel zones 19A-19D, to thereby provide sufficient material in an along the zones 16A, 16B to facilitate joinder of two panels 12 along their edges 10A′, 10B′, and sufficient material in and along the zones 18A-18C to support the structure and operation of living hinges to be subsequently formed in these areas or zones, and/or to enhance deformation resistance to compression forces applied to the outer surface of the foil 20A and/or the foil 20B in the area(s) or zone(s) 16A, 16B, 18A, 18B and/or 18C.

In the embodiment illustrated in FIGS. 5A-5B, the living hinge area or zone 18A is shown having a width G which extends in the cross-machine direction of the panel 12. The volume, V_{18A}, of the living hinge area or zone 18A is thus V_{18A}=H×G×J, where G is the width of the living hinge area or zone 18A (extending in the cross-machine direction of the panel 12), H is the height of the panel 12, which is also the length of the living hinge area or zone 18A, and J is the distance between the opposed interior surfaces of the panel members 20A, 20B. Within this volume V_{18A}, a distributed interconnecting structure 30, made up of a plurality of interconnecting support members 32 spaced apart and interconnected with each other via upper and lower support members 36A, 36B respectively, is illustratively formed between and connected to the opposed interior surfaces of the panel members 20A, 20B along the length H and width G thereof.

The interconnecting support members 32 illustrated in FIGS. 5A and 5B are each illustratively provided in the form of linear ribs or flutes having a length or height J, which is the distance between the opposed interior surfaces of the panel members 20A, 20B, and a thickness K2 as illustrated in FIG. 5A. Adjacent interconnecting support members 32, e.g., also in the form of linear ribs or flutes, are spaced apart by spaces 34 each having a length or height J and a width L2. Illustratively, L2 is less than L1, and K2 is less than K1. Adjacent interconnecting support members 32 are interconnected with each other via laterally extending (i.e., transversely relative to the width G of the living hinge area or zone 18A and in a direction parallel to the cross-machine direction of the panel 12, upper support members 36A and laterally extending lower support members 36B. Each of the upper support members 36A has a thickness N1, a length L2 and is spaced apart from the interior surface of the panel member 20A by a distance M1. Each of the lower support members 36B has a thickness N2, a length L2 and is spaced apart from the interior surface of the panel member 20B by a distance M3, and the upper and lower support members 36A, 36B are spaced apart from each other by a distance M2. In the illustrated embodiment, N1=N2 and M1=M2=M3, although in some alternate embodiments N1 may be different from N2 and/or any of M1, M2 and M3 may be different one or both of the remaining values of M1, M2 and M3. In other alternate embodiments, either or both of the sets of lateral support members 36A and 36B may be positioned linearly, non-linearly or piecewise-linearly anywhere along the lengths of the interconnecting support members 32. In still other alternate embodiments, the distributed interconnecting structure 30 may include only a single set of lateral support members 36A or 36B connecting together adjacent ones of the interconnecting support members 32, wherein such a single set of lateral support members 36A or 36B may be positioned linearly, non-linearly or piecewise-linearly anywhere along the lengths of the interconnecting support members 32. In the illustrated embodiment, the interconnecting support members 32, the upper support members 36A and the lower support members 36B are all shown as being generally linear rib or flute-type structures, although it will be understood that in alternate embodiments one or more of the support members 32, one or more of the upper support members 36A and/or one or more of the lower support members 36B may be non-linear or piecewise linear.

In embodiments in which panels 12 are extruded, either individually or in the form of a continuous panel stock 10 from which individual panels 12 are separated as illustrated in FIG. 1, and/or in embodiments in which panels 12 are fabricated using any process or technique in which a flowable material is used to form the panels 12 and is thereafter cooled or cured to produced finished panels 12, it is desirable to have such panels 12 and/or panel stock 10 cool or cure to create relatively uniform surfaces along their lengths and also across their widths (W₁/W₂) so as to minimize, or at least reduce the likelihood of, warpage, bubbling and/or other non-uniformities in, on and/or along the panels 12. In this regard, it is desirable in some such embodiments to promote uniform cooling or curing of the panels 12 and/or panel stock 10 across the lengths and widths thereof by forming the distributed interconnecting structure 30 in the volume, V_{18A}, of the living hinge area or zone 18A with the same, or substantially the same, amount of material along the length H of the zone 18A and across the width G of the zone 18A as used to form the portion of the interconnecting structure 31 along the lengths and across the widths in and of adjacent, contiguous panel zones 19A-19D having the same volume as V_{18A}. This is illustrated graphically in FIG. 5B in which F identifies the width of an area of the panel 12 which contains a portion of the interconnecting structure 31 made up of a number of interconnecting support walls 22 separated by spaces 24, and which is adjacent, contiguous to, and also equal to the width G of, the living hinge area or zone 18A in which the distributed interconnecting structure 30 is formed.

Thus, in order to promote uniform cooling or curing of the panels 12 and/or panel stock 10 across the lengths and widths thereof, the total amount, i.e., the total mass, of material A_{M1} used to form the distributed interconnecting structure 30 within the volume V_{18A}, i.e., the amount of material used to form the distributed interconnecting structure 30 along the length H and across the width G of the volume V_{18A}, should be the same, or substantially the same, as the total amount, i.e., the total mass, of material A_{M2} used to form the portion of the interconnecting structure 31 contained within the adjacent and contiguous volume V_{FJH}, i.e., the amount of material used to form the number of interconnecting support walls 22 along the length H and across the width F of the volume V_{FJH}, wherein V_{FJH}=F×J×H. In the example illustrated in FIGS. 5A-5B, the amount of material A_{M2} can be computed using the known dimensions of the 6 interconnecting support members 22 contained within the volume V_{FJH}. If, as illustrated in FIG. 5B, N1=N2, the amount of material A_{M1} is given by A_{M1}=[10×(amount of material used to form each of the interconnecting support members 32)]+[18×(amount of material used to form each of the lateral support members 36A, B)]=[10×(K2×J×H)]+[18×(L2×N1×H)]U³, where U corresponds to the units of measure (e.g., mm, cm, inches, etc.). Assuming N1=K2 and G≈10×L2+10×K2, the foregoing equations can be solved for values of K2 and L2.

Whereas the amount of material A_{M1} is to be distributed with greater density across the width G of the volume V_{18A} than the amount of material A_{M2} is distributed across the width F of the volume V_{FJH} in order to provide sufficient material in and along the lengths of the area or zone 18A, e.g., for supporting the structure and operation of a living hinge formed in this area or zone, it is further desirable to use the same amount of material A_{M1} in the volume V_{18A} as the material A_{M2} used in the volume V_{FJH}, and to distribute of this amount of material A_{M1} along the length H of the volume V_{18A} substantially as the amount of material A_{M2} is distributed along the length H of the volume V_{FJH} to thereby promote uniform cooling or curing of the panels 12 and/or panel stock 10 along the height H of the panels 12 (i.e., along the machine direction E). In the example illustrated in FIGS. 5A and 5B, this is illustratively accomplished by extending the distributed interconnecting structure 30 in the volume V_{18A} continuously along the machine direction of the panel stock 10 (i.e., to completely traverse the height H of each panel 12) as are the interconnecting support walls 22 of the interconnecting structure 31 in the Volume V_{FJH}.

As just described above, the distributed interconnecting structure 30 is illustratively designed relative to the volume V_{18A} of the panel stock 10 and panels 12 within which it is formed such that the material making up the distributed interconnecting structure 30 is illustratively distributed across the width G of the volume V_{18A} with greater density than is the material making up the portion of the interconnecting structure 31 defined by the number of interconnecting walls 22 spanning the width of an adjacent, contiguous and equal volume V_{FJH} of the panel 12. This is illustratively the case not only with respect to the volume V_{FJH} of the panel 12 to the left of the volume V_{18A} but also with respect to an identical adjacent, contiguous and equal volume V_{FJH} of the panel 12 to the right of the volume V_{FJH}. As used herein, the term “density” is defined as a degree of consistency measured by the quantity of mass and/or surface area per unit volume. In the example illustrated in FIGS. 5A and 5B, the distributed interconnecting structure 30 is distributed across the width G of the volume V_{18A} with greater density than is the material making up the portion of the interconnecting structure 31 within the width of an adjacent, contiguous and equal volume V_{FJH} of the panel 12 by using a greater number of thinner but more closely spaced interconnecting support members 32 as compared to the lesser number of more thick and spaced-apart interconnecting support members 22, and by also laterally interconnecting the support members 32 with lateral support members 36A, 36B. The result is that the amount, i.e., mass, of material used to form the distributed interconnecting structure 30 is substantially equal to the amount of material used to form the portions of the interconnecting structure 31 within the adjacent, contiguous and equal volumes V_{FJH} of the panel 12 on either side of the volume V_{18A}, but the material used to form the distributed interconnecting structure 30 is distributed across the width G of the volume V_{18A} with greater density, i.e., with greater mass and/or surface area per unit volume, than that of the portion of the interconnecting structure 31 within the adjacent, contiguous and equal volumes V_{FJH} of the panel 12 on either side of the volume V_{18A}. In any case, such distribution of material across the width G of the volume V_{18A} provides sufficient material in and along the lengths of the area or zone 18A for supporting the structure and operation of a living hinge formed in this area or zone and/or for enhancing deformation resistance to compressive forces applied to the foil 20A and/or to the foil 20B at or near this area or zone. The former is illustrated by example in FIGS. 6-8 in which a conventional living hinge formation die or press 40 is used to form a living hinge 38 in and at the living hinge area or zone 18A.

In the example living hinge formation process of FIGS. 6-8, the panel 12 is illustratively at an elevated temperature, at least locally at or in the area of the living hinge area or zone 18A, at which the material making up the panel 12 can flow or otherwise be permanently altered in shape via the die or press 40. In some embodiments in which the panel 12 is fabricated using an extrusion or other thermal process, the living hinge 38 may be formed as a part of the process of providing the panel stock 10, e.g., during or just after formation of the stock 10 while the temperature of the stock 10 is still sufficiently elevated. Alternatively, the living hinge 38 may be formed after the panels 12 are formed, in which case the panels 12 will typically be reheated using conventional techniques to a suitable temperature or temperature range at which the living hinge 38 may be formed using the die or press 40.

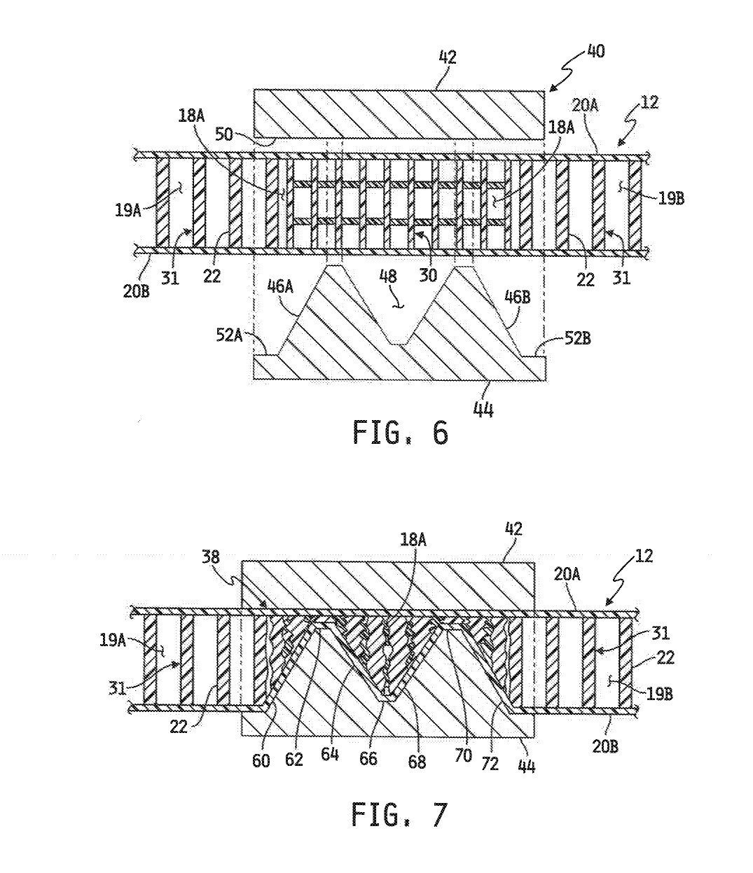

In the simplified diagram illustrated in FIG. 6, the living hinge formation die or press 40 illustratively includes a top plate 42 positioned above the panel member 20A, and a bottom plate 44 positioned below the panel member 20B. The underside of the top plate illustratively defines a substantially planar surface 50. The bottom plate 44 illustratively has a pair of truncated protrusions 46A, 46B extending upwardly from upwardly facing planar surfaces 52A and 52B respectively, wherein the two truncated protrusions define a truncated valley region 48 therebetween. As illustrated in FIG. 7, the top plate 40 and the bottom plate 42 are pressed toward and into contact with the panel 12 with the living hinge area or zone 18A positioned therebetween, and as the plates 40, 42 are advanced toward each other the contours of the protrusions 46A, 46B, valley 48 and planar surfaces 52A, 52B of the bottom plate 44 permanently deform the heated panel members 20A, 20B and distributed interconnecting structure 30 to produce a resulting living hinge 38 having angled outer hinge edges 60, 72, angled inner hinge edges 64, 68, substantially planar hinge edges 62, 70 at the truncated valleys between the angled edges 60, 64 and 68, 72 respectively and a substantially planar hinge edge 66 at the truncated peak between the angled edges 64 and 68. In one embodiment, the angles of the angled edges are multiples of 45 degrees such that the resulting living hinge 38 is foldable about the truncated peak 66 with the panel member 20B one side of the living hinge 38 facing the panel member 20B on the other side of the living hinge 38 as illustrated in FIG. 8.

It will be appreciated, as evident from FIGS. 6 and 7, that inclusion of the distributed interconnecting structure 30 within the living hinge area 18A provides some amount of lateral alignment tolerance of the die or press 40 relative to the location of the living hinge 38 while still providing for a solid and stable living hinge 38. For example, the die or press 40 could move to the right up to a distance that places the right edge of the planar peak 70 under the first interconnecting member 22 to the right of the distributed interconnecting structure 30, or to the left up to a distance that places the left edge of the planar peak 62 under the first interconnecting member 22 to the left of the distributed interconnecting structure 30 (e.g., see FIG. 6) without creating a material change in the performance of the resulting living hinge 38.

It will be understood that the description of the distributed interconnecting structure 30 with respect to FIGS. 5A and 5B was limited to the living hinge area or zone 18A only by way of example, and that the distributed interconnecting structure 30 is illustratively formed within the volume of each living hinge area or zone of the panel 12. In the embodiment illustrated in FIGS. 1-4, for example, the distributed interconnecting structure 30 is formed within each of the remaining living hinge areas or zones 18B, 18C, and that the living hinge formation process illustrated in FIGS. 6-8, or similar such process, is carried with respect to each such living hinge area or zone 18B, 18C to form living hinges 38 of the type illustrated in FIGS. 7 and 8 along each such living hinge area or zone 18B, 18C. It will be further understood that while the living hinge 38 of FIGS. 7 and 8 is illustrated and described as forming a so-called double score living hinge, e.g., one in which a substantially planar lower hinge edge 66 is formed between two substantially planer upper hinge edges 62, 70, the living hinge 38 may alternatively be formed using other conventional living hinge designs. Examples of such other conventional living hinge designs include, but are not limited to, a bi-stable hinge, a triple score hinge, e.g., one which includes three substantially planar upper hinge edges and two substantially planar lower hinge edges each positioned between a center one of the upper hinge edges and a different outer one of the upper hinge edges, or the like.

Referring again to FIGS. 5A-5B, in embodiments of the panel 12 in which the width, L1, of the spaces 24 between interconnecting support members 22 is relatively large as compared with the thickness, K1, of the interconnecting support members 22, as described above, joining panel ends 10A′ and 10B′ may result in weakness and/or failure of such a joint as a result of insufficient material in and along the lengths of the relatively large spaces 24 as also described above. In the embodiment of the panel 12 illustrated in FIGS. 5A-5B, the panel end areas or zones 16A, 16B are therefore modified, e.g., during formation of the panel stock 10, similarly as described with respect to the living hinge area or zone 18A, to form in each panel end area or zone 16A, 16B a distributed interconnecting structure 35 similar to the distributed interconnecting structure 30 formed in the living hinge area or zone 18A. As shown in FIG. 5B, the distributed interconnecting structure 35 is illustratively designed and positioned such that the panel end or edge 10A′ is defined at or through one of the interconnecting support members 32. Locating the panel end or edge 10A′ at or adjacent to such an interconnecting support member 32 illustratively provides a structure to and with which a suitable bond may be formed when joining panel edges 10A′, 10B′. Even if the panel end or edge 10A′ deviates from the interconnecting support member 32 illustrated in FIG. 5B, this will expose free ends of the lateral support members 36A, 36B which will provide additional structure along the panel edges 10A′, 10B′ with which to secure a suitable bond therebetween.

In embodiments in which it is desirable to have the panels 12 and/or panel stock 10 cool or cure to create relatively uniform surfaces along their lengths and widths, the amount of material used to form the distributed support structure 35 within the volume of the panel defined by the panel end area or zone 16 is illustratively selected to be the same, or approximately the same, as the amount of material used to form the number of interconnecting support members 22 within adjacent and contiguous volumes of the panel 12 on either side of the panel end area or zone 16 as described above with respect to the distributed interconnecting structure 30 formed within the volume V_{18A}.

Referring now to FIG. 9, a cross-sectional view similar to FIG. 5B is shown illustrating an alternate embodiment 30′ of the distributed interconnecting structure formed in the living hinge area or zone 18A of a panel 12′. In the illustrated embodiment, the distributed interconnecting structure 30′ is illustratively provided in the form of a number of closely spaced interconnecting support members 82 each extending between and connected to the interior surfaces of the panel members 20A and 20B. In embodiments in which it is desirable to have the panels 12′ and/or panel stock 10 cool or cure to create relative uniform surfaces, the amount of material used to form the distributed support structure 30 within the volume V_{18A} of the panel is, as described above with respect to FIGS. 5A and 5B, illustratively selected to be the same, or approximately the same, as the amount of material used to form the portion of the interconnecting structure 31 within adjacent and contiguous volumes of the panel 12′ on either side of the volume V_{18A}.

FIG. 9 also illustrates an alternate embodiment 35′ of the distributed interconnecting structure formed in the panel end area or zone 16A of the panel 12′. In the illustrated embodiment, the distributed interconnecting structure 35′ is illustratively provided in the form of a plurality of spaced-apart lateral support members 80 each connected to and between two interconnecting support members 22 located at the boundaries of the panel end area or zone 16A. In embodiments in which it is desirable to have the panels 12′ and/or panel stock 10 cool or cure to create relatively uniform surfaces, the amount of material used to form the distributed support structure 35′ within the volume of the panel defined by the panel end area or zone 16A is illustratively selected to be the same, or approximately the same, as the amount of material used to form the portion of the interconnecting structure 31 within adjacent and contiguous volumes of the panel 12′ on either side of the panel end area or zone 16A.

Referring now to FIGS. 10A and 10B, top plan and cross-sectional views similar to FIGS. 5A and 5B respectively are shown illustrating another alternate embodiment 30″ of the distributed interconnecting structure formed in the living hinge area or zone 18A of another panel 12″. In the illustrated embodiment, the distributed interconnecting structure 30″ is illustratively provided in the form of a number of spaced-apart interconnecting support members 96 each extending laterally across the living hinge area or zone 18A along the width H of the panel 12″ and each connected to and between the foils 20A, 20B as well as to and between two interconnecting support members 22 located at the boundaries of the living hinge area or zone 18A. In some embodiments, the two interconnecting support members 22 located at the boundaries of the living hinge area or zone 18A are respective parts of adjacent panel zones 19A, 19B as shown in the illustrated embodiment. In some alternate embodiments, either or both of the two interconnecting support members 22 may be part of the living hinge zone 18A, and in other alternate embodiments the number of spaced-apart interconnecting support members 96 may each be connected to and between other support members connected within the living hinge area or zone 18A between either or both of the opposing surfaces of the foils 20A, 20B. In any case, in embodiments in which it is desirable to have the panels 12″ and/or panel stock 10 cool or cure to create relatively uniform surfaces, the amount of material used to form the distributed support structure 30″ within the volume V18A of the panel is, as described above with respect to FIGS. 5A and 5B, illustratively selected to be the same, or approximately the same, as the amount of material used to form the portion of the interconnecting structure 31 within adjacent and contiguous volumes of the panel 12″ on either side of the volume V18A.

FIGS. 10A and 10B also illustrate another alternate embodiment 35″ of the distributed interconnecting structure formed in the panel end area or zone 16A of the panel 12″. In the illustrated embodiment, the distributed interconnecting structure 35″ is illustratively provided in the form of a plurality of spaced-apart lateral support members, e.g., 90, 92, 94, each connected to and between two interconnecting support members 22 located at the boundaries of the panel end area or zone 16A. In some embodiments, the one of the two interconnecting support members 22 located at the boundary of the panel end area or zone 16A and the panel zone 19A is part of adjacent panel zones 19A as shown in the illustrated embodiment. In some alternate embodiments, this interconnecting support member 22 may instead be part of the panel end area or zone 16A, and in other alternate embodiments the plurality of spaced-apart lateral support members, e.g., 90, 92, 94, may each be connected to and between other support members connected within the panel end area or zone 16A between either or both of the opposing surfaces of the foils 20A, 20B. In the embodiment illustrated in FIGS. 10A and 10B, the thickness of the lateral support members increases such that the thickness of the lateral support member 92 is greater than that of the lateral support member 90, the thickness of the lateral support member 94 is greater than that of the lateral support member 92, and so forth. In some alternate embodiments, the thickness of the lateral support members may decrease in the same direction just described. In any case, in embodiments in which it is desirable to have the panels 12″ and/or panel stock 10 cool or cure to create relatively uniform surfaces, the amount of material used to form the distributed support structure 35″ within the volume of the panel defined by the panel end area or zone 16 is illustratively selected to be the same, or approximately the same, as the amount of material used to form the portion of the interconnecting structure 31 within adjacent and contiguous volumes of the panel 12″ on either side of the panel end area or zone 16.

The interconnecting structure 31 has been illustrated and described hereinabove in the form of a plurality of elongated, spaced-apart members 22 affixed to and extending substantially perpendicularly between the opposed interior surfaces of the panel foils 20A, 20B. It will be understood that such members 22 represent only one non-limiting example embodiment of the interconnecting structure 31, and that this disclosure contemplates myriad other forms of the interconnecting structure 31 that may be formed within any one or more of the panel zones 19A-19G. As one example, FIG. 11A shows a first alternative embodiment of an interconnecting structure 31′ in which additional elongated members 100, 102 extend diagonally between the opposed interior surfaces of the planar panel members 20A, 20B in the spaces between the elongated members 22. In the illustrated embodiment, each elongated member 100 extends in one direction from an area of the interior surface of the planar panel member 20A adjacent to one of the elongated members 22 downwardly to an area of the interior surface of the planar panel member 20B adjacent to the elongated member 22 located to the right of the first elongated member 22, and each elongated member 102 extends in an opposite direction from an area of the interior surface of the planar panel member 20A adjacent to the one of the elongated members 22 downwardly to an area of the interior surface of the planar panel member 20B adjacent to the elongated member 22 located to the left of the first elongated member 22. In some embodiments, the elongated, diagonal members 100 and/or the elongated, diagonal members 102 contact the corresponding elongated members 22 at each end thereof, while in other embodiments the interface between the panel foil 20A and the elongated members 100 and/or 102 may be spaced apart from the elongated members 22 and/or the interface between the panel foil 20B and the elongated members 100 and/or 102 may be spaced apart from the elongated members 22. In still other embodiments, the diagonally extending members 100, 102 may all extend in the same direction.

In another example, FIG. 11B shows a second alternative embodiment of an interconnecting structure 31″ in which additional X-shaped members 110 extend between the opposed interior surfaces of the panel foils 20A, 20B in the spaces between the elongated members 22. In some embodiments, the X-shaped members 110 contact the corresponding elongated members 22 at each end thereof, while in other embodiments the interfaces between the panel foil 20A and the X-shaped members 110 may be spaced apart from either of both of the corresponding elongated members 22 and/or the interfaces between the panel foil 20B and the X-shaped members 110 may be spaced apart from either or both of the corresponding the elongated members 22.

In yet another example, FIG. 11C shows a third alternative embodiment of an interconnecting structure 31′″ in which additional opposing U-shaped members extend between the opposed interior surfaces of the panel foils 20A, 20B in the spaces between the elongated members 22. In the illustrated example, each U-shaped member includes a first U-shaped structure 120 having a pair of legs each extending downwardly from the interior surface of the panel foil 20A adjacent to a corresponding one of the elongated members 22 to a closed “U,” and a second U-shaped structure 122 having a pair of legs each extending upwardly from the interior surface of the panel foil 20B adjacent to a corresponding one of the elongated members 22 to another closed “U,” wherein the closed “U” portions of each opposing U-shaped structures 120, 122 are connected. In some embodiments, the legs of the U-shaped members 120 and/or 122 contact the corresponding elongated members 22 at each end thereof, while in other embodiments the interfaces between the panel foil 20A and either or both of the legs of the U-shaped members 120 may be spaced apart from either of both of the corresponding elongated members 22 and/or the interfaces between the panel foil 20B and either or both of the legs of the U-shaped members 122 may be spaced apart from either or both of the corresponding the elongated members 22. In some embodiments, the U-shaped members 120 may be separate from the U-shaped members 122, and in other embodiments each set of U-shaped members 120, 122 may be a unitary structure.

In still another example, FIG. 11D shows a fourth alternative embodiment of an interconnecting structure 31^{IV} in which additional hollow cylinders 130 extend between the opposed interior surfaces of the panel foils 20A, 20B in the spaces between the elongated members 22. In some embodiments, as illustrated in FIG. 11D, the hollow cylinders 130 do not contact either of the corresponding elongated members 22, while in other embodiments the hollow cylinders 130 may contact and/or connect to either or both of the elongated members 22.

It will be understood that the various interconnecting structures 31′-31^{IV} illustrated FIGS. 11A-11D are provided only by way of example, and should not be considered to be limiting in any way. It will further be understood that other linear, piece-wise linear, non-linear or a combination of linear/piece-wise linear and non-linear structures may be interconnected between the opposed interior surfaces of the panel foils 20A, 20B in the spaces between two or more of the elongated members 22 in any one or more of the panel zones 19A-19G, and any such structures are contemplated by this disclosure. Examples of such other structures include, but are not limited to, D-shaped structures, arcuate-shaped structures, oval structures, polygonal structures, K-shaped structures, and the like. In any such embodiments, and/or in any of the embodiments illustrated in FIGS. 11A-11D, one or more, or all, of the elongated structures 22 may be omitted.

The various distributed interconnecting structures 30, 30′, 30″ and 35, 35′, 35″ within the living hinge zones 18A-18D and end zones 16A, 16B respectively have been illustrated and described hereinabove in the form of various ones and/or combinations of generally linear, elongated support members, e.g., 32, 36A, 36B, 80, 82, 90, 92, 94, 96. However, at least within the living hinge zones 18A-18C, the panel foils 20A, 20B are compressed toward each other during the living hinge formation process, e.g., as illustrated by example in FIGS. 6-8, and during such compression perpendicularly extending support members, e.g., 32, 82, may collapse (or “fail”) in one direction or the other (i.e., to the left or to the right) or a combination thereof (e.g., like an accordion) as the panel foils 20A, 20B move toward each other. The latter phenomenon is illustrated somewhat in FIGS. 7 and 8. It is desirable, in some embodiments, to control the direction of such collapse of support members extending between the interior surfaces of the planar panel members 20A, 20B such that some or all of the support members within one or more of the living hinge zones 18A-18C collapse in at least one common direction, e.g., either to the left or to the right, or some to the left and others to the right, as the panel foils 20A, 20B are compressed toward each other during formation of one or more living hinges. Such control should, for example, ensure, or at least facilitate, more uniform distribution of the distributed interconnecting structure 30 across the widths and/or lengths of the living hinge zones during formation of the living hinges.

Referring to FIGS. 12A-12D, one embodiment of such an alternative distributed interconnecting structure 30′″ is shown in which the structure 30′″ is provided in the form of a plurality of curved, i.e., arcuate-shaped, spaced-apart, elongated members 140 each extending and connected between the opposed interior surfaces of the panel foils 20A, 20B within, for example, the living hinge zone 18A. Each elongated member 140 is illustratively curved in the same direction, e.g., to the right in FIGS. 12A-12D, although in other embodiments one or more, or all, of the elongated members 140 may alternatively be curved in the opposite direction, e.g., to the left in FIGS. 12A-12D. In the illustrated embodiment, each elongated member 140 has a uniform radius of curvature, although in other embodiments such curvature may not be uniform along the length of one or more of the elongated members 140.

In any case, FIG. 12A shows the distributed interconnecting structure 30′″ prior to any compression of the panel foils 20A, 20B within the living hinge zone 18A. FIGS. 12B-12D illustrate the controlled collapse of the various curved, elongated members 140 of the distributed interconnecting structure 30′″ as the panel foils 20A, 20B are compressed toward each other in the directions of the compression arrows CP. As shown in FIGS. 12B-12D, each of the curved, elongated structures 140 collapses in the same direction 142, e.g., to the right, as the panel foils 20A, 20B are compressed toward each other during the living hinge formation process, and such controlled collapse necessarily results from the pre-curved shape of the elongated members 140.

In some embodiments, it is desirable to minimize, or at least reduce, the number and/or size of voids formed between adjacent elongated members as they collapse during the living hinge formation process. In such embodiments in which the distributed interconnecting structure 30′″ is provided in the form of a plurality of arcuate-shaped elongated members 140 as illustrated in FIGS. 12A-12D, it may accordingly be desirable to select the lengths, radius of curvature, thickness and/or spacing between, the elongated members 140 such that a portion of each elongated member 140, e.g., at least the central portion, contacts an elongated member 140 to the right thereof during the controlled collapse of the various curved, elongated members 140, thus minimizing, or at least reducing, the number and/or size of voids formed between adjacent elongated members 140 during the living hinge formation process.

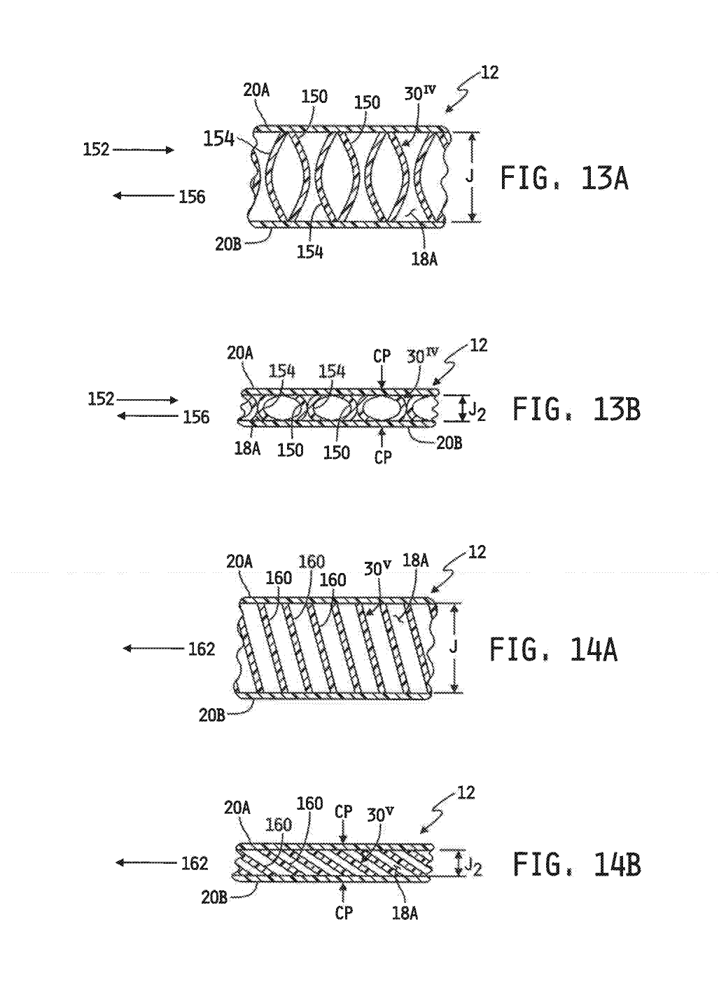

Referring now to FIGS. 13A and 13B, another embodiment of an alternative distributed interconnecting structure 30^{IV} is shown in which the structure 30^{IV} is provided in the form of a plurality of opposing, curved, spaced-apart, elongated members 150 and 154 each extending and connected between the opposed interior surfaces of the panel foils 20A, 20B within, for example, the living hinge zone 18A. Each elongated member 150 is illustratively curved in the same direction, e.g., to the right in FIGS. 13A and 13B, and each elongated member 154 is likewise curved in the same but opposite direction, e.g., to the left in FIGS. 13A and 13B. In the illustrated embodiment, each elongated member 150, 154 has a uniform radius of curvature, although in other embodiments such curvature may not be uniform along the length of one or more of the elongated members 150 and/or 154. In any case, FIG. 13A shows the distributed interconnecting structure 30^{IV} prior to any compression of the panel foils 20A, 20B within the living hinge zone 18A, and FIG. 13B shows that each of the curved, elongated structures 150 collapses in the same direction 152, e.g., to the right, and each of the curved, elongated structures 154 collapses in the same but opposite direction 156, e.g., to the left, as the panel foils 20A, 20B are compressed toward each other during the living hinge formation process. Such controlled collapse necessarily results from the pre-curved shape of the elongated members 150 and 154.

Referring now to FIGS. 14A and 14B, yet another embodiment of an alternative distributed interconnecting structure 30^{V} is shown in which the structure 30^{V} is provided in the form of a plurality of elongated, linear, diagonal, spaced-apart, elongated members 160 each extending and connected between the opposed interior surfaces of the panel foils 20A, 20B within, for example, the living hinge zone 18A. Each elongated member 160 is illustratively diagonally disposed in the same direction, e.g., to the left in FIGS. 14A and 14B. FIG. 14A shows the distributed interconnecting structure 30^{V} prior to any compression of the panel foils 20A, 20B within the living hinge zone 18A, and FIG. 14B shows that each of the elongated, linear, diagonal, spaced-apart structures 160 collapses in the same direction 162, e.g., to the left, as the panel foils 20A, 20B are compressed toward each other during the living hinge formation process. Such controlled collapse necessarily results from the diagonal shape of the elongated members 160.

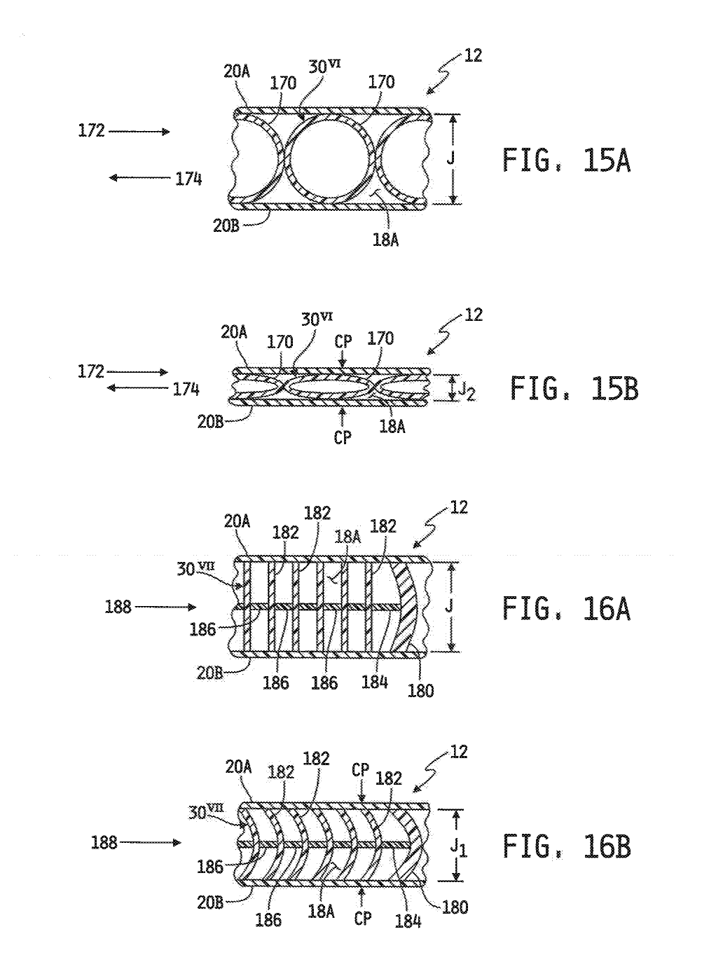

Referring now to FIGS. 15A and 15B, still another embodiment of an alternative distributed interconnecting structure 30^{VI} is shown in which the structure 30^{VI} is provided in the form of a plurality of cylindrical, spaced-apart, elongated members 170 each extending and connected between the opposed interior surfaces of the panel foils 20A, 20B within, for example, the living hinge zone 18A. Each elongated member 170 illustratively has the same radius, although in alternate embodiments one or more of the members 170 may have a different radius than one or more others of the members 170. FIG. 15A shows the distributed interconnecting structure 30^{VI} prior to any compression of the panel foils 20A, 20B within the living hinge zone 18A, and FIG. 15B shows that each of the cylindrical, elongated structures 160 collapses in each lateral direction 172 and 174, e.g., to the right and to the left respectively, as the panel foils 20A, 20B are compressed toward each other during the living hinge formation process. Such controlled collapse necessarily results from the circular shape of the elongated members 170.

Referring now to FIGS. 16A and 16B, another embodiment of an alternative distributed interconnecting structure 30^{VII} is shown in which the structure 30^{VII} is provided in the form of a curved, elongated member 180 and a plurality of linear, spaced-apart, elongated members 182 each extending and connected between the opposed interior surfaces of the panel foils 20A, 20B within, for example, the living hinge zone 18A. Each linear, elongated member 182 is connected to adjacent linear, elongated members 182 via a laterally extending member 186 connected therebetween, and the linear, elongated member 182 adjacent to the curve, elongated member 180 is connected thereto by a lateral member 186 extending therebetween. FIG. 16A shows the distributed interconnecting structure 30^{VII} prior to any compression of the panel foils 20A, 20B within the living hinge zone 18A, and FIG. 16B shows that as the curved, elongated structure 180 collapses in the direction 188, e.g., to the right, by virtue of its curvature, each of the linear, spaced-apart, elongated members 182 is pulled from its center in the direction 188 by the lateral members 184, 186 as the panel foils 20A, 20B are compressed toward each other during the living hinge formation process. Such controlled collapse necessarily results from the pre-curved shape of the elongated member 180.

Referring now to FIG. 17, a further embodiment of an alternative distributed interconnecting structure 30^{VIII} is shown in which the structure 30^{VIII} is provided in the form of a two-tiered structure having a laterally extending elongated member 200, e.g., an intermediate foil, which illustratively bisects the space J, and further having a plurality of curved, elongated members 202 each extending and connected between the opposed interior surface of the panel foil 20A and the laterally extending elongated member 200 and another plurality of curved, elongated members 202 each extending and connected between the opposed interior surface of the panel foil 20B and the laterally extending elongated member 200. In the embodiment illustrated in FIG. 17, the curved, elongated members 202 are all curved, and therefore predisposed, to collapse in the same direction 204, e.g., to the right, as the panel foils 20A, 20B are compressed toward each other during the living hinge formation process.

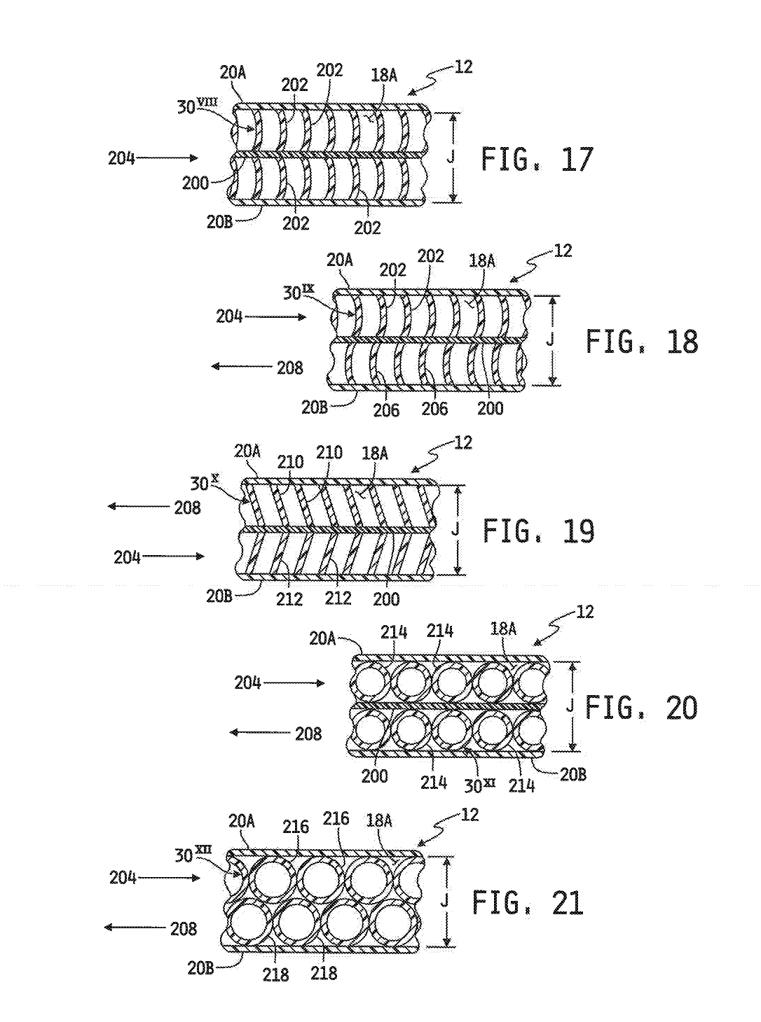

In still a further embodiment illustrated in FIG. 18, another alternative distributed interconnecting structure 30^{IX} is shown which is similar to the structure 30^{VIII} illustrated in FIG. 17 but in which the plurality of curved, elongated members 202 extending and connected between the opposed interior surface of the panel foil 20B and the laterally extending elongated member 200 is replaced with a plurality of curved, elongated members 206 curved in an opposite direction. Thus, the curved, elongated members 202 are predisposed to collapse in the direction 204, e.g., to the right, and the curved, elongated members 206 are predisposed to collapse in the opposite direction 208, e.g., to the left, as the panel foils 20A, 20B are compressed toward each other during the living hinge formation process.

In yet a further embodiment illustrated in FIG. 19, yet another alternative distributed interconnecting structure 30^{X} is shown which is similar to the structure 30^{IX} illustrated in FIG. 18 but in which the plurality of curved, elongated members 202 extending and connected between the opposed interior surface of the panel foil 20A and the laterally extending elongated member 200 is replaced with a plurality of linear, diagonally-disposed, elongated members 210 and the plurality of curved, elongated members 206 extending and connected between the opposed interior surface of the panel foil 20B and the laterally extending elongated member 200 is replaced with another plurality of linear, diagonally-disposed, elongated members 212. The linear, diagonally-disposed, elongated members 210 are predisposed to collapse in the direction 208, e.g., to the left, and the linear, diagonally-disposed, elongated members 212 are predisposed to collapse in the opposite direction 204, e.g., to the right, as the panel foils 20A, 20B are compressed toward each other during the living hinge formation process.

In still a further embodiment illustrated in FIG. 20, yet another alternative distributed interconnecting structure 30^{XI} is shown which is similar to the structure 30^{VIII} illustrated in FIG. 17 but in which the plurality of curved, elongated members 202 extending and connected between the opposed interior surface of the panel foil 20A and the laterally extending elongated member 200 is replaced with a plurality of cylindrical, elongated members 214, and the plurality of curved, elongated members 202 extending and connected between the opposed interior surface of the panel foil 20B and the laterally extending elongated member 200 is replaced with a another plurality of cylindrical, elongated members 214. Each of the cylindrical, elongated members 214 is predisposed to collapse in both lateral directions 204 and 208, e.g., to the right and to the left respectively, as the panel foils 20A, 20B are compressed toward each other during the living hinge formation process. FIG. 21 shows a further alternative distributed interconnecting structure 30^{XII} which is similar to the structure 30^{XI} illustrated in FIG. 20 but in which the laterally extending elongated member 200 is omitted and two tiers of cylindrical, elongated members 216 are connected to each other and to each of the panel foils 20A, 20B. As in the structure 30^{XI} illustrated in FIG. 20, each of the cylindrical, elongated members 216 is predisposed to collapse in both lateral directions 204 and 208, e.g., to the right and to the left respectively, as the panel foils 20A, 20B are compressed toward each other during the living hinge formation process.

It will be understood that, while not shown detail in FIGS. 12A-21 for ease of illustration, some or all of the members of the illustrated distributed interconnecting structures will thicken as the panel foils 20A, 20B are compressed toward each other, as shown by example in FIGS. 7 and 8. Moreover, it will be appreciated that, while also not shown in detail in FIGS. 12A-21 for ease of illustration, some such members of the illustrated distributed interconnecting structures may form complex shapes as they contact adjacent members during the living hinge formation process.

Referring now to FIGS. 22A and 22B, an embodiment is shown of a panel 12 cut, or otherwise separated, from a panel stock 10 having end zones 16A, 16B and living hinge zones 18A-18C sized and located along each panel 12 to provide for the formation of hinged container sleeves of at least two different dimensions. It will be understood that FIGS. 22A and 22B are vertically aligned with each other such that the left edge 10A′, the end zones 16A, 16B and the living hinge zones 18A-18C align between the two panels 12, 12′. In the example embodiment illustrated in FIG. 22A, the locations of the living hinges 38₁, 38₂ and 38₃ are all located so as to provide for a width A of approximately 5 inches, a width B of approximately 22.5 inches, a width C of approximately 48 inches and a width D of approximately 17.5 inches, such that the width of the panel 12, equal to the sum of A-D, is approximately 93 inches. The height, H, of the panel 12, which extends in the machine direction as described above with respect to FIG. 1, is, for example, approximately 45 inches. As such, when two such panels 12 are end-joined along their edges 10A′, 10B′, and living hinges are formed in and along each of the living hinge zones 18A, 18B and 18C, a closed-sided container sleeve 17, as illustrated in FIGS. 2-4 is formed having dimensions 48″ (length)×45″ (width)×45″ (height) as described with respect to FIG. 2.

In the example illustrated in FIG. 22B, the locations of the living hinges 38₁, 38₂ and 38₃ are all located so as to provide for a width A of approximately 130 millimeters, a width B of approximately 500 millimeters, a width C of approximately 1200 millimeters and a width D of approximately 370 millimeters, and the panel is cut along the edge 10B′ such that the resulting width of the panel 12, equal to the sum of A-D, is approximately 2,200 millimeters. The height, H, of the panel 12′, which extends in the machine direction as described above with respect to FIG. 1, is, for example, approximately 1,150 millimeters. As such, when two such panels 12′ are end-joined along their edges 10A′, 10B′, and living hinges are formed in and along each of the living hinge zones 18A, 18B and 18C, a closed-sided container sleeve 17, as illustrated in FIGS. 2-4 is formed having dimensions 1200 millimeters (length)×1000 millimeters (width)×1,150 millimeters (height).

The dimensions of the panel 12 illustratively represent one dimensional configuration used to produce one common closed-container sleeve widely used in the U.S., and the dimensions of the panel 12′ illustratively represent another dimensional configuration used to produce another common closed-container sleeve widely used in Europe. By designing an extrusion tool to selectively expand and place the living hinge zones 18A, 18B and 18C relative to, for example, the left (or right) edge 10A′ (or 10B′) of the panel stock 10 such that living hinges 38₁, 38₂ and 38₃ can be formed within such zones for each panel 12, 12′, a common panel stock 10 may thus be used to provide both types of panels 12, 12′ using a single extrusion tool. In the illustrated embodiment, the width (along the cross-machine direction) of the living hinge zone 18A need not be expanded since 130 millimeters (distance A) is substantially close to 5 inches. However, the difference between the distances B of the two the panels 12 and 12′ is approximately 2.8 inches and the width (along the cross-machine direction) of the living hinge zone 18B should thus be at least approximately 3.5 inches. The difference between the distance C of the two panels 12 and 12′ is approximately 0.75 inches, and the width (along the cross-machine direction) of the living hinge zone 18C should thus be at least approximately 4.5 inches. As the total length of the panel 12 is approximately 93 inches and the total length of the panel 12′ is only approximately 2, 200 millimeters, the width of the end zone 16B should be at least approximately 6.5-7 inches to account for the loss of a portion of the width of the panel 12′.

FIG. 22A further illustrates another implementation of zones 18D, 18E containing distributed interconnecting structures of the type illustrated and described hereinabove. In the embodiment illustrated in FIG. 22A, for example, a portion 220 of the panel zone 19D defines a pivoting panel 220 which may illustratively pivot outwardly and/or inwardly relative to the panel zone 19D about a lateral hinge 222 extending along the portion 220 of the panel zone 19D in the cross-machine direction between the foil ends. A zone 18D is formed between the planar foils 20A, 20B adjacent to one side of the portion 220 of the panel zone 19D, and the zone 18D illustratively has a length that extends in the machine direction along the height H of the panel 12 between the opposing foil ends and a width that extends in the cross-machine direction along a portion of the width of the panel 12. Another zone 18E is formed between the planar foils 20A, 20B adjacent to the opposite side of the portion 220 of the panel zone 19D, and the zone 18E likewise illustratively has a length that extends in the machine direction along the height H of the panel 12 between the opposing foil ends and a width that extends in the cross-machine direction along another portion of the width of the panel 12.

As illustrated in FIG. 22A, one end of the lateral hinge 222 extends from the portion 220 of the panel zone 19D into the zone 18D, and an opposite end of the lateral hinge 222 extends from the portion 220 of the panel zone 19D into the zone 18E. The panel 12 is separated, e.g., by cutting or other panel separation technique, along a first path 224 that extends in the machine direction through the zone 18D from the foil end to the one end of the lateral hinge 222, and also along a second path 226 that extends in the machine direction through the zone 18E from the foil end to the opposite end of the lateral hinge 222. The pivoting panel 220 is thus defined between the lateral hinge 222 and each of the first and second panel separation paths 224, 226. Along the first panel separation path 224, the panel 12 defines a pair of opposing panel edges 224A, 224B, and along the second panel separation path 226 the panel 12 likewise defines another pair of opposing panel edges 226A, 226B. Illustratively, each panel edge 224A, 224B, 226A, 226B is sealed, e.g., via a conventional hot melting or other sealing operation, along the machine direction between the foil end and a respective end of the lateral hinge 222.

Referring now to FIG. 23, an embodiment is shown of a panel 12 from which a panel product 300 is to be cut and in which a number of zones 18₁, 18₂ and 18₃ containing distributed interconnecting structures of the type illustrated and described hereinabove have been selectively formed to provide enhanced structural support in a corresponding number of selected areas of the panel product 300. In the illustrated embodiment, the panel 12 is illustratively cut, or otherwise separated, from panel stock 10 formed generally as illustrated and described above. From such panels, a panel product 300 is illustratively cut or otherwise separated. Alternatively, the panel product 300 may be cut or otherwise separated directly from the panel stock 10. In any case, the panel stock 10 is illustratively designed to selectively include one or more zones containing distributed interconnecting structures as described herein to selectively locate along the panel stock 10 areas or zones which provide enhanced structural integrity in the form of enhanced deformation resistance to compression forces applied to the outer surface of the foil 20A and/or the foil 20B in such zone(s).

In the illustrated embodiment, the panel product 300 may illustratively include edge areas 302A, 302B and 304 that may be particularly weak or otherwise exhibit insufficient deformation to compression forces applied to the outer surfaces of the foils 20A, 20B if the panel 12 includes, for example, only the interconnecting structures 31 of the type described used in the panel zones 19A-19D as described with respect to FIGS. 5A and 5B, wherein the elongated members 22 of such interconnecting structures 31 extend along the machine direction of the panel 12, i.e., in the direction of the height, H, of the panel 12. The panel stock 10 may thus be formed to include zones 18₁, 18₂ and 18₃ in which contain one of the embodiments 30, 30′, 30″, etc. of the distributed interconnecting structure illustrated and described herein. Inclusion of such a distributed interconnecting structure within the zones 18₁, 18₂ and 18₃ illustratively enhance deformation resistance to compression forces applied to the outer surface of the foil 20A and/or the foil 20B in the areas 302A, 302B and 304 of the panel product 300 in which the zones 18₁, 18₂ and 18₃ are located.

In the illustrated embodiment, the panel product 300 may further include an internal area 306 that is particularly susceptible to compressive forces and/or is subject to substantial and/or repeated compressive forces. The panel stock 10 may accordingly be formed to include a zone 18₄ which contains one of the embodiments 30, 30′, 30″, etc. of the distributed interconnecting structure illustrated and described herein. Inclusion of such a distributed interconnecting structure within the zone 18₄ illustratively enhances deformation resistance of the area 306 to compression forces applied to the outer surface of the foil 20A and/or the foil 20B in such an area 306 of the panel product 300. Referring now to FIG. 24, an example embodiment of a panel 12 is shown in which a secondary foil 20C is illustratively formed on or attached to the exterior surface of the top foil 20A. Alternatively or additionally, a secondary foil 20D may be formed on or attached to the exterior surface of the bottom foil 20B as illustrated by dash-lined representation in FIG. 24. Such secondary foil(s) 20C and/or 20D may be included to provide for selective coloring of the foil(s) 20A and/or 20B, to enhance the stiffness and/or structural integrity of the foil(s) 20A and/or 20B and/or one or more other reasons relating to the appearance and/or structure of the foil(s) 20A and/or 20B.

In embodiments in which the secondary foil 20C is formed on the exterior surface of the top foil 20A and/or the secondary foil 20D is formed on the exterior surface of the bottom foil 20B, such formation may illustratively be accomplished, in one embodiment, using a conventional co-extrusion process. Those skilled in the art will recognize other techniques for forming the secondary foil 20C on the exterior surface of the top foil 20A and/or forming the secondary foil 20D on the exterior surface of the bottom foil 20B, and it will be understood that any such other techniques are contemplated by this disclosure. In embodiments in which the secondary foil 20C is attached to the exterior surface of the top foil 20A and/or the secondary foil 20D is attached to the exterior surface of the bottom foil 20B, such attachment may illustratively be accomplished via a conventional foil attachment structure(s), medium (media) or technique(s), examples of which include, but are not limited to, one or more adhesives or other foil bonding media, a conventional thermal bonding technique, or the like. Those skilled in the art will recognize other foil attachment structure(s), medium (media) or technique(s) for attaching the the secondary foil 20C to the exterior surface of the top foil 20A and/or attaching the secondary foil 20D to the exterior surface of the bottom foil 20B, and it will be understood that any such other foil attachment structure(s), medium (media) or technique(s) are contemplated by this disclosure.

It will be understood that any combination of the embodiments 30, 30′, 30″, etc. of the distributed interconnection structures may be formed in any one or more of the living hinge areas or zones 18A-18C of any panel 12 described herein, and that any combination of the embodiments 35, 35″, 35″ of the distributed interconnection structures may be formed in either or both of the panel end areas or zones 16A, 16B of any panel 12 described herein. It will further be understood that any embodiment 30, 30′, 30″, etc. of the distributed interconnection structures may be alternatively or additionally used in whole or in part as a distributed interconnection structure in either or both of the panel end areas or zones 16A, 16B of any panel, and/or that any embodiment 35, 35′, 35″ of the distributed interconnection structures may be alternatively or additionally used in whole or in part as a distributed interconnection structure in any of the living hinge areas or zones 18A-18D.

The various embodiments of the interconnecting structures, e.g., 31, 31′, 31″, 31′″, 31^{IV}, have been described herein as being provided in the form of a plurality of elongated support members, e.g., 22, 100, 110, 120, 122, 130, affixed to the interior surfaces of the planar foils 20A, 20B within one or more of the panel zones, e.g., 19A-19D. It will be understood that while such interconnecting structures in the form of a plurality of such elongated support members are indeed affixed to the interior surfaces of both planar foils 20A, 20B within any one panel zone, one or more of the individual elongated support members within such a plurality may be affixed to the interior surface of only one or the other of the planar foils 20A, 20B. For example, one or more of the elongated support members 22, 100, 110, 120, 122, 130 illustrated in the attached figures may, in alternate embodiments, include a gap between opposing ends thereof, or may not otherwise extend fully from the interior surface of one of the planar foils 20A, 20B to the other. As another example, one or more of the elongated support members 120 in the embodiment illustrated in FIG. 11C may not be connected to respective ones of the elongated support members 122.

Similarly, the various distributed interconnecting structures, e.g., 30, . . . 30^{XII} and 35, 35′, 35″ have been described herein as being affixed to the interior surfaces of the planar foils 20A, 20B. In some of the various embodiments of such distributed interconnecting structures provided in the form of a plurality of elongated support members, e.g., 32, 80, 82, 90, 92, 94, 96, 140, 150, 154, 160, 170, 180, 182, 110, 120, 122, 130, the plurality of such elongated support members have also been described herein as being affixed to the interior surfaces of the planar foils 20A, 20B within one or more of the zones 18A-18E. It will be understood that while such distributed interconnecting structures are indeed affixed to the interior surfaces of both planar foils 20A, 20B within any one such zone, and such distributed interconnecting structures provided in the form of a plurality of elongated support members are likewise affixed to the interior surfaces of both planar foils 20A, 20B within any one such zone, one or more of the individual elongated support members within any such distributed interconnecting structure or plurality of elongated support members may be affixed to the interior surface of only one or the other of the planar foils 20A, 20B. For example, one or more of the elongated support members 32, 82, 96, 140, 150, 154, 160,270 180, 182 illustrated in the attached figures may, in alternate embodiments, include a gap between opposing ends thereof, or may not otherwise extend fully from the interior surface of one of the planar foils 20A, 20B to the other. Likewise, one or more of the elongated support members 202, 206, 210, 214, 216, 218 may be affixed only to the interior surface of the planar foil 20A, to the interior surface of the planar foil 20B, to one surface of the intermediate foil 200 or to the opposite surface of the intermediate foil 200. Thus, while it is true that the plurality of elongated support members within any of the panel zones, e.g., 19A-19D, the distributed interconnecting structure within any of the various zones 16A, 16B and/or 18A-18E and/or 18₁-18₄, and the plurality of elongated support members within any of the various zones 16A, 16B and/or 18A-18E and/or 18₁-18₄, are generally affixed within such zones to the interior surfaces of both of the planar foils 20A, 20B, one or more of the individual elongated support members within any such distributed interconnecting structure or plurality of elongated support members may be affixed to the interior surface of only one or the other of the planar foils 20A, 20B.

It will be further understood that the various embodiments of the distributed interconnecting structures illustrated in FIGS. 12A-21 are simplified diagrams intended to illustrate some of the general concepts thereof such as, for example, configuring the various elongated interconnecting members to collapse in a controlled cross-machine direction, e.g., to the left or right. Such embodiments are generally not intended to accurately depict various dimensions of the illustrated distributed interconnecting structures, such as material thickness, spacing between individual members, and the like. Those skilled in the art will recognize that some additional configuration of some of the embodiments illustrated in FIGS. 12A-21 may be desired in order to ensure the controlled collapse of the illustrated elongated support members in the desired direction(s). For example, in the embodiments illustrated in FIGS. 12A-12D, 13A-13B, 15A-15B, 20 and 21, it may be desirable to separate each of the individual elongated support members in the cross-machine direction by an amount equal to approximately ½ of the diameter of the curvature thereof, although it will be understood that such spacing may further vary depending upon any of a number of factors including, for example, but not limited to the thickness of the elongated support members, distance J between the planar foils 20A, 20B, the diameter(s) of the curvatures of the elongated support members, and the like.

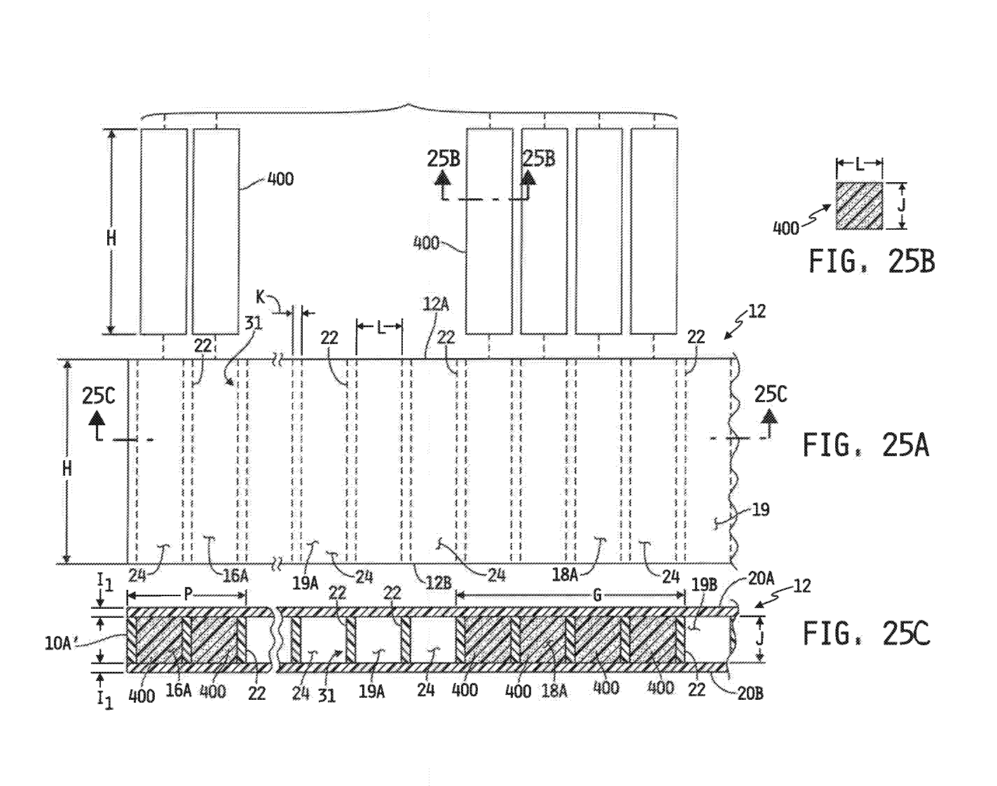

Referring now to FIGS. 25A-25C, another embodiment of a panel 12 is shown. In the illustrated embodiment, the panel 12 has an interconnecting structure 31, in the form of a plurality of elongated support members 22, attached to the interior surfaces of each of the planar foils 20A, 20B. Each elongated support member 22 illustratively extends linearly in the machine direction between the foil ends 12A, 12B and the elongated support members 22 are spaced apart in the cross-machine direction between the sides of the panel 12. In the illustrated embodiment, the elongated support members 22 each have length H and height J, as described above, and are spaced apart from each other by a space or channel 24. In the embodiment illustrated in FIGS. 25A-25C, each of the elongated support members 22 has a thickness or width K and each of the channels 24 have a width L.

One or more living hinge zones can illustratively be formed in the panel 12 in a conventional manner, or by selectively providing elongated filler members 400 in any number of the channels 24 sequentially across a section of a desired width of the panel 12 and then forming a living hinge at such a section. Similarly, one or more end zones can illustratively be formed in the panel 12 in a conventional manner, or by selectively providing elongated filler members 400 in any number of the channels sequentially across a section of a desired width of the panel 12 adjacent to either or both of the sides thereof. In the embodiment illustrated in FIGS. 25A-25C, for example, an end zone 16A is selectively formed by providing elongated filler members 400 within the first two sequential channels 24 adjacent to the side 10A′ of the panel 12 such that an end zone 16A of width P is defined between the panel size 10A′ and an adjacent panel zone 19A. Alternatively or additionally, an end zone 16B may be selectively formed by providing such elongated filler members 400 within sequential channels 24 adjacent to the opposite side 10B′ of the panel 12. It will be understood that although the end zone 16A is illustrated in FIGS. 25A and 25C as being formed by providing elongated filler members 400 in each of the two sequential channels 24 adjacent to the side 10A′ of the panel 12, this disclosure contemplates that the end zone 16A and/or an end zone 16B may alternatively be formed in this embodiment by providing elongated filler members 400 in any number of sequential channels adjacent to either side 10A′, 10B′ of the panel 12.

As also shown in the embodiment illustrated in FIGS. 25A-25C a living hinge zone 18A is selectively formed by providing elongated filler members 400 sequentially within a subset of channels 24 between a panel zone 19A and another panel zone 19B. In the illustrated embodiment, for example, a living hinge zone 18A is selectively formed by providing elongated filler members 400 within the four sequential channels 24 between the panel zones 19A and 19B such that a living hinge zone 18A of width G is defined between the panel zones 19A, 19B. It will be understood that although the living hinge zone 18A is illustrated in FIGS. 25A and 25C as being formed by providing elongated filler members 400 in each of the four sequential channels 24 between the panel zones 19A, 19B, this disclosure contemplates that the living hinge zone 18A (and/or any other living hinge zone formed in another area of the panel 12) may alternatively be formed in this embodiment by providing elongated filler members 400 in any number of sequential channels between two panel zones such that a living hinge zone of any desired width is selectively formed between and contiguous with panel zones on either side thereof.

In the embodiment illustrated in FIGS. 25A-25C, L and J are illustratively equal such that the channels 24 formed between adjacent ones of each of the plurality of elongated support members 22 have a square cross-section. In this particular embodiment, each of the elongated filler members 400 is accordingly a square cuboid as shown is FIG. 25B. It will be understood, however, that this disclosure contemplates embodiments in which the cross-sections of the channels 24 have other shapes, and that the elongated filler members 400 will accordingly have an external shape that matches that of the cross-sectional shape of the channels 24. Examples of such cross-sectional shapes include, but are not limited to, rectangular, triangular, oval, circular, D-shaped, and the like.

As illustrated by example in FIGS. 11A-11D, this disclosure further contemplates embodiments in which the interconnecting structure 31 is alternatively provided in the form of a plurality of piecewise linear or non-linear elongated support members, e.g., 100, 110, 120, 122, 130, spaced apart along the width of the panel 12. In such embodiments, it will be noted that such a structure may define more than one channel between each elongated member and one or more adjacent structures. For example, whereas each elongated support member 22 defines a single channel 24 between itself, the interior surface of the planar foil 20A, the interior surface of the planar foil 20B and an adjacent elongated support member 22, a piecewise linear or non-linear elongated support member may define more than one channel between itself and at least one of the interior surface of the planar foil 20A, the interior surface of the planar foil 20B and an adjacent elongated support member. In the embodiment illustrated in FIG. 11A, for example, each diagonal support member 102 bisects the channel formed between adjacent support members 22 such that two channels having triangular cross-section extend between each adjacent pair of elongated support members 22. In the embodiment illustrated in FIG. 11C, as another example, two channels having identical cross-sectional areas are defined between each of the support members 120, 122 and an interior surface of a respective one of the planar foils 20A, 20B, and two additional channels, also having identical cross-sectional areas but different than those just noted, are defined between each elongated support member 22 and two abutting or connected support members 120, 122, such that four channels extend between each adjacent pair of elongated support members 22.

In some embodiments, suitably shaped elongated filler members 400 are provided in each of the number of channels formed between each adjacent set of elongated support members. In other embodiments, suitably shaped elongated filler members 400 may be provided in fewer than all of the number of such channels formed between one or more of the adjacent sets of elongated support members. In some embodiments, suitably shaped elongated filler members 400 may be provide in only one of a plurality of channels formed between one or more of the adjacent sets of elongated support members.

In some embodiments, the panel 12 is formed separately from the elongated filler members 400 and in such embodiments the elongated filler members 400 are inserted into the one or more channels between adjacent ones of the elongated support members. In such embodiments, the elongated filler members 400 may be sized to have the same cross-sectional dimensions as those of the channels into which they will be inserted, or may be sized smaller or larger depending upon the type of material from which they are formed. In some embodiments, the elongated filler members 400 may be sized such that they completely fill the cross-sectional area of the channels into which they are inserted, and in some alternate embodiments one or more of the elongated filler members 400 may be sized such that it/they do not completely fill the cross-sectional area of the channel(s) into which it/they is/are inserted. In some embodiments, the lengths of the elongated filler members 400 are sized such that they extend between the top 12A and the bottom 12B of the panel 12, although in other embodiments the lengths of one or more of the elongated filler members 400 may be sized such that they do not extend completely between the top 12A and the bottom 12B of the panel 12. As one example, the lengths of the elongated filler members 400 used to form the zones 18D and 18E in the panel 12 illustrated in FIG. 22A may extend only from the top 12A of the panel 12 to the lateral hinge 222.

In other embodiments, the panel 12 and the elongated filler members 400 may be of uniform construction, and may illustratively be formed by extrusion. In either embodiment, the elongated filler members 400 may be formed of various materials selected for the purpose for which they serve. For example, when used to form living hinge zones and/or end zones which require heating and flowing and/or bonding of the elongated filler members 400, the elongated filler members 400 may illustratively be formed of a material which will flow when heated and which will bond to the material from which the panel 12 is formed. As one illustrative example, in embodiments in which the panel 12 is formed of polypropylene, the elongated filler members 400 may be formed of a polypropylene foam, e.g., a high density polypropylene foam such as expanded polypropylene or expanded polypropylene foam. As another example, when used to form a zone in which it is desirable to enhance the deformation resistance of the panel 12, the elongated filler members 400 may illustratively be formed of a corresponding material that resists deformation under compression. Those skilled in the art will recognize other suitable materials from which to form the elongated filler members 400, and such other materials are contemplated by this disclosure. Additionally, those skilled in the art will recognize other material properties which may be desirable for one or more of the elongated filler members 400 to have, and will further recognize other corresponding materials suitable to achieve such other material properties, and any such other materials and material properties are contemplated by this disclosure. Examples of such other material(s) that may be used to form the elongated filler members 400 include, but are not limited to, at least one of a polypropylene foam, a high-density polypropylene foam, an expanding foam, a non-expanding foam, a low-density polyether, polyester, polyvinyl acetate, a flexible plastic material, a rigid plastic material, wood, a wood composite, paper, cellulose, one or a combination of metals, a metal composite, a textile, a formable medium and a curable medium. For purposes of this disclosure, a formable medium will be understood to be any medium which is initially flowable when dispensed and which thereafter hardens on its own to a flexible, semi-rigid or rigid state. Also for purposes of this disclosure, a curable medium will be understood to be any medium which is initially flowable when dispensed and which thereafter hardens to a flexible, semi-rigid or rigid state via one or more additives or agents or via application of heat and/or radiation.

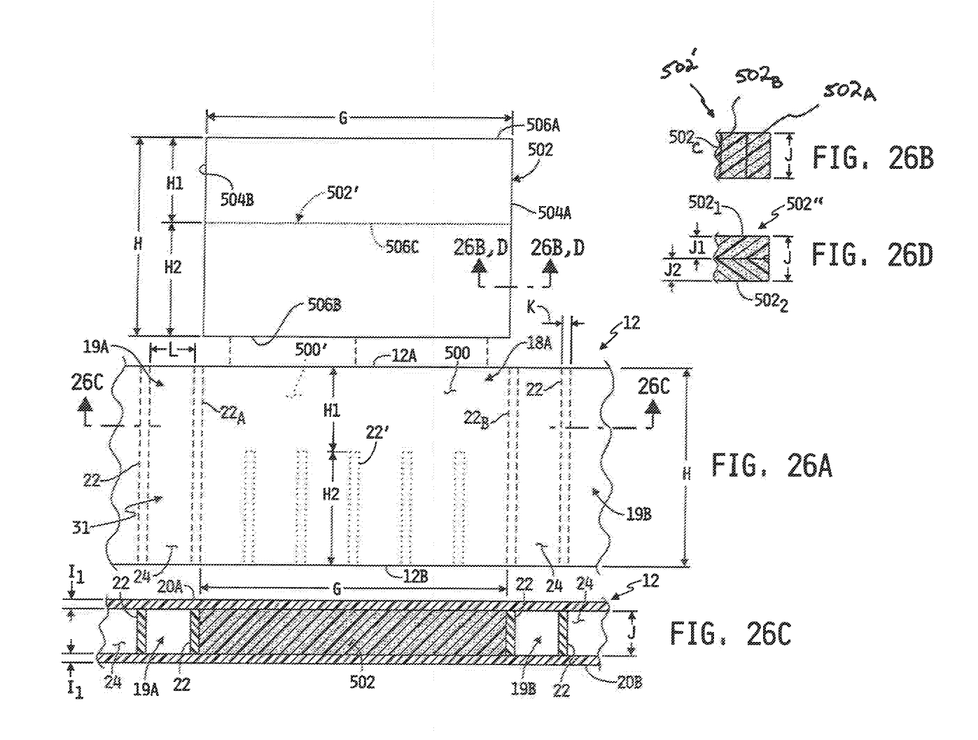

Referring now to FIGS. 26A-26D, another embodiment of a panel 12 is shown. In the illustrated embodiment, the panel 12 has an interconnecting structure 31, in the form of a plurality of elongated support members 22, attached to the interior surfaces of each of the planar foils 20A, 20B in each of two spaced-apart sections 19A and 19B of the panel 12. Each elongated support member 22 illustratively extends linearly in the machine direction between the foil ends 12A, 12B and the elongated support members 22 are spaced apart in the cross-machine direction along each section 19A, 19B. In the illustrated embodiment, the elongated support members 22 each have length H and height J, as described above, and are spaced apart from each other by a space or channel 24. In the embodiment illustrated in FIGS. 26A and 26C, each of the elongated support members 22 has a thickness or width K and each of the channels 24 have a width L.

One or more elongated members 22 may illustratively be selectively omitted (or removed) in a region 500, e.g., a living hinge zone 18A, defined between the two sections 19A, 19B of the panel 12. In the embodiment illustrated in FIGS. 26A and 26C, for example, multiple adjacent (i.e., sequential) elongated members 22 are selectively omitted during fabrication of the panel 12 or selectively removed after fabrication of the panel 12 to form the region 500 positioned between the two spaced-apart sections 19A and 19B of the panel 12. In some embodiments of the panel 12 in which the thicknesses, I₁, the material composition and/or the material construction of the panel foils 20A, 20B and/or the height and/or width of the region 500 are deemed sufficient to support formation of a living hinge across the region 500, the region 500 may be left open, i.e., hollow and devoid of any filler material or member. In other embodiments, such as illustrated in FIGS. 26A-26D, a single filler member 502 or multiple filler members may be provided within the region 500.

In the embodiment illustrated in FIGS. 26A and 26C, the living hinge zone 18A is selectively formed between the panel sections 19A and 19B by providing a single filler member 502 within the region 500 in which the elongated support members 22 were not formed during fabrication of the panel 12 or in which the elongated support members 22 were formed during fabrication of the panel 12 but were then subsequently removed, e.g., via a conventional cutting, grinding or other removal process. In the illustrated embodiment, the single filler member 502 has a height H defined between opposing ends 506A, 506B thereof that is illustratively equal to, or approximately equal to, the height H of the panel 12 between the two ends 12A, 12B thereof. The filler member 502 also illustratively has a width G defined between opposing sides 504A, 504B thereof that is illustratively equal to, or approximately equal to, the width G of the panel 12 in the region 500. The filler member 502 further illustratively has a thickness J, as illustrated in the cross-section of FIG. 26B, that is illustratively equal to, or approximately equal to, the thickness J of the panel 12 defined between the opposed interior surfaces of the panel foils 20A, 20B as illustrated in FIG. 26C. In some alternate embodiments, such as in which the filler member 502 is a deformable and/or resilient material such as a foam, cellulose or other such deformable and/or resilient material, the height H of the filler member 502 may be greater than the height H of the panel 12, the width G of the filler member 502 may be greater than the width G of the region 500, and/or the thickness J of the filler member 502 may be greater than the thickness J of the space defined between the opposed inner surfaces of the panel foils 20A, 20B, such that the total volume of the filler member 502 is greater than that of the region 500 defined by the panel 12. In such embodiments, the filler member 502 may illustratively be compressed in height, thickness and or width before or during insertion into the region 500. In other alternate embodiments, the height H of the filler member 502 may be less than the height H of the panel 12, the width G of the filler member 502 may be less than the width G of the region 500, and/or the thickness J of the filler member 502 may be less than the thickness J of the space defined between the opposed inner surfaces of the panel foils 20A, 20B, such that the total volume of the filler member 502 is less than that of the region 500 defined by the panel 12. The same may be true in either case of one or more of the filler members 400 in alternate implementations of the embodiment illustrated in FIGS. 25A-25C.

In still other alternate embodiments, the single filler member 502 may be provided in the form of multiple filler members sized to be suitably arranged within the region 500. In the embodiment illustrated in FIG. 26B, for example, the filler member 502′ includes multiple filler members, e.g., 502_{A}, 502_{B}, 502_{C} . . . , positioned within the region 500 in side-by-side relationship. As another example, the filler member 502″ in the embodiment illustrated in FIG. 26D includes multiple filler members, e.g., 502₁ of height J1 and 502₂ of height J2, where J=J1+J2, positioned within the region 500 in a stacked relationship, i.e., one on top of the other. As yet another example, the filler member 502 may be provided in the form of multiple filler members positioned within the region 500 in an end-to-end relationship along the height H of the region 500. Again, the same may be true of one or more of the filler members 400 in alternate implementations of the embodiment illustrated in FIGS. 25A-25C. Other arrangements or patterns of multiple filler members will occur to those skilled in the art, and it will be understood that any such other arrangements or patterns are intended to fall within the scope of this disclosure.

In any case, a living hinge zone 18A of width G is thus defined between the panel zones 19A, 19B along the region 500, and a living hinge may be formed along the zone 18A as described hereinabove. In some embodiments, such a living hinge may be formed strictly along region 500, i.e., such that the material forming the resulting living hinge includes only the foils 20A, 20B and the filler member 502, or sub-portions thereof. In other embodiments, the living hinge may include portions of the panel 12 to the left and/or to the right of the region 500 such that the material forming the resulting living hinge may include the foils 20A, 20B, the filler member 502 and one or more of the elongated support members 22 within the section 19A and/or within the section 19B.

It will be understood that although the living hinge zone 18A is illustrated in FIGS. 26A-26D as being formed by providing at least one filler member 502, 502′, 502″ within the region 500 extending between the two opposing ends 12A, 12B of the panel 12, this disclosure contemplates that only a portion of the height of the region 500, e.g., that portion H1 defined between the end 12A and extending toward the end 12B, may be formed without, or have removed therefrom, the elongated support members 22 as illustrated by dotted-line representation in FIG. 26A. For example, the dotted line representation 506C illustratively represents a truncated-height filler member 502′ having a height H1, e.g., formed without or having removed therefrom a height H2 (where H=H1+H2), and the dotted-line lateral sequence of elongated support members 22′ extending between the elongated support members 22A, 22B represent correspondingly truncated-height elongated support members which each extend a height H2 from the end 12B of the panel 12 toward the end of the panel 12A, thereby leaving a region 500′ of height H1 between the end 12A of the panel and the truncated ends of the elongated support members 22′, and between the opposing sides defined by the opposing faces of the elongated support members 22A, 22B, in which the elongated support members 22′ were not formed during fabrication of the panel 12 or in which the elongated support members 22′ were formed during fabrication of the panel 12 but were subsequently removed. In this alternate embodiment, the one or more filler members 502, 502′, 502″ inserted into the region 500′ will thus extend from the truncated ends of the number of elongated support members 22′ to, or approximately to, the end 12A of the panel 12.

In some embodiments, the panel 12 may include an end zone 16A and/or 16B as illustrated and described hereinabove. Any such end zone may illustratively be formed without elongated support members 22 in a region thereof, or by forming in and subsequently removing, at least partially, one or more such elongated support members in a region thereof, as just described with reference to FIGS. 26A-D, and then inserting, or forming therein, a single filler member (or multiple filler members). Referring to the embodiment illustrated in FIGS. 25A and C, for example, such an end-zone 16A may be formed using the techniques illustrated and described with respect to FIGS. 26A-26D by forming the illustrated end zone 16A without the middle elongated support member 22, or by removing the middle elongated support member 22, and then inserting, or forming therein, a single (or multiple) filler member, e.g., the filler member 500 with a suitably truncated width.

In some embodiments, the suitably shaped one or more filler members 502, 502′, 502″ may be formed of various materials selected for the purpose for which they serve. For example, when used to form living hinge zones and/or end zones which require heating and flowing and/or bonding of the one or more filler members 502, 502′, 502″, the one or more filler members 502, 502′, 502″ may illustratively be formed of a material or materials which will flow when heated and which will bond to the material from which the panel 12 is formed. As one illustrative example, in embodiments in which the panel 12 is formed of polypropylene, the one or more filler members 502, 502′, 502″ may be formed of a polypropylene foam, e.g., a high density polypropylene foam such as expanded polypropylene or expanded polypropylene foam. As another example, when used to form a zone in which it is desirable to enhance the deformation resistance of the panel 12, the one or more filler members 502, 502′, 502″ may illustratively be formed of one or more corresponding materials that resist deformation under compression.

In some embodiments, the panel 12 is formed separately from the one or more filler members 502, 502′, 502″, e.g. as a unitary or laminated constructions, and in such embodiments the one or more filler members 502, 502′, 502″ is/are illustratively inserted into the region 500 as illustrated in FIGS. 26A-26D. In some such embodiments, the panel 12 may be formed without the elongated support members 22 in the region 500, and in other embodiments the panel 12 may be formed with the elongated support members 22 in the region 500 and subsequently removed therefrom, e.g., using a conventional material removal process. In other embodiments, the panel 12 and the one or more filler members 502, 502′, 502″ may together be of uniform construction, and may illustratively be formed by extrusion. In any such embodiments, the one or more filler members 502, 502′, 502″ may be illustratively sized to have the same volumetric and/or cross-sectional dimensions as that of the region 500 into which it/they will be inserted, or may be sized smaller or larger depending upon the type of material from which it/they is/are formed. In some embodiments, the one or more filler members 502, 502′, 502″ may be sized such that it/they completely fill the volume and/or cross-sectional area of the region 500 into which it/they is/are inserted, and in some alternate embodiments the one or more filler members 502, 502′, 502″ may be sized such that it/they does/do not completely fill the volume and/or cross-sectional area of the region 500 into which it/they is/are inserted, as described above.

Those skilled in the art will recognize other suitable materials from which to form the one or more filler members 502, 502′, 502″, and it will be understood that such other materials are contemplated by this disclosure. Additionally, those skilled in the art will recognize other material properties which may be desirable for the one or more filler members 502, 502′, 502″ to have, and will further recognize other corresponding materials suitable to achieve such other material properties. It will be understood that any such other materials and material properties are contemplated by this disclosure. For example, in some embodiments the one or more filler members 502, 502′, 502″, and/or one or more of the elongated filler members 400 illustrated and described with respect to FIGS. 25A-25C, may include multiple layers of the same, similar and/or different materials and/or material properties and/or material characteristics. In the embodiment illustrated in 26D, for example, the layer 502₁ may be identical to, similar to or different from the layer 502₂ in material composition and/or one or more material properties, and/or the layer 502₁ may be affixed, bonded or otherwise coupled to the layer 502₂ or may be separate from, i.e., not affixed, bonded or otherwise coupled to, the layer 502₂. The same may be true of any combination of the layers 502_{A}, 502_{B} and 502_{C} in the embodiment illustrated in FIG. 26B. In other embodiments, the one or more filler members may alternatively include two or more diagonally stacked layers, or two or more layers arranged in some other linear or non-linear pattern, separately from or in addition to two or more vertically or horizontally stacked layers.

In any multi-layer embodiment of the one or more filler members 502, 502′, 502″, and/or of one or more of the elongated filler members 400, such layers may be selected based on any number of factors including, but not limited to, any one or combination of cost, one or more material properties, one or more material performance characteristics, or the like. Examples of different material properties and/or material characteristics which two or more layers forming the one or more filler members 502, 502′, 502″ (and/or one or more of the elongated filler members 400) may have include, but are not limited to, different material density, different melting point(s), different coefficient(s) of friction and/or dry friction, different rigidity, different ductility, different thermal expansion characteristics, different curing and/or cooling characteristics, different material bonding properties, and the like. As one example, in some embodiments in which the panel 12 is formed separately from the one or more filler members 502, 502′, 502″ (and/or from one or more of the elongated filler members 400) such that the one or more filler members 502, 502′, 502″ is/are inserted into the region 500 (and/or one or more of the elongated filler members 400 is/are inserted into the channel(s) 24), a higher density material, e.g., high-density polypropylene foam, may be sandwiched between lower-density material layers, e.g., low-density polypropylene foam. Alternatively, two outer layers may sandwich an inner layer, wherein the outer layers may be formed of a low-friction material. In either case, the outer layers are selectively chosen to facilitate insertion of the one or more filler members 502, 502′, 502″ within the region 500 (and/or insertion of one or more of the elongated filler members 400 into one or more corresponding channels 24) by providing outer surfaces that may be less likely to catch, bind or otherwise stick to surfaces inside of the panel 12 during insertion thereof.

As another example, in some embodiments in which the panel 12 is formed integrally with the one or more filler members 502, 502′, 502″ (and/or with the one or more filler members 400), e.g., as part of an extrusion process, the one or more filler members 502, 502′, 502″ (and/or one or more of the filler members 400) may be formed of two or more materials of different density which, when combined with the material used to form the foils 12A, 12B and elongated support members 22, provide for overall uniformity of material in the machine and/or cross-machine direction(s) in order to promote uniform cooling and/or curing thereof.

Those skilled in the art will recognize other desirable material properties and/or material performance characteristics that may be realized by providing the one or more filler members 502, 502′, 502″ (and/or one or more of the elongated filler members 400) in the form of two or more layers of identical, similar or different materials, and any number of layers of any material combination that provides any such material properties and/or material performance characteristics are contemplated by this disclosure. Example material(s) that may be used to form one or any combination of the one or more filler members 502, 502′, 502″ may be the same as those described above with respect to the elongated filler members 400, which include, but are not limited to, at least one of a polypropylene foam, a high-density polypropylene foam, an expanding foam, a non-expanding foam, a low-density polyether, polyester, polyvinyl acetate, a flexible plastic material, a rigid plastic material, wood, a wood composite, paper, cellulose, one or a combination of metals, a metal composite, a textile, a formable medium and a curable medium.

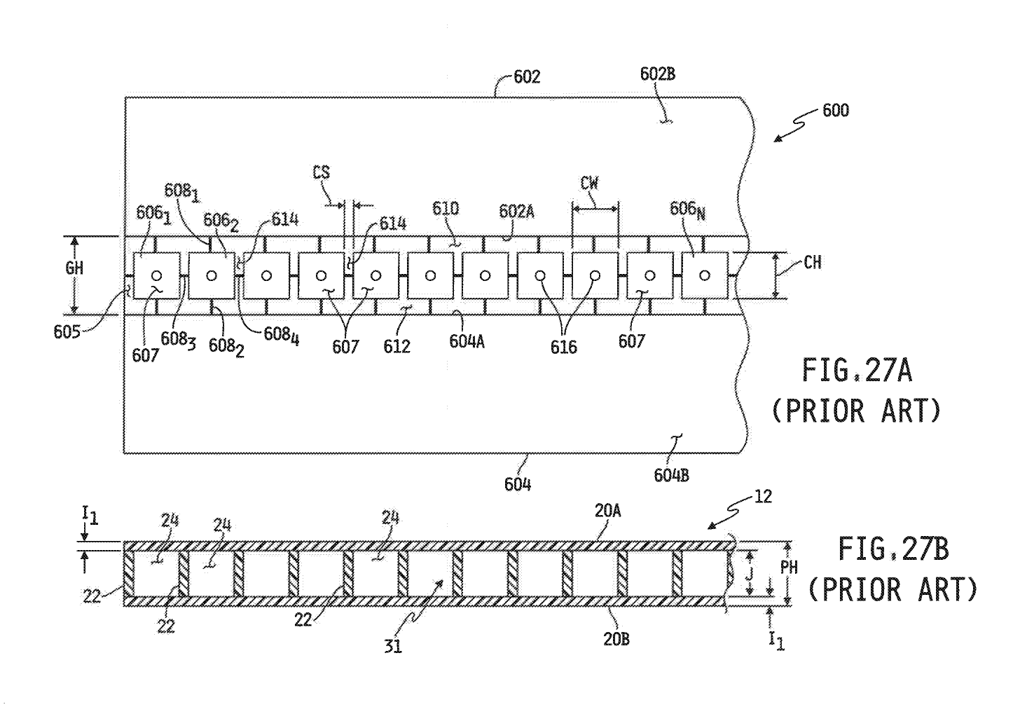

Referring now to FIGS. 27A and 27B, a conventional extrusion tool 600 is shown in FIG. 27A which may be used with, e.g., operatively coupled to, a conventional extruder to produce conventional panels 12 of the type shown in FIG. 27B (and also illustrated in FIG. 25A). In the illustrated embodiment, the extrusion tool 600 includes a top plate 602 and a bottom plate 604 (each sometimes referred to as a “die lip”) with an inner surface 602A of the top plate 602 spaced apart from an inner surface 604A of the top plate 602 to define an elongated channel or gap 605 therebetween. A number of cubes 606₁-606_{N} are sequentially arranged longitudinally within and along the gap 605, where N may be any positive integer. A top surface of each cube 606₁-606_{N} is coupled to the inner surface 602A of the top plate 602 via a connecting wire, fin or ribbon 608₁, a bottom surface of each cube 606₁-606_{N} is coupled to the inner surface 604A of the bottom plate 604 via another connecting wire, fin or ribbon 608₂, and opposing side surfaces of each cube 606₁-606_{N} is coupled to side surfaces of adjacent cubes via connecting wires, fins or ribbons 608₃ and 608₄. A passageway 616 is defined into and through each cube 606₁-606_{N} from a front face 607 through a rear face thereof.

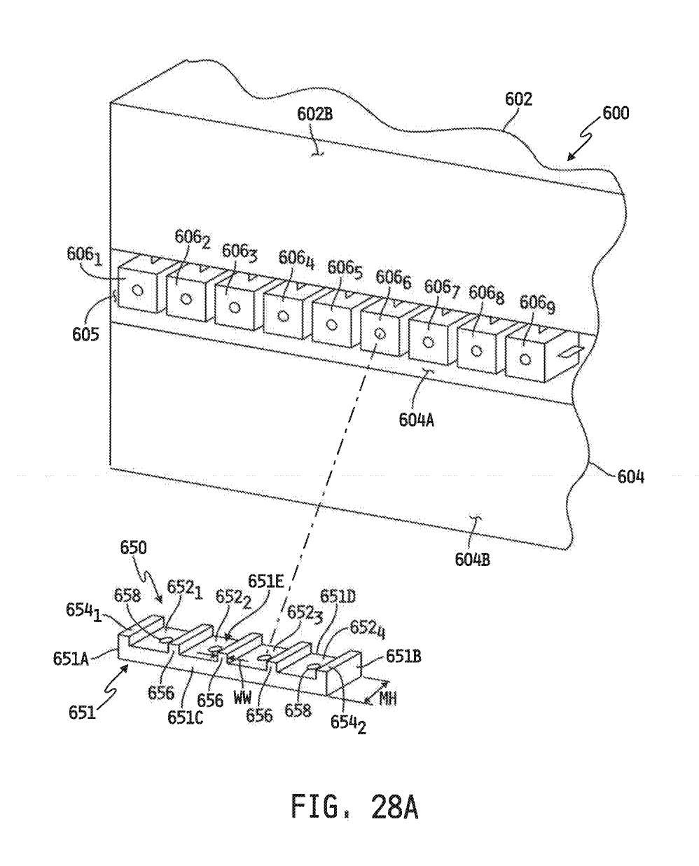

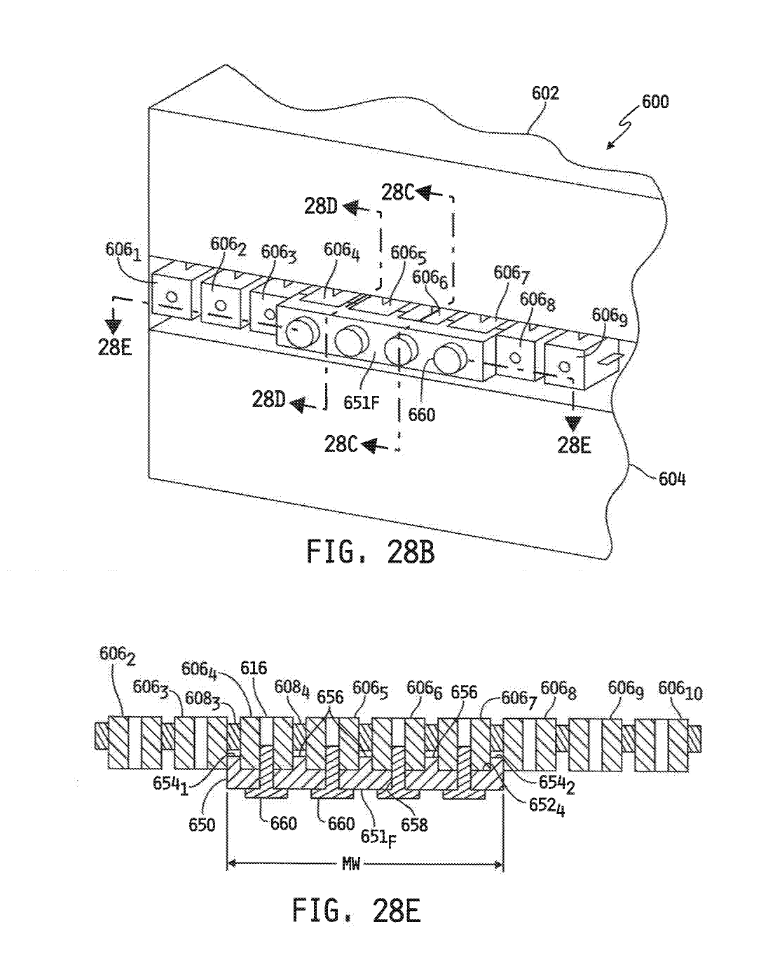

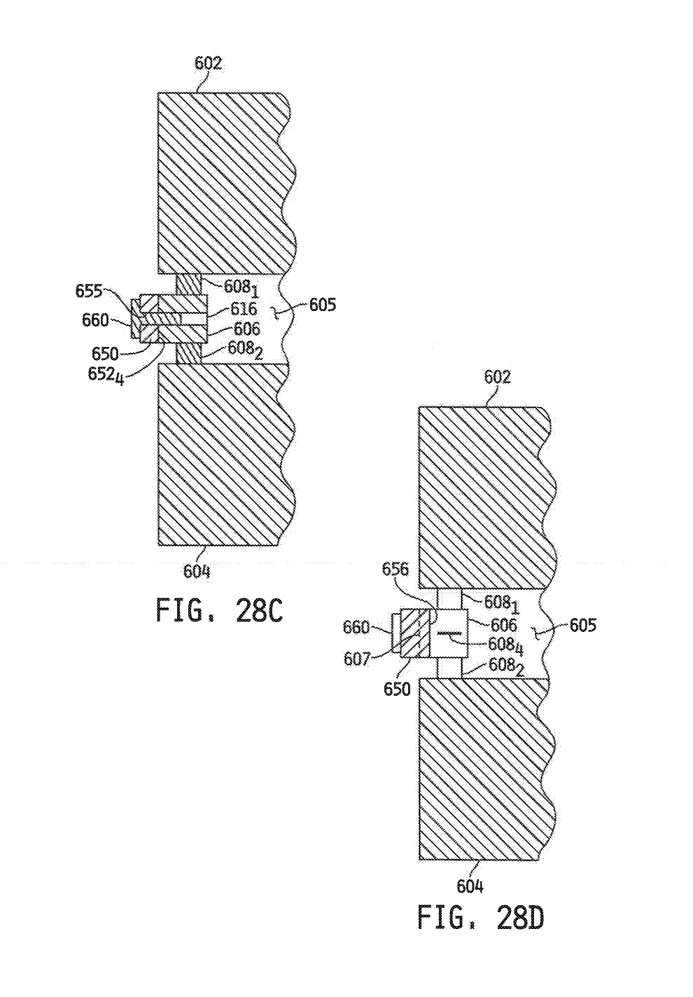

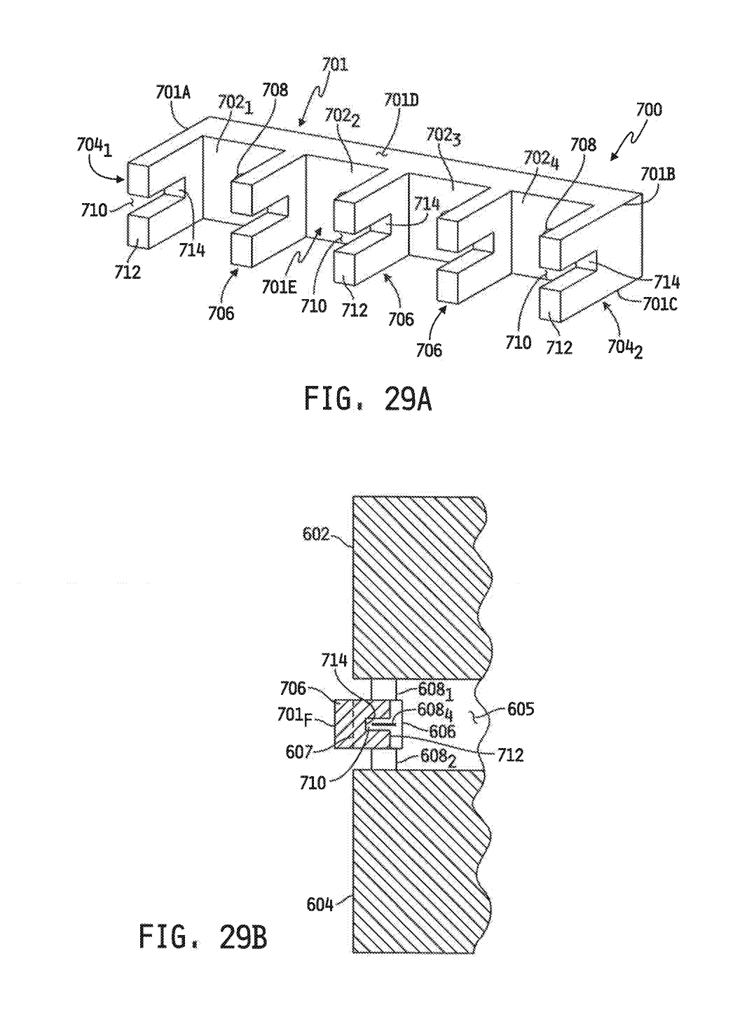

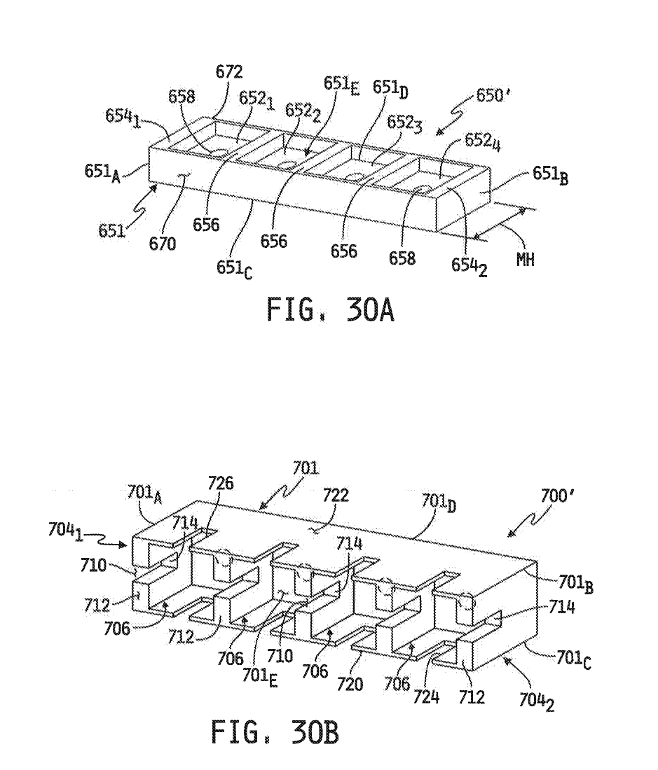

The cubes 606₁-606_{N} are illustratively arranged in the gap 605 such that the front faces 607 of the cubes 606₁-606_{N} are co-planar with each other and also with the front faces 602B and 604B of the top and bottom plates 602 and 604 respectively (see also FIGS. 28A, 28B and 29B). In the illustrated embodiment, the interconnecting fins or ribbons 608₁, 608₂, 608₃ and 608₄ are all transversely recessed within the space 605 such that the forward-most edge of each fin or ribbon 608₁, 608₂, 608₃, 608₄ (relative to the faces 602B, 604B and 607) is set back from the plane defined by the front faces 602B, 604B of the top and bottom plates 602, 604 and the front faces 607 of the cubes 606₁-606_{N} (see also FIGS. 28A, 28B and 29B). In other embodiments, one or more of the fins or ribbons 608₁, 608₂, 608₃, 608₄ may be differently positioned relative to the front face 602B of the top plate 602, the front face 604B of the bottom plate 604 and/or the front face 607 of the corresponding cube(s) 606₁-606_{N}.

In the embodiment illustrated in FIG. 27A, each cube 606₁-606_{N} has a cube height CH and a cube width CW, and the gap 605 has a gap height GH. In the illustrated embodiment, CH=CW, although in other embodiments CH may not be equal to CW. In any case, the cubes 606₁-606_{N} are arranged within the space 605 such that an elongated space 610 is defined between the cubes 606₁-606_{N} and the inner surface 602A of the top plate 602, another elongated space 612 is defined between the cubes 606₁-606_{N} and the inner surface 604A of the bottom plate 604, and spaces 614 are defined between adjacent cubes 606₁-606_{N}. In the illustrated embodiment, the space 610 is equal in height to the space 612, and the widths of the spaces 614 are all equal, although in other embodiments the height of the space 610 may not be equal to that of the space 612 and/or the spaces 614 may not all have equal width. In embodiments in which the height of the space 610 is equal to the height of the space 612, each such height is defined by the relationship (GH−CH)/2. The spaces 614 each illustratively have a width CS as illustrated in FIG. 27A.

Referring now to FIG. 27B, the illustrated panel 12 is illustratively identical to that illustrated in FIGS. 25A and 25C in that the panel 12 has an interconnecting structure 31 in the form of a plurality of elongated support members 22 attached to interior surfaces of each of a pair of opposing planar foils 20A, 20B. Each elongated support member 22 illustratively extends linearly in the machine direction between the foil ends 12A, 12B and the elongated support members 22 are spaced apart in the cross-machine direction between the sides of the panel 12. In the illustrated embodiment, the elongated support members 22 each have height J, as described above, and are spaced apart from each other by a space or channel 24. Although not shown in FIG. 27B for clarity of illustration, each of the elongated support members 22 has a thickness or width K and each of the channels 24 have a width L as illustrated in FIGS. 25A and 25C. The thickness of each of the planar foils 20A, 20B is I₁, and the panel height PH (i.e., the total height of the panel 12) is given by PH=2I₁+J.

FIGS. 27A and 27B are horizontally aligned to demonstrate that the elongated support members 22 align with the spaces 614 between the cubes 606₁-606_{N} through which the elongated support members 22 are formed. Although not shown in FIG. 27A, air/vacuum lines are typically coupled to the holes 607 to provide air flow into/out of the channels 24 for the purpose of controlling cooling of the extruded panel 12 and/or controlling the dimensions of one or more structures of the panel 12. In some embodiments, the gap height GH is adjustable across the tool 60, e.g., via vertical adjustment of the top plate 602 and/or inner surface 602A thereof relative to the bottom plate 604 and/or inner surface 604A thereof and/or vice versa. In any case, the panel foils 20A, 20B are formed through the spaces 610 and 612 respectively. It is generally understood that at least some of the dimensions of the panel 12, e.g., the height of the elongated support members 22, the thickness of the elongated support members 22 and/or the thickness of either or both of the panel foils 20A, 20B, may generally be controlled via control of one or more of the gap height GH, variations in the gap height GH across the tool 600, flow rate of air/vacuum through the holes 616, flow rate and/or other flow characteristics of the material being extruded, temperature of the material being extruded, post-extruded cooling rate of the material being extruded and the like.

Referring now to FIGS. 28A-28E, an embodiment is shown of an extrusion tool mask 650 configured to selectively mount to a number Q of the cubes 606₁-606_{N} and mask or cap a corresponding sequential number Q+1 of the spaces 614 between and adjacent to such Q cubes for the purpose of blocking the passage therethrough of the material being extruded, wherein Q may be any positive integer. With such an extrusion tool mask 650 installed on the extrusion tool 600, panels 12 extruded using the combination of the extrusion tool 600 and the extrusion tool mask 650 will thus be missing Q+1 sequential elongated support members 22 in the area corresponding to the Q+1 spaces 614 of the extrusion tool 600 blocked by the extrusion tool mask 650. It will be understood that any number of such extrusion tool masks 650, each configured to engage one or more cubes 606₁-606_{N}, may be selectively installed longitudinally along the gap 650 in the extrusion tool 600 to thereby produce an extruded panel 12 missing one or more elongated support members 22 in one or more corresponding selected areas or regions of the panel 12.

The extrusion tool mask 650 illustrated in FIGS. 28A-28E has an elongated base 651 extending from one end 651A to an opposite end 651B thereof and extending between opposing sides 651C and 651D thereof. A cube engaging surface 651E of the base 651 defines four planar faces 652₁-652₄ each separated by a wall 656 extending upwardly and away from the cube engaging surface 651E. In the illustrated embodiment, an end wall 654₁ extends upwardly away from the cube engaging surface 651E at the end 651A of the base 651 at one end of the planar face 652₁ and another end wall 654₂ extends upwardly away from the cube engaging surface 651E at the opposite end 651B of the base 651 at one end of the planar face 652₄. Between each set of opposing walls, the base 651 illustratively defines a passageway 658 centrally through each planar surface 652₁-652₄ which extends through and between the cube engaging surface 651E and an opposite surface 651F of the base 651. As illustrated in FIG. 28A, each wall 656 and end wall 654₁, 654₂ defines a wall width WW, and the extrusion tool mask 650 illustratively has a height MH between the sides 651C, 651D which defines the heights of each of the planar surfaces 652₁-652₄ and of each of the walls 654₁, 654₂ and 656.

As illustrated in FIGS. 28B-28E in particular, the extrusion tool mask 650 is configured to be installed on the extrusion tool 600 with the planar faces 652₁-652₄ each engaging the front, exposed face 607 of a different one of the cubes, e.g., cubes 606₄-606₇ respectively, with each of the walls 654₁, 654₂, 656 extending into the space 614 between adjacent ones of such cubes. Thus installed, the walls 654₁, 654₂, 656 operate to block the passage of extruded material through corresponding spaces 614 between adjacent cubes 606₁-606_{N} while allowing extruded material to pass through the spaces 610, 612 above and below the extrusion tool mask 650, thereby producing panels 12 with a region in which a number of sequential elongated support members 22 are selectively missing as illustrated in FIGS. 26A and 26C. In this regard, the height MH of the extrusion tool mask 650 is illustratively sized to be substantially equal to the cube height CH, i.e., substantially equal to the height of the cubes 606₁-606_{N}, and the width WW of each wall 654₁, 654₂, 656 is illustratively sized such that the walls 654₁, 654₂, 656 extend into the space 614 between adjacent cubes 606₁-606_{N} so as to block the passage of extruded material therethrough.

The widths WW of the walls 654₁, 654₂, 656 to block the passage of extruded material therethrough may illustratively be selected to be the same as, slightly less than or slightly greater than, the cube spacing CS, i.e., the width of the spacing 614 between each of the cubes 606₁-606_{N}, and in some embodiments the wall width WW may depend upon the type of material used to form the extrusion tool mask 650. In some example embodiments, for example, the extrusion tool mask 650 may be formed of an elastomeric material such as a flexible silicone material selected to withstand extrusion operating temperatures, and in such embodiments the widths WW of the walls 654₁, 654₂, 656 may be selected to be the same as, or slightly greater than, the cube spacing CS, i.e., the width of the spacing 614 between each of the cubes 606₁-606_{N}, such that the sides of the walls 654₁, 654₂, 656 contact, and in some embodiments engage, the sides of corresponding ones of the adjacent cubes 606₁-606_{N}. Alternatively, the widths WW of the walls 654₁, 654₂, 656 may be selected in such embodiments to be slightly less than the cube spacing CS. In other example embodiments, the extrusion tool mask 650 may be formed of a metal material or metal alloy, e.g. brass or other metal composite, and in such embodiments the widths WW of the walls 654₁, 654₂, 656 may be selected to be slightly less than the cube spacing CS so that the walls 654₁, 654₂, 656 may be received between adjacent cubes 606₁-606_{N} without damaging or deforming the cubes 606₁-606_{N} and/or the interconnecting wires, fins or ribbons 608₁, 608₂, 608₃, 608₄. Alternatively, the widths WW of the walls 654₁, 654₂, 656 may be selected in such embodiments to be substantially the same as the cube spacing CS such that the walls 654₁, 654₂, 656 form a tight fit with the cubes 606₁-606_{N} when inserted within the spaces 614. Those skilled in the art will recognize that in still other embodiments, the extrusion tool mask 650 may be formed of other suitable materials without limitation.

As illustrated in FIGS. 28D and 28E in particular, the height of the walls 654₁, 654₂, 656 relative to the planar faces 652₁-652₄ is illustratively selected to be less than the distance between the front, exposed faces of the cubes 606₁-606_{N} and the interconnecting wires, fins or ribbons 608₁, 608₂, 608₃, 608₄. In the embodiment illustrated in FIGS. 28A-28E, the height of the walls 654₁, 654₂, 656 relative to the planar faces 652₁-652₄ is so selected such that the terminal ends of the walls 654₁, 654₂, 656 will not contact, and therefore will not damage, the interconnecting wires, fins or ribbons 608₁, 608₂, 608₃, 608₄ when the extrusion tool mask 650 is installed on the extrusion tool 600. In some alternate embodiments, one or more of the walls of the extrusion tool mask may be configured to be longer while also avoiding contact with the interconnecting wires, fins or ribbons 608₁, 608₂, 608₃, 608₄, and an example of one such alternate embodiment of an extrusion tool mask 700 is illustrated in FIGS. 29A and 29B. In the embodiment illustrated in FIGS. 29A and 29B, the extrusion tool mask 700 is identical in many respects to the extrusion tool mask 650 in that the mask 700 includes a base 701 extending between two ends 701A, 701B and two opposite sides 701C, 701D, and a cube engaging face 701E of the base 701 defines a number, e.g., four in the illustrated embodiment, planar surfaces 702₁-702₄ each configured to engage a front face 607 of a different one of the cubes 606₁-606_{N}. Between each planar surface 702₁-702₄, a wall 706 extends upwardly and away from the cube engaging face 701E, and end walls 704₁ and 704₂ extend upwardly from the face 701E adjacent to the ends 701A, 701B respectively of the base 701. As with the extrusion tool mask 650, the base 601 of the extrusion tool mask 700 may illustratively define a passageway 608 centrally through each planar surface 702₁-702₄ which extends through and between the cube engaging surface 701E and an opposite surface 701F of the base 701.

In the embodiment illustrated in FIGS. 29A and 29B, the walls 704₁, 704₂, 706 further each define a channel or groove 710 which extends from a top surface 712 of the wall 704₁, 704₂, 706 toward a corresponding one of the planar surfaces 702₁-702₄ and terminating at a terminal end 714 of the channel 710 that is spaced apart from the corresponding planar surface 702₁-702₄. As illustrated in FIG. 29B in particular, which is the same view through the extrusion tool mask 700, as mounted to the extrusion tool 600, as shown in FIG. 28D, the wall 706 extends to, over and under the wire, fin or ribbon 608₄ with the wire, fin or ribbon 608₄ received within the channel 710 of the wall 706 but not contacting the terminal end 714 of the channel 710. Those skilled in the art will recognize other configurations of the walls extending upwardly from the planar faces of the extrusion tool mask, and it will be understood that such other configurations are contemplated by this disclosure.

Referring now to FIGS. 28A-29B, in some embodiments one or more of the planar faces 652₁-652₄ and/or 702₁-702₄ may define a passageway 658, 708 therethrough as briefly described above, and in such embodiments the passageway(s) 658, 708 are positioned relative to the planar faces 652₁-652₄, 702₁-702₄ to align with the passageways 616 defined through the cubes 606₁-606_{N} when the extrusion tool mask 650, 700 is installed on, i.e., mounted to, the extrusion tool 600. In such embodiments, the passageway(s) 658, 708 may serve a single function or several functions. In the embodiment illustrated in FIGS. 28A-29B, for example, the passageway(s) 658, 708 may illustratively form part of a mounting structure for securing the extrusion tool mask 650, 700 to the cubes 606₁-606_{N}. Referring specifically to FIGS. 28B, 28C and 28E, a fixation member 660 may be passed through one or more sets of aligned the passageways 658/708 and 616 to secure the extrusion tool mask 650, 700 to one or more corresponding cubes 606₁-606_{N}. In one example embodiment, the fixation member(s) 660 may be provided in the form of a headed elastomeric plug, e.g., a flexible silicone or other such material selected to withstand extrusion operating temperatures, having a shaft configured to extend through the passageway(s) 658/708 and at least partially into the passageway(s) 616 and sized to engage the passageway(s) 658/708 and/or 616 with a friction fit (also known as a press fit or interference fit). In some alternate embodiments, the fixation member(s) 660 may be provided in the form of a headed, rigid plug having a shaft configured to extend through the passageway(s) 658/708 and the passageway(s) 616 and engage the back or rearward face of the cubes 606₁-606_{N}. In still other embodiments, one or more of the passageways 616 may be threaded, and in such embodiments the fixation member(s) 660 (and, in some embodiments, the passageway(s) 658, 708) may be also be threaded and the fixation member(s) 600 may threadingly engage the passageways 616 of one or more of the cubes 606₁-606_{N} (and, in some embodiments, the passageway(s) 658, 708 of the extrusion tool mask 650, 700). Those skilled in the art will recognize other structures and techniques for securing one or more extrusion tool masks 650, 700 to selected cubes 606₁-606_{N} of the extrusion tool 600, and it will be understood that any such other structures and/or techniques are contemplated by this disclosure. It will further be understood that while FIGS. 28B and 28E show the extrusion tool mask 650 mounted to the extrusion tool 600 with four fixation members 660, i.e., one for each of the four illustrated planar faces 652₁-652₄, fewer fixation members 660 (e.g., one or more) may be used to secure an extrusion tool mask 650, 700 to the extrusion tool 600, and in such embodiments the extrusion tool mask 650, 700 may or may not include fewer passageways 658, 708.

In some embodiments, one or more passageway(s) 658, 708 may alternatively or additionally be provided to allow air to be passed, or vacuum to be drawn, therethrough for the purpose of controlling and/or facilitating cooling of the extruded panel 12 in the areas masked by the extrusion tool mask 650, 700. In still other embodiments, one or more passageway(s) 658, 708 may alternatively or additionally be provided for the purpose of extruding and/or injecting filler material into the region of the panels 12 masked by the extrusion tool mask 650, 700 as the panels 12 are being extruded. In such embodiments, the filler material may be a formable or curable material which at least partially fills the region of the panels 12 masked by the extrusion tool mask 650, 700, resulting in a panel structure similar or identical to that illustrated in FIG. 26C. In some embodiments, the filler material may be or include a foam material, e.g., an expanding foam material of desired density such as urethane, polyurethane or the like, a non-expanding or low-expansion foam of desired density such as polyurethane or the like. In some alternate embodiments, the filler material may be or include the same material, with modified, e.g., lesser, density, used to form the elongated support members 22 and planar foils 20A, 20B. Those skilled in the art will recognize other extrudable materials that may be used as the filler material, and it will be understood that such other extrudable materials are contemplated by this disclosure. In any case, the filler material extruded and/or injected through one or more of the passageways 658. 708 of the extrusion tool mask 650, 700 may be configured and/or selected in some embodiments to bond to the inner surfaces of the planar foils 20A, 20B and/or to the elongated support members 22 at the boundaries of the region of the panel 12 in which one or more of the elongated support members 22 are missing, and in other embodiments the filler material may be configured and/or selected such that it does not bond to the inner surfaces of the planar foils 20A, 20B and/or to the elongated support members 22 at the boundaries of the region of the panel 12 in which one or more of the elongated support members 22 are missing.

Still other embodiments are contemplated in which none of the foregoing functions served by one or more passageways 658, 708 are desired. In such embodiments, the extrusion tool mask 650, 700 may be formed with no passageways 650, 708.

In some embodiments, it may be desirable to include thin walls along the top(s) and/or bottom(s) of one or more of the planar faces 652₁-652₄ and/or 702₁-702₄ to facilitate locating, aligning and/or engaging the extrusion tool mask 650, 700 on one or more of the cubes 606₁-606_{N} of the extrusion tool 600. In this regard, FIG. 30A shows an example embodiment 650′ of the extrusion tool mask 650, and FIG. 30B shows an example embodiment 700′ of the extrusion tool mask 700, in which both masks 650′, 700′ have been modified to include a lower thin wall 670, 720 respectively along the side 651C, 701C respectively, and an upper thin wall 672, 722 respectively along the side 651D, 701D respectively, wherein the walls 670/672 and 720/722 extend from one end 651A, 701A to the opposite end 651B, 701B respectively of the mask 650′, 700′. In the embodiment illustrated in FIG. 30A, the top and bottom walls 670, 672 each have a height equal to the heights of the walls 654₁, 654₂ and 656, but have a thickness less than that, and in some embodiments much less than that, of the walls 654₁, 654₂ and 656. In the embodiment illustrated in FIG. 30B, the top and bottom walls 720, 722 each define a channel or slot 724, 726 respectively therein adjacent to each of the planar faces 702₁-702₄, and the channels or slots 724, 726 are illustratively as described with respect to the channels or slots 710. As with the top and bottom walls 670, 672 illustrated in FIG. 30A, the top and bottom walls 720, 722 in the embodiment illustrated in FIG. 30B each have a height equal to the heights of the walls 704₁, 704₂ and 706, but have a thickness less than that, and in some embodiments much less than that, of the walls 704₁, 704₂ and 706. The primary purpose of the top and bottom walls 670/672 and 720/722 is to facilitate locating, aligning, engaging and/or maintaining engagement of the extrusion tool mask 650, 700 on one or more of the cubes 606₁-606_{N} of the extrusion tool 600. In some alternate embodiments, only a top or a bottom wall may be included on the extrusion tool mask 650, 700. In other alternate embodiments, the bottom wall 670, 720 may be provided only between one, or less than all, pair(s) of the walls 654₁, 654₂ and 656, 704₁, 704₂ and 706 and/or the top wall 672, 722 may be provided only between one, or less than all, pair(s) of the walls 654₁, 654₂ and 656, 704₁, 704₂ and 706. In any of the described embodiments, the extrusion tool mask 650′, 700′ may or may not include one or more of the passageways 658, 708.

It will be understood that while the extrusion tool masks 650, 650′, 700, 700′ are illustrated in FIGS. 28A-30B as each having four planar faces 652₁-652₄, 702₁-702₄ and end walls 654₁/652₂, 704₁/704₂ at opposite ends thereof, embodiments are contemplated which have more or fewer planar faces 652/702 and/or which have only one end wall or no end walls 654₁/652₂, 704₁/704₂. In embodiments which include two such end walls 654₁/652₂, 704₁/704₂, the extrusion tool mask 650, 650′. 700, 700′ may have any number, Q, of planar faces 652/702 and will generally mask Q+1 spaces 614 between adjacent cubes 606₁-606_{N} to produce a panel 12 missing Q+1 elongated support members 22, where Q may be any positive integer. In embodiments which include only one end wall 654₁/652₂, 704₁/704₂, the extrusion tool mask 650, 650′. 700, 700′ may likewise have any number, Q, of planar faces 652/702 but will generally mask only Q spaces 614 between adjacent cubes 606₁-606_{N} to produce a panel 12 missing Q elongated support members 22, where, again, Q may be any positive integer. In embodiments which include no end walls 654₁/652₂, 704₁/704₂, the extrusion tool mask 650, 650′. 700, 700′ may again have any number, Q, of planar faces 652/702 but will generally mask only Q−1 spaces 614 between adjacent cubes 606₁-606_{N} to produce a panel 12 missing Q−1 elongated support members 22, where, yet again, Q may be any positive integer. In any case, an example of a panel 12 having a region 500 in which a number of elongated support members 22 are missing, and which may therefore be produced using one of the extrusion tool masks 650, 650′, 700, 700′ or other such mask, is illustrated in FIG. 26A.

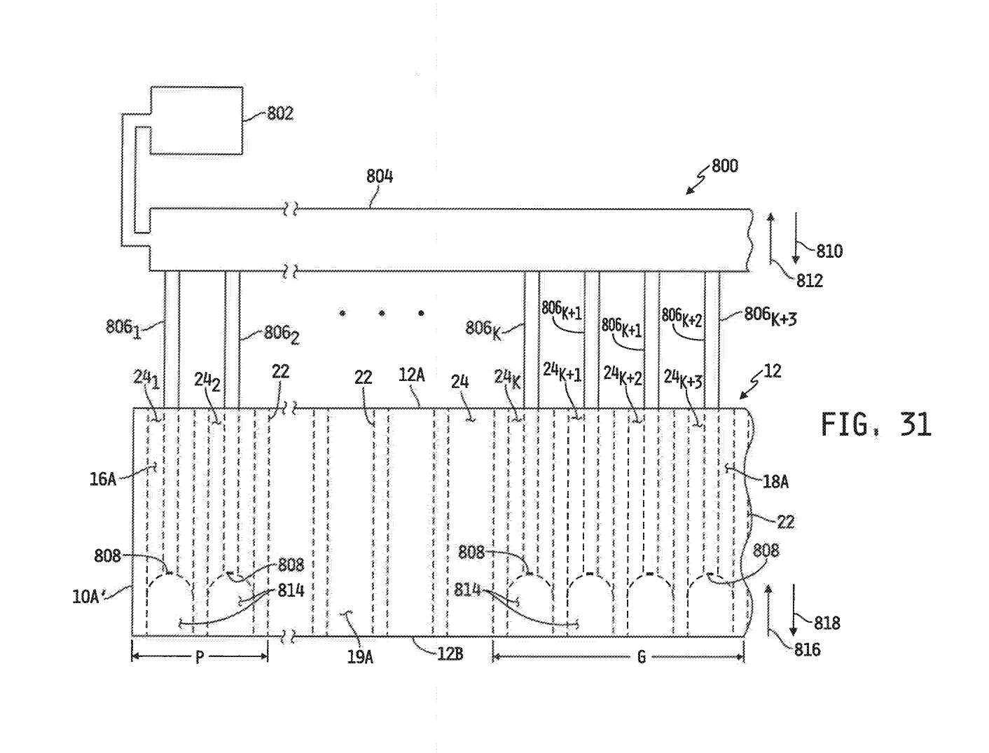

Referring now to FIG. 31, an embodiment is shown of an apparatus 800 and process via which formable filler material, e.g., in the form of a formable medium or a curable medium, as these terms are defined above, may be dispensed into one or more of the channels 24 between adjacent elongated support members 22 to produce panels 12 as illustrated in FIG. 25C. In the illustrated embodiment, the panel 12 is illustratively a formed panel cut or otherwise separated from panel stock as described above, and has a top end 12A and an opposite bottom end 12B defining a height H therebetween as illustrated in FIG. 25A.

The illustrated apparatus 800 illustratively includes a source 802 of formable filler material fluidly coupled to a rail-type container 804 that is fluidly coupled to a number of elongated dispensers 806₁-806_{K+3}, where K may be any positive integer. The source 802 of formable filler material illustratively supplies filler material, e.g., under pressure, to the rail-type container 804. In some embodiments, the filler material supplied by the source 804 may be or include a foam material, e.g., an expanding foam material of desired density such as urethane, polyurethane or the like, a non-expanding or low-expansion foam of desired density such as polyurethane, or the like. In some alternate embodiments, the filler material may be or include the same material used to form the elongated support members 22 and planar foils 20A, 20B of the panel 12, examples of which include, but are not limited to, polypropylene, polyethylene, and the like. In still other embodiments, the source 802 of filler material may include multiple sources of different filler materials, and the apparatus 800 may be configured to dispense the filler material as a combination of two or more such different filler materials as a mixture and/or in layers. Those skilled in the art will recognize other materials that may be used as the filler material, and it will be understood that such other materials are contemplated by this disclosure. In any case, the filler material may be configured and/or selected in some embodiments to bond to the inner surfaces of the planar foils 20A, 20B and/or to the elongated support members 22 at the boundaries of the region of the panel 12 in which one or more of the elongated support members 22 are missing, and in other embodiments the filler material may be configured and/or selected such that it does not bond to the inner surfaces of the planar foils 20A, 20B and/or to the elongated support members 22 at the boundaries of the region of the panel 12 in which one or more of the elongated support members 22 are missing.

Each of the elongated dispensers 806₁-806_{K+3} is sized such that it may be received within a channel 24 defined between adjacent elongated support members 22 of the panel 12 and such that it may extend through the channel 24 from one end 12A of the panel 12 to the other end 12B (or vice versa). At the free end of each elongated dispenser 806₁-806_{K+3} is a nozzle 808 configured to spray, inject or otherwise dispense filler material 814 from the container 804 into a corresponding channel 24 of the panel 12.

In the embodiment illustrated in FIG. 31, the apparatus 800 and the panel 12 are both depicted to be consistent with the embodiment of the panel 12 illustrated in FIGS. 25A and 25C in which elongated and preformed filler members 400 are shown inserted into two channels 24 in a region 16A adjacent to one side 10A′ of the panel 12 and also into four channels 24 in another region 18A separated from the region 16A by yet another region 19A of the panel 12. In this regard, the apparatus 800 includes two elongated dispensers 806₁ and 806₂ arranged and spaced apart relative to the container 804 to extend into two adjacent channels 24₁ and 24₂ near the side 10A′ of the panel 12, and four additional elongated dispensers 806_{K}-806_{K+3} arranged and spaced apart relative to the container 804 to extend into four adjacent channels 24_{K}-24_{K+3} defining the region 18A of the panel 12.

As illustrated by a pair of arrows 810, 812, the apparatus 800 is, in one embodiment, movable toward and away from the panel 12 such that the elongated dispensers 806₁-806_{K+3} are directed into the corresponding channels 24 of the panel 12 by moving the apparatus 800 in the direction 810, and then withdrawing the elongated dispensers 806₁-806_{K+3} from the channels 24 in the direction 812 while simultaneously dispensing the filler material 814 as shown. In some such embodiments, the panel 12 may be stationary. Alternatively or additionally, the panel 12 may be movable toward and away from the apparatus 800, e.g., in the directions illustrated by the arrows 816, 818, with the apparatus 800 stationary or with the apparatus 800 also moving in the directions 810, 812. In any case, the filler material 814 is dispensed into the corresponding channels 24 along the height of the panel 12 (i.e., between the ends 12A, 12B). After the filler material 814 is formed, e.g., dried, hardened, cured, etc., with or without the addition or removal of heat, pressure and/or other environmental conditions, the result achieved is illustratively as depicted in the cross-sectional view of the panel 12 of FIG. 25C.

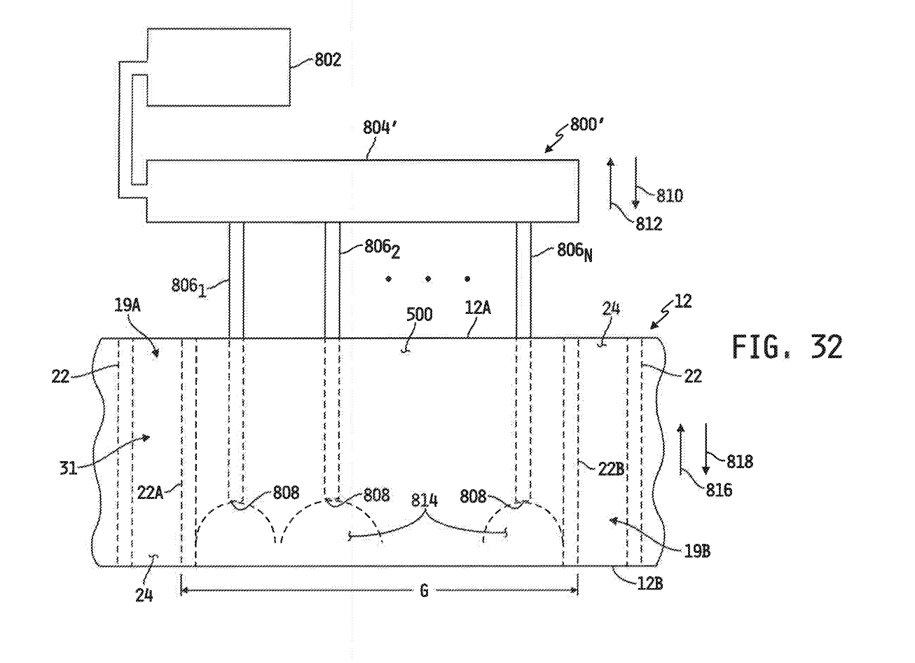

Referring now to FIG. 32, an embodiment is shown of an apparatus 800′ and process via which formable filler material, e.g., in the form of a formable medium or a curable medium, as these terms are defined above, may be dispensed into a region 500 of a panel 12 between elongated support members 22A and 22B in which one or more elongated support members 22 is/are missing, so as to produce panels 12 as illustrated in FIG. 26C. In the illustrated embodiment, the panel 12 is illustratively a formed panel cut or otherwise separated from panel stock as described above, and has a top end 12A and an opposite bottom end 12B defining a height H therebetween, a plurality of elongated support members 22 and a region 500 between two elongated support members 22A, 22B in which one or more elongated support members 22 is/are missing, as illustrated in FIG. 26A. In some embodiments, the panel 12 illustrated in FIG. 32 may be formed via a conventional extruder using the combination of a conventional extrusion tool 600 and an extrusion tool mask 650, 650′, 700, 700′ as illustrated and described in relation to FIGS. 27A-30B. In other embodiments, the panel 12 illustrated in FIG. 32 may be formed via a conventional extruder using a conventional extrusion tool 600, or formed as a conventional laminated panel structure, to first produce panels of the type illustrated in FIG. 27B, and then processing such panels to remove, e.g., via cutting, grinding or the like, the one or more elongated support members 22 in the region 500. In any case, the apparatus 800′ is identical in many respects to the apparatus 800 illustrated in FIG. 31, and like numbers are therefore used to identify like features and components.

In the embodiment illustrated in FIG. 32, the apparatus 800′ and the panel 12 are both depicted to be consistent with the embodiment of the panel 12 illustrated in FIGS. 26A and 26C in which an elongated and preformed filler member 502 (or multiple side-by-side filler members) is shown inserted into the region 500 defined between elongated support members 22A, 22B. In this regard, the apparatus 800′ may include any number of elongated dispensers 806₁-806_{N} arranged and spaced apart relative to the container 804 to extend into the region 500 of the panel 12, where N may be any positive integer. The elongated dispensers 806₁-806_{N} are illustratively sized such that they may be collectively received within the region 500 defined between the elongated support members 22A, 22B of the panel 12 and such that they may extend through the region 500 from one end 12A of the panel 12 to the other end 12B (or vice versa). At the free end of each elongated dispenser 806₁-806_{N} is a nozzle 808 configured to spray, inject or otherwise dispense filler material 814 from the container 804 into a region 500 of the panel 12. In some embodiments, such as that shown in FIG. 32, the elongated dispensers 806₁-806_{N} may include multiple dispensers each configured to dispense filler material 814 in a pattern which overlaps that dispensed by an adjacent dispenser such that the multiple dispensers collectively dispense filler material 814 which spans the region 500. In other embodiments, the elongated dispensers 806₁-806_{N} may include only a single dispenser configured to dispense filler material 814 in a pattern which, by itself, spans the region 500.

As with the apparatus 800 illustrated in FIG. 31, the apparatus 800′, the panel 12 or both may, in the embodiment illustrated in FIG. 32, be movable toward and away from the other, or toward and away from each other, as illustrated by arrow pairs 810, 812 and 816, 818. The one or more elongated dispenser(s) 8061-806N is/are thus directed into the region 500 of the panel 12 by moving the apparatus 800′ in the direction 810 and/or moving the panel 12 in the direction 816, and then withdrawing the one or more elongated dispenser(s) 8061-806M in the direction 812 and/or moving the panel 12 in the direction 818 while simultaneously dispensing the filler material 814 as shown. In some such embodiments, the panel 12 may be stationary, in other embodiments the apparatus 800′ may be stationary and in still other embodiments both the apparatus 800′ and the panel 12 may be movable as just described. In any case, the filler material 814 is dispensed into the corresponding region 500 along the height of the panel 12 (i.e., between the ends 12A, 12B). After the filler material 814 is formed, e.g., dried, hardened, cured, etc., with or without the addition or removal of heat, pressure and/or other environmental conditions, the result achieved is illustratively as depicted in the cross-sectional view of the panel 12 of FIG. 26C.

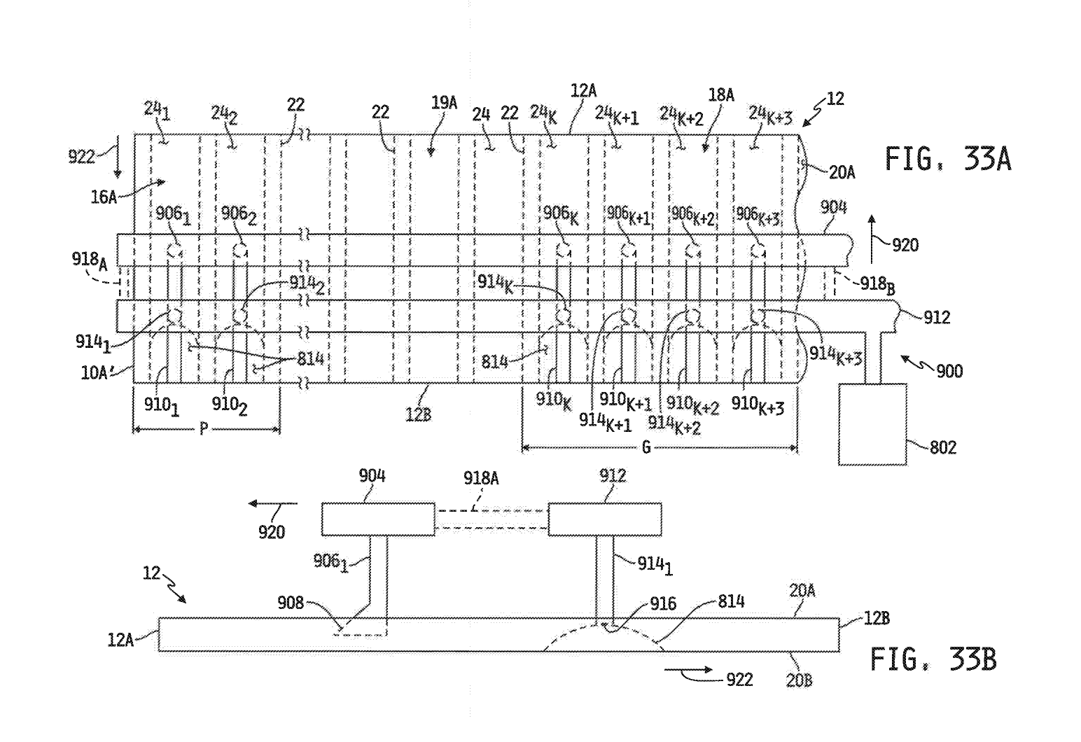

Referring now to FIGS. 33A and 33B, an embodiment is shown of another apparatus 900 and process via which formable filler material, e.g., in the form of a formable medium or a curable medium, as these terms are defined above, may be dispensed into one or more of the channels 24 between adjacent elongated support members 22 to produce panels 12 as illustrated in FIG. 25C. In the illustrated embodiment, the panel 12 is illustratively a formed panel cut or otherwise separated from panel stock as described above, and has a top end 12A and an opposite bottom end 12B defining a height H therebetween as illustrated in FIG. 25A.

The illustrated apparatus 900 illustratively includes a carrier 904 to which one or more channel-forming tools 906₁-906_{K+3} is/are attached, and a source 802 of formable filler material fluidly coupled to a rail-type container 912 that is fluidly coupled to a number of elongated dispensers 914₁-914_{K+3}, where K may be any positive integer. The source 802 of formable filler material is as described with respect to FIGS. 31 and 32, and illustratively supplies the filler material, e.g., under pressure, to the rail-type container 912.

A channel cutting head 908 is formed at, or affixed to, the free end of each of the one or more channel-forming tools 906₁-906_{K+3}, and each channel cutting head 908 is sized to have a width that is less than or equal to the width of the channels 24 defined between adjacent elongated support members 22 of the panel 12. Each such channel cutting head 908 is illustratively configured to cut, grind, abrade or otherwise form a channel 910 into and through the planar foil 20A or 20B of the panel 12 such that at least part of the underlying channel 24 of the panel 12 is exposed through the planar foil 20A or 20B along the height of the panel 12, i.e., between the opposing ends 12A, 12B of the panel 12.

Each of the elongated dispensers 914₁-914_{K+3} has at its free end a nozzle 916 configured to spray, inject or otherwise dispense filler material 814 from the container 804 into a corresponding channel 24 of the panel 12 through a corresponding channel 910 formed by a channel cutting head 908. In some embodiments, the nozzle 916 (including or not including a portion of the elongated dispenser 914 coupled thereto or formed integral therewith) is sized such that it may be received within a channel 24 of the panel 12 through a channel 910 formed by a channel cutting head 908. In other embodiments, the nozzle 916 is sized such that it is not received within or through a channel 910 formed by a channel cutting head 908, but rather is disposed above the channel 910 and outside of the channel 24 of the panel 12.

In some embodiments, the panel 12 is stationary and the carrier 904 and the container 912 are both illustratively movable in a direction toward the panel 12 as illustrated by the arrow 920. In other embodiments, the carrier 904 and the container 912 are both stationary and the panel 12 is movable in a direction toward the carrier 904 and the container 912 as illustrated by the arrow 922. In still other embodiments, the carrier 904 and the container 912 are movable in the direction of the arrow 920 and the panel 12 is movable in the direction of the arrow 922. In embodiments in which the carrier 904 and the container 912 are movable, the carrier 904 and the container 912 may in some embodiments be movable independently of each other. In other embodiments, the carrier 904 and the container 912 may be interconnected by one or more interconnection structures, e.g., interconnecting structures 918A and/or 918B, as shown by dashed-line representation in FIGS. 33A and 33B, such that the carrier 904 and the container 912 move together. In any case, the carrier 904 and the container 912 may be spaced apart from each other as illustrated in FIGS. 33A and 33B, or may instead be coupled together.

In the embodiment illustrated in FIGS. 33A and 33B, the apparatus 900 and the panel 12 are both depicted to be consistent with the embodiment of the panel 12 illustrated in FIGS. 25A and 25C in which elongated and preformed filler members 400 are shown inserted into two channels 24 in a region 16A adjacent to one side 10A′ of the panel 12 and also into four channels 24 in another region 18A separated from the region 16A by yet another region 19A of the panel 12. In this regard, the apparatus 900 includes two elongated channel-forming tools 906₁ and 906₂ arranged and spaced apart relative to the carrier 904 and two elongated dispensers 914₁ and 914₂ arranged and spaced apart relative to the container 912 to form two adjacent channels 910₁ and 910₂ into and through the planar foil 20A above two corresponding adjacent channels 24₁ and 24₁ defining the region 16A near the side 10A′ of the panel 12, and to dispense filler material 814 through the respective channels 910₁ and 910₂ into the respective channels 24₁ and 24₂ of the panel 12. Additionally, the apparatus 900 includes four elongated channel-forming tools 906_{K}-906_{K+3} arranged and spaced apart relative to the carrier 904 and four elongated dispensers 914_{K}-914_{K+3} arranged and spaced apart relative to the container 912 to form four adjacent channels 910₁ and 910₂ into and through the planar foil 20A above four corresponding adjacent channels 24_{K}-24_{K+3} defining the region 18A of the panel 12, and to dispense filler material 814 through the respective channels 910_{K}-910_{K+3} into the respective channels 24_{K}-24_{K+3} of the panel 12. As the carrier 904 and the container 912 are moved relative to the panel 12, and/or as the panel 12 is moved relative to the carrier 904 and the container 912, along the height of the panel 12 (i.e., between the ends 12A, 12B), the channels 910₁-910₂ and 910_{K}-910_{K+3} are formed by the channel-forming tools 906₁-906₂ and 906_{K}-906_{K+3} and filler material 814 is thereafter dispensed by the dispensers 914₁-914₂ and 914_{K}-914_{K+3} into the channels 24₁-24₂ and 24_{K}-24_{K+3}. After the filler material 814 is formed, e.g., dried, hardened, cured, etc., with or without the addition or removal of heat, pressure and/or other environmental conditions, the result achieved is illustratively as depicted in the cross-sectional view of the panel 12 of FIG. 25C with the exception that the panel 12 according to the process illustrated in FIGS. 33A and 33B will include channels 910₁-910₂ and 910_{K}-910_{K+3} through the planar foil 20A (or 20B). In some embodiments, the filler material 814 may extend into and through the channels 24₁-24₂ and 24_{K}-24_{K+3} and into and through the channels 910₁-910₂ and 910_{K}-910_{K+3} to the top (i.e., outer) surface of the planar foil 20A (or 20B), and in other embodiments the filler material 814 may fill only the channels 24₁-24₂ and 24_{K}-24_{K+3} and not extend into the channels 910₁-910₂ and 910_{K}-910_{K+3}.

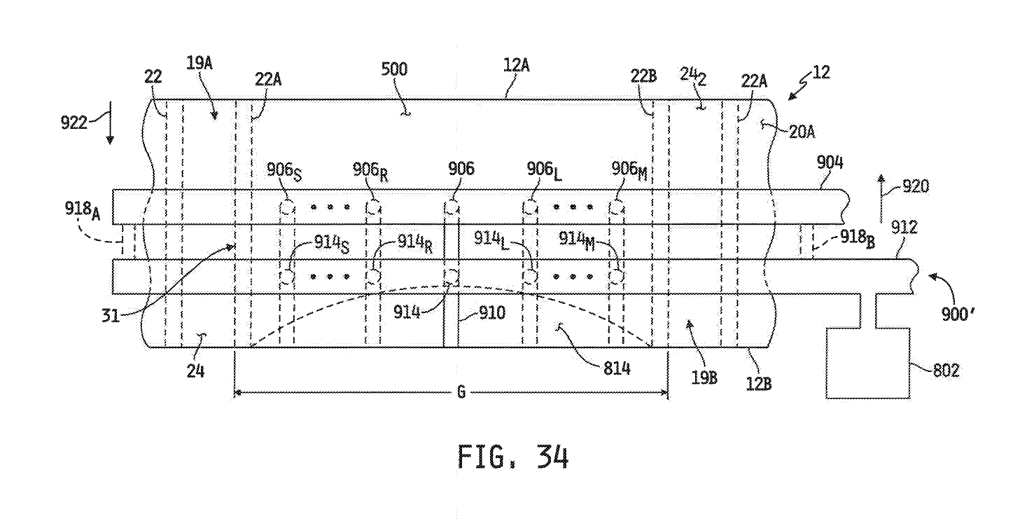

Referring now to FIG. 34, an embodiment is shown of an apparatus 900′ and process via which formable filler material, e.g., in the form of a formable medium or a curable medium, as these terms are defined above, may be dispensed into a region 500 of a panel 12 between elongated support members 22A and 22B in which one or more elongated support members 22 is/are missing, so as to produce panels 12 as illustrated in FIG. 26C. In the illustrated embodiment, the panel 12 is illustratively a formed panel cut or otherwise separated from panel stock as described above, and has a top end 12A and an opposite bottom end 12B defining a height H therebetween, a plurality of elongated support members 22 and a region 500 between two elongated support members 22A, 22B in which one or more elongated support members 22 is/are missing, as illustrated in FIG. 26A. In some embodiments, the panel 12 illustrated in FIG. 34 may be formed via a conventional extruder using the combination of a conventional extrusion tool 600 and an extrusion tool mask 650, 650′, 700, 700′ as illustrated and described in relation to FIGS. 27A-30B. In other embodiments, the panel 12 illustrated in FIG. 34 may be formed via a conventional extruder using a conventional extrusion tool 600 to first produce panels of the type illustrated in FIG. 27B, and then processing such panels to remove, e.g., via cutting, grinding or the like, the one or more elongated support members 22 in the region 500. In any case, the apparatus 900′ is identical in many respects to the apparatus 900 illustrated in FIGS. 33A and 33B, and like numbers are therefore used to identify like features and components.

In the embodiment illustrated in FIG. 34, the apparatus 900′ and the panel 12 are both depicted to be consistent with the embodiment of the panel 12 illustrated in FIGS. 26A and 26C in which an elongated and preformed filler member 502 (or multiple side-by-side filler members) is shown inserted into the region 500 defined between elongated support members 22A, 22B. In this regard, the apparatus 900′ may include any number of channel-forming tools 906₁-906_{M} and dispensers 914₁-914_{M}, all operable as described above, where M may be any positive integer. In some embodiments, such as that shown in FIG. 34, the apparatus 900′ may include a single channel-forming tool 906 and a single dispenser 914 mounted to the carrier 904 and container 912 respectively such that the channel 910 formed by the tool 906 is formed substantially centrally relative to the region 500, i.e., substantially equidistant from the elongated support members 22A and 22B. In this embodiment, the dispenser 914 and/or nozzle 916 and/or filling material 814 is/are illustratively configured and/or selected such that the filling material 814 dispensed from the dispenser 914 spans the region 500, i.e., extends from and between the elongated support members 22A, 22B, as illustrated in FIG. 34. In alternate embodiments, the apparatus 900′ may include any number of additional channel forming tools 906_{L}-906_{M} and corresponding dispensers 914_{L}-914_{M} mounted to the carrier 904 and container 912 respectively to form and fill any corresponding number of channels 910_{L}-910_{M} on one side of the channel 910, and/or any number of additional channel forming tools 906_{R}-906_{S} and corresponding dispensers 914_{R}-914_{S} mounted to the carrier 904 and container 912 respectively to form and fill any corresponding number of channels 910_{R}-910_{S} on the opposite side of the channel 910, where L, M, R and S may each be any positive integer with L≦M and R≦S. In such embodiments, the multiple dispensers are each configured to dispense filler material 814 in a pattern which overlaps that dispensed by an adjacent dispenser such that the multiple dispensers collectively dispense filler material 814 which spans the region 500. In any case, as the carrier 904 and the container 912 are moved relative to the panel 12, and/or as the panel 12 is moved relative to the carrier 904 and the container 912, along the height of the panel 12 (i.e., between the ends 12A, 12B), filler material 814 is dispensed by the dispenser(s) 914 into the region 500 via the channel(s) 910 formed by the channel-forming tool(s) 906. After the filler material 814 is formed, e.g., dried, hardened, cured, etc., with or without the addition or removal of heat, pressure and/or other environmental conditions, the result achieved is illustratively as depicted in the cross-sectional view of the panel 12 of FIG. 26C with the exception that the panel 12 according to the process illustrated in FIGS. 33A and 33B will include one or more channels 910 through the planar foil 20A (or 20B). In some embodiments, the filler material 814 may extend into and through the region 500 and into and through the channel(s) 910 to the top (i.e., outer) surface of the planar foil 20A (or 20B), and in other embodiments the filler material 814 may fill only the region 500 and not extend into the channel(s) 910.

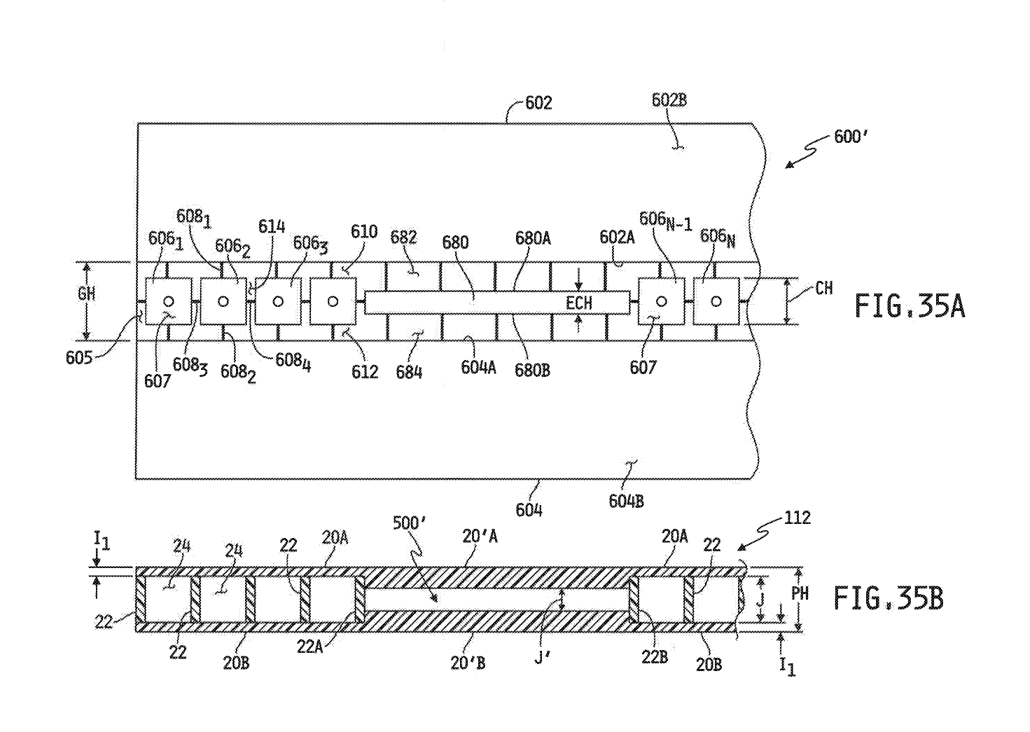

Referring now to FIGS. 35A and 35B, another embodiment of an extrusion tool 600′ is shown in which may be used with, e.g., operatively coupled to, a conventional extruder to produce panels 112 which include interconnecting support members 22 in some panel regions but which do not include the interconnecting support members 22 on one or more other panel regions. FIGS. 35A and 35B are horizontally aligned to demonstrate that the features of the panel 112 are produced by the correspondingly aligned structures of the extrusion tool 600′.

The extrusion tool 600′ illustrated in FIG. 35A is identical in many respects to the extrusion tool 600 illustrated in FIGS. 27A, 28A and 28B, and like numbers are therefore used to represent like structures and components. In the illustrated embodiment, the extrusion tool 600′ differs from the extrusion tool 600 in that an elongated cube 680 replaces five of the cubes, e.g., cubes 606₅-606₉, in the plurality of sequential cubes 606₁-606_{N}. The length of the elongated cube 680 is, in the illustrated embodiment, equal to the sum of the widths CW of the five cubes 606₅-606₉ and the widths CS of the four spaces 614 between adjacent ones of the five cubes 606₅-606₉. The height of the elongated cube 680 is illustratively truncated relative to the heights CH of the cubes 606₅-606₉ it replaces, and the height of the elongated cube ECH is defined as the distance between a top surface 680A and a bottom surface 680B thereof. An elongated space 682 is defined between the inner surface 602A of the top plate 602 and the top surface 680A of the elongated cube 680, and another elongated space 684 is defined between the inner surface 604A of the bottom plate 604 and the bottom surface 680B of the elongated cube 680. In the illustrated embodiment, the difference in height between CH and the truncated height of the elongated cube 680 is distributed substantially evenly between the inner surface 602A of the top plate 602 and the inner surface 604A of the bottom plate 604 such that the height of the space 682 is substantially equal to the height of the space 684. Because the height of the elongated cube 680 is truncated relative to the height CH of the remaining cubes 606, the height of the spaces 682, 684 is greater than that of the spaces 610, 612. In embodiments in which the height of the space 610 is equal to the height of the space 612 and the height of the space 682 is equal to that of the space 684, the height of the spaces 610, 612 is defined by the relationship (GH−CH)/2, and the height of the spaces 682, 684 is defined by the relationship (GH−ECH)/2, where CH>ECH.

Referring now to FIG. 35B, the illustrated panel 112 is identical to that illustrated in FIG. 27B in regions to the left of the elongated support member 22A and in regions to the right of the elongated support member 22B. Between the elongated support members 22A, 22B, a region 500′ is defined by the elongated cube 680 and the inner surfaces 602A, 604A of the top and bottom plates 602, 604 respectively which does not include any elongated support members 22 interconnected between the planar foils. Moreover, above and below the region 500′ the top planar foil 20′A and the bottom planar foil 20′B are each thicker than that of the top planar foil 20A and the bottom planar foil 20B respectively due to the increased heights of the spaces 682, 684 relative to the heights of the spaces 610, 612, thus resulting in a height J′ of the region 500′ which is less than the height J of the elongated support members 22. In embodiments in which the height of the space 682 is equal to that of the space 684, the height or thickness of the planar foils 20′A and 20′B is defined by the relationship (PH−J′)/2, where J>J′.

The region 500′ with thicker planar foils 20′A, 20′B may be established as a region of the panel 112 in which a living hinge or other hinge member is to be formed, e.g., with or without one or more filler members disposed therein, or in which thicker planar foils is otherwise desired. In either case, the thickness of the planar foils 20′A, 20′B will selected consistently with their purpose which will, in turn, dictate the height ECH of the elongated cube 680. Likewise, the desired length of the region 500′ will dictate the length of the elongated cube 680.

In some alternate embodiments, the top surface 680A of the elongated cube 680 may be positioned to be co-planar with the top surfaces of the cubes 606₁-606_{N} such that the top planar foil 20A has uniform thickness while the bottom planar foil 20′B below the region 500′ is thicker than the bottom planar foil 20B elsewhere along the panel 11. In other alternate embodiments, the bottom surface 680B of the elongated cube 680 may be positioned to be co-planar with the bottom surfaces of the cubes 606₁-606_{N} such that the bottom planar foil 20B has uniform thickness while the top planar foil 20′A above the region 500′ is thicker than the top planar foil 20A elsewhere along the panel 112. In still other alternate embodiments in which the top planar foil 20′A above the region 500′ is thicker than the top planar foil 20A elsewhere along the panel 112 and the bottom planar foil 20′B below the region 500′ is thicker than the bottom planar foil 20B elsewhere along the panel 112, the thickness of the planar foil 20′A may be different than that of the planar foil 20′B. In any case, it will be understood that while the elongated cube 680 is illustrated in FIG. 35A as replacing five of the cubes, e.g., cubes 606₅-606₉, in other embodiments the elongated cube 680 may be sized to replace more or fewer cubes 606. It will be further understood that while only a single elongated cube 680 is illustrated in FIG. 35A as replacing a number of cubes 606, other embodiments may include any number of elongated cubes positioned in and along the gap 605 of the extrusion tool 600′.

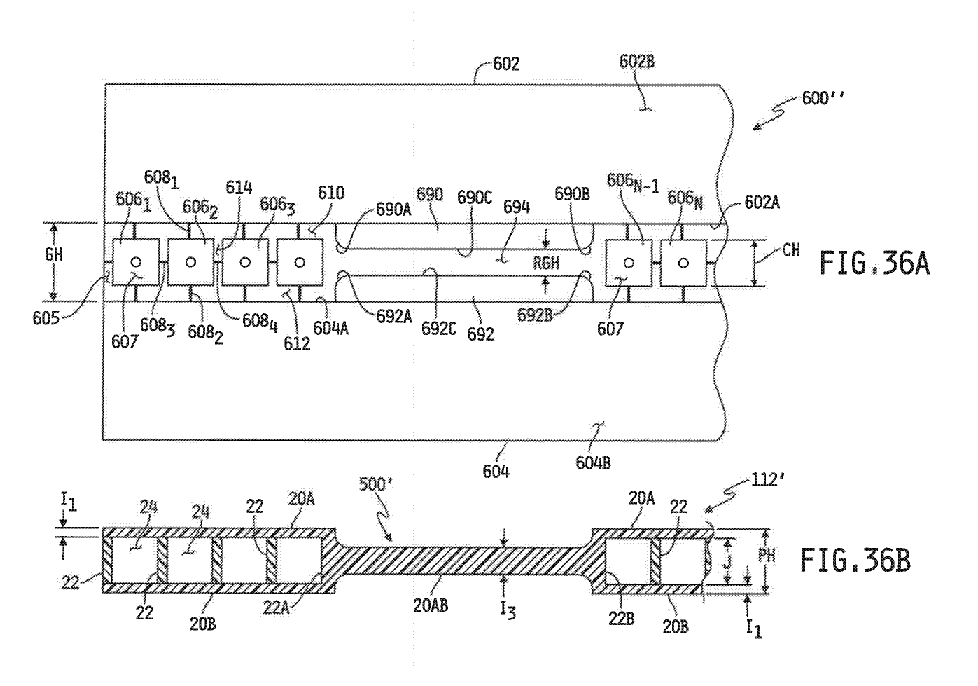

Referring now to FIGS. 36A and 36B, yet another embodiment of an extrusion tool 600″ is shown in which may be used with, e.g., operatively coupled to, a conventional extruder to produce panels 112′ which include interconnecting support members 22 in some panel regions but which do not include the interconnecting support members 22 on one or more other panel regions. FIGS. 36A and 36B are horizontally aligned to demonstrate that the features of the panel 112′ are produced by the correspondingly aligned structures of the extrusion tool 600″.

The extrusion tool 600″ illustrated in FIG. 36A is identical in many respects to the extrusion tool 600 illustrated in FIGS. 27A, 28A and 28B, and like numbers are therefore used to represent like structures and components. In the illustrated embodiment, the extrusion tool 600″ differs from the extrusion tool 600 in a region of the gap 605 in which a number of cubes 606 are replaced with a top plate extension 690 coupled to the inner surface 602A of the top plate 602 and a bottom plate extension 692 coupled to the inner surface 604A of the bottom plate 604. In the example embodiment illustrated in FIG. 36A, the top and bottom plate extensions 690, 692 replace five of the cubes, e.g., cubes 606₅-606₉, in the plurality of sequential cubes 606₁-606_{N}. The length of the top and bottom plate extensions 690, 692 is, in the illustrated embodiment, equal to the sum of the widths CW of the five cubes 606₅-606₉ and the widths CS of the four spaces 614 between adjacent ones of the five cubes 606₅-606₉.

The top plate extension 690 attached to or integral with the inner surface 602A of the top plate 602 extends downwardly via opposing shoulders 690A, 690B to a planar lower surface 690C facing the bottom plate extension 692. The bottom plate extension 692 attached to or integral with the inner surface 604A of the bottom plate 604 similarly extends upwardly via opposing shoulders 692A, 692B to a planar upper surface 692C facing the top plate extension 690 so that the two planar surfaces 690C, 692C are facing each other. The planar surfaces 690C, 692C define an elongated gap 694 therebetween having a reduced gap height RGH relative to the gap height GH of the gap 605. In the illustrated embodiment, the top and bottom plate extensions 690, 692 each extend approximately an equal distance away from the respective inner plate surface 602A, 604A, and the reduced gap height RGH is less than the cube height CH.

Referring now to FIG. 36B, the illustrated panel 112′ is identical to that illustrated in FIG. 27B in regions to the left of the elongated support member 22A and in regions to the right of the elongated support member 22B. Between the elongated support members 22A, 22B, a region 500″ is defined by the top and bottom plate extensions 690, 692 in which the top and bottom planar foils 20A, 20B merge into a single planar foil 20AB illustratively having a thickness I₃ that is greater than or equal to the combined thicknesses I₁ of the two planar foils 20A, 20B.

The region 500″ with single, thick planar foil 20AB may be established as a region of the panel 112′ in which a living hinge or other hinge member is to be formed, or in which a region of a thick planar foil is otherwise desired. In either case, the thickness of the planar foil 20AB will selected consistently with its purpose which will, in turn, dictate the gap height RGH set by the top and bottom plate extensions 690, 692. Likewise, the desired length of the region 500″ will dictate the lengths of the top and bottom plate extensions 690, 692.

In some alternate embodiments, the opposing surfaces 690C, 692C of the top and bottom plate extensions 690, 692 may each extend an equal distance toward the other such that the top planar foil 20A slopes downwardly to the single planar foil 20AB by the same amount than the bottom planar foil 20B slopes upwardly to the single planar foil 20AB. In other alternate embodiments, the opposing surfaces 690C, 692C of the top and bottom plate extensions 690, 692 may extend an different distances toward the other such that the top planar foil 20A slopes downwardly to the single planar foil 20AB by the different amount than the bottom planar foil 20B slopes upwardly to the single planar foil 20AB. In still other alternate embodiments, the extrusion tool 600″ includes only one of the top and bottom extension plates 690, 692, and in such embodiments only one of the top and bottom planar foil 20A, 20B slopes toward the single planar foil 20AB while the other planar foil 20A, 20B remains substantially co-planar across the panel 112′. In still further alternate embodiments, one or more of the shoulders 690A, 690B, 692A and 692B may not be sloped but may instead have a different profile in the transition between the inner surface 602A of the top plate 602 and the surface 690C of the top plate extension 690 and/or between the inner surface 604A of the bottom plate 604 and the surface 692C of the bottom plate extension 692. In any case, it will be understood that while the top and bottom plate extensions 690, 692 are illustrated in FIG. 36A as replacing five of the cubes, e.g., cubes 606₅-606₉, in other embodiments the top and/or bottom plate extension(s) 690, 692 may be sized to replace more or fewer cubes 606. It will be further understood that while only a single set of top and bottom plate extensions 690, 692 are illustrated in FIG. 36A as replacing a number of cubes 606, other embodiments may include any number of set of top and bottom plate extensions 690, 692 positioned in and along the gap 605 of the extrusion tool 600″.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, some embodiments have been described herein with which it is desirable to promote uniform cooling or curing of the panels 12 and/or panel stock 10 across the lengths and widths thereof by forming the distributed interconnecting structure 30 in the volume, V18A, of the living hinge area or zone 18A with the same, or substantially the same, amount of material along the length H of the zone 18A and across the width G of the zone 18A as used to form the portion of the interconnecting structure 31 along the lengths and across the widths in and of adjacent, contiguous panel zones 19A-19D having the same volume as V18A. This disclosure further contemplates alternate embodiments in which the interconnecting structures between the planar foils 20A, 20B are not necessarily uniform across the panel length and/or width, but in which such interconnecting structures may be concentrated and/or compressed, and in some embodiments solid, in and along, for example, one or more of the zones in which a living hinge is to be formed. In such embodiments, for example, any warping, curling and/or other such undesirable resulting effects on the panel stock 10 and/or of the individual panels 12 that may occur in the area(s) of such one or more living hinge zones during cooling and/or curing thereof may be overcome, i.e., straightened and/or otherwise corrected, by heat and/or compression applied in such areas via a living hinge formation tool, die or press such as that described herein and/or via one or more other processing techniques that will occur to those skilled in the art.

What is claimed is:

1. An opposing-foil panel, comprising:
first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, the interior surface the first planar foil spaced apart from the interior surface of the second planar foil,
a first plurality of elongated support members affixed to the interior surfaces of the first and second planar foils, the first plurality of elongated support members extending along the machine direction between the first and second foil ends and spaced apart along the cross-machine direction in a first section of the first and second planar foils,
a second plurality of elongated support members affixed to the interior surfaces of the first and second planar foils, the second plurality of elongated support members extending along the machine direction between the first and second foil ends and spaced apart along the cross-machine direction in a second section of the first and second planar foils that is separate and spaced apart from the first section of the first and second planar foils, and
a region of the first and second planar foils having a thickness defined between the interior surfaces of the first and second planar foils, a width defined between the first and second sections of the first and second planar foils and a length extending at least partially along the foil height from one of the first and second foil ends toward the other of the first and second foil ends, the region of the first and second planar foils having no elongated support members affixed therein between the interior surfaces of the first and second planar foils.

2. The opposing-foil panel of claim 1, further comprising at least one filler member disposed within the region of the first and second planar foils and extending at least partially along the length, width and thickness thereof such that the at least one filler member at least partially fills a volume of the region.

3. The opposing-foil panel of claim 2, wherein the region of the first and second planar foils comprises a living hinge zone,
and wherein the opposing-foil panel further comprises a living hinge formed at least partially along the living hinge zone with the first and second planar foils and the at least one filler member disposed therein.

4. The opposing-foil panel of claim 3, wherein the living hinge further includes at least one of the first plurality of elongated support members.

5. The opposing-foil panel of claim 4, wherein the living hinge further includes at least one of the second plurality of elongated support members.

6. The opposing-foil panel of claim 2, wherein the at least one filler member is formed of at least one of a polypropylene foam, a high-density polypropylene foam, an expanding foam, a non-expanding foam, a low-density polyether, polyester, polyvinyl acetate, a flexible plastic material, a rigid plastic material, wood, a wood composite, paper, cellulose, one or a combination of metals, a metal composite, a textile, a formable medium and a curable medium.

7. The opposing-foil panel of claim 2, wherein the at least one filler member defines a thickness sized to be received within the thickness of the region of the first and second planar foils,
and wherein the at least one filler member comprises two or more sheets coupled together to define the thickness of the filler member.

8. The opposing-foil panel of claim 2, wherein the at least one filler member defines a width sized to be received within the width of the region of the first and second planar foils,
and wherein the at least one filler member comprises two or more sheets positioned side-by-side within the width of the region.

9. The opposing-foil panel of claim 2, wherein the at least one filler member is a single sheet.

10. The opposing-foil panel of claim 2, further comprising a third plurality of elongated support members affixed to the interior surfaces of the first and second planar foils within the region of the first and second foils, the third plurality of elongated support members extending along the machine direction between the first and second foil ends and spaced apart along the cross-machine direction in the region of the first and second planar foils,
and wherein the third plurality of elongated support members is at least partially removed from the region prior to receiving the at least one filler member therein.

11. The opposing-foil panel of claim 1, wherein the region of the first and second planar foils comprises a living hinge zone,
and wherein the opposing-foil panel further comprises a living hinge formed at least partially along the living hinge zone with the first and second planar foils.

12. The opposing-foil panel of claim 11, wherein the living hinge further includes at least one of the first plurality of elongated support members.

13. The opposing-foil panel of claim 12, wherein the living hinge further includes at least one of the second plurality of elongated support members.

14. The opposing-foil panel of claim 1, wherein the opposing-foil panel is one of an extruded opposing-foil panel and laminated opposing-foil panel.

15. The opposing-foil panel of claim 1, further comprising a third plurality of elongated support members affixed to the interior surfaces of the first and second planar foils within the region of the first and second foils, the third plurality of elongated support members extending along the machine direction between the first and second foil ends and spaced apart along the cross-machine direction in the region of the first and second planar foils,
and wherein the third plurality of elongated support members is at least partially removed from the region.

16. An opposing-foil panel, comprising:
first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, the interior surface the first planar foil spaced apart from the interior surface of the second planar foil,
a first plurality of elongated support members affixed to the interior surfaces of the first and second planar foils, the first plurality of elongated support members extending along the machine direction between the first and second foil ends and spaced apart along the cross-machine in a section of the first and second planar foils, and
a region of the first and second planar foils having a thickness defined between the interior surfaces of the first and second planar foils, a width defined between one of the first and second foil sides and the section of the first and second planar foils and a length extending at least partially along the foil height from one of the first and second foil ends toward the other of the first and second foil ends, the region of the first and second planar foils having no elongated support members affixed therein between the interior surfaces of the first and second planar foils.

17. The opposing-foil panel of claim 16, further comprising at least one filler member disposed within the region of the first and second planar foils and extending at least partially along the length, width and thickness thereof such that the at least one filler member at least partially fills a volume of the region.

18. A method of forming an opposing-foil panel, the method comprising:
forming the opposing foil panel to include first and second planar foils each defining a foil height extending linearly along a machine direction between first and second foil ends, a foil width extending linearly along a cross-machine direction, normal to the machine direction, between first and second foil sides and an interior surface between the first and second foil ends and the first and second foil sides, with the interior surface the first planar foil spaced apart from the interior surface of the second planar foil, to include a first plurality of elongated support members affixed to the interior surfaces of the first and second planar foils and extending along the machine direction between the first and second foil ends and spaced apart along the cross-machine direction in a first section of the first and second planar foils, and to include a second plurality of elongated support members affixed to the interior surfaces of the first and second planar foils and extending along the machine direction between the first and second foil ends and spaced apart along the cross-machine direction in a second section of the first and second planar foils that is separate and spaced apart from the first section of the first and second planar foils, and
one of forming a region of the first and second planar foils between the first and second sections of the first and second planar foils and having no elongated support members affixed therein between the interior surfaces of the first and second planar foils, and forming the region to include a third plurality of elongated support members affixed to the interior surfaces of the first and second planar foils and extending along the machine direction between the first and second foil ends and spaced apart along the cross-machine direction in the region and thereafter at least partially removing the third plurality of elongated support members from the region.

19. The method of claim 18, further comprising inserting at least one filler member into the region such that the at least one filler member at least partially fills a volume of the region.

20. The method of claim 18, further comprising at least partially filling the region with a formable filling material.
